(19) United States
(12) Patent Application Publication
(10) Pub. No.: US 2017/0203868 A1
(43) Pub. Date: Jul. 20, 2017

(54) POUCH WITH FITMENT AND METHOD OF MAKING SAME

(71) Applicant: Dr. Py Institute, LLC, New Milford, CT (US)

(72) Inventors: Daniel Py, Larchmont, NY (US); Julian V. Chan, New Milford, CT (US)

(21) Appl. No.: 15/410,740

(22) Filed: Jan. 19, 2017

Related U.S. Application Data
(60) Provisional application No. 62/280,700, filed on Jan. 19, 2016.
(60) Provisional application No. 62/295,139, filed on Feb. 14, 2016.
(60) Provisional application No. 62/298,214, filed on Feb. 22, 2016.
(60) Provisional application No. 62/323,561, filed on Apr. 15, 2016.
(60) Provisional application No. 62/448,315, filed on Jan. 19, 2017.

(51) Int. Cl. B65B 55/06; B65B 61/18; B65B 3/02; B65B 3/04; B29C 69/02; A61J 1/10; B65D 75/54; A61J 1/14; B65B 7/02; B65B 51/02; B65B 61/06

(52) U.S. Cl. CPC B65B 55/06; B65B 51/02; B65B 61/186; B65B 3/022; B65B 3/04; B65B 61/06; A61J 1/10; B65D 75/54; A61J 1/1475; B65B 7/02; B29C 69/02; B29L 2031/7128

(57) ABSTRACT

A sealed, empty pouch, wherein the interior of the pouch is particle and pyrogen free, is made by (i) molding a tubular film including an inner surface and an outer surface, and blowing or otherwise directing micro-filtered air and/or other gas through the tubular film during molding; (ii) flattening the molded tubular film; (iii) sealing the flattened tubular film at spaced locations, cutting the sealed film at the spaced locations, and forming a plurality of empty pouches; (iv) over-molding a fitment to the outer surface of each of a plurality of empty pouches and forming a fluid-tight seal between the fitment and the interior of the pouch; and (v) preventing the collection of particles on the inner surface of each pouch, and the exposure of each such inner surface to an ambient atmosphere throughout steps (i) through (iv).

### CROSS-REFERENCE TO RELATED PATENT APPLICATION

This patent application claims benefit under 35 U.S.C. §119 to U.S. provisional patent application Ser. No. 62/295,139, filed 14 Feb. 2016, U.S. provisional patent application Ser. No. 62/298,214, filed 22 Feb. 2016, and U.S. provisional patent application Ser. No. 62/323,561, filed 15 Apr. 2016, each of which is entitled “Pouch With Over-Molded Fitment And Method Of Making Same,” U.S. provisional patent application Ser. No. 62/280,700, filed 19 Jan. 2016, entitled “Pouch with Heat-Sealed External Fitment,” and U.S. provisional patent application Ser. No. 62/448,315, filed 19 Jan. 2017, entitled “Pouch With Fitment And Method Of Making Same,” all of which are hereby incorporated by reference in their entireties as part of the present disclosure.

### FIELD OF THE INVENTION

The present invention relates to pouches or like articles for aseptic or sterile filling products therein, and more particularly, to pouches or like articles with fitments, and to methods of making such pouches, including methods of making such pouches with aseptic or sterile, and particle-free and/or pyrogen free interior surfaces.

### BACKGROUND INFORMATION

Prior art pouches used to store aseptic or sterile products, such as pharmaceutical or food products, are typically manufactured in an environment where the interior surfaces of the pouches can be exposed to contamination during manufacturing. Accordingly, such pouches must be subjected to a sterilization process, either before or after filling the product therein, such as by terminal sterilization, or by sterilizing the pouch prior to aseptic or sterile filling the product therein. Terminal sterilization can be damaging to the product filled into the pouch and subject to the sterilization process. Gamma and other types of sterilization can be relatively costly, and if used to terminally sterilize, can damage the product filled into the pouch. If used to sterilize the pouch prior to aseptically or sterile filling the product into the pouch, such sterilization processes nevertheless can leave particulate matter, both viable and non-viable and associated pyrogens, in the interior chambers of the pouches, and thus in the products that are filled into the pouches. If such particulate matter is above a certain level, it can have an undesirable effect on the product. A viable particle is a particle that contains one or more living microorganisms. These can affect the sterility of a product, such as a pharmaceutical product, and generally range from about 0.2 μm to about 30 μm in size. A non-viable particle is a particle that does not contain a living microorganism but acts as transportation for viable particles. Pyrogens are fever-producing substances, which are metabolic products of microorganisms. Pyrogens are produced by many microorganisms including bacteria, yeasts and molds. Pyrogens can be damaging if injected into a human being. One of the drawbacks of prior art pouches and methods of manufacturing them is that they may not be free from particulate matter and associated pyrogens.

It is an object of the present invention to overcome one or more of the above-described drawbacks and/or disadvantages of the prior art.

### SUMMARY OF THE INVENTION

In accordance with a first aspect, the present invention is directed to a method comprising the following steps:
(i) molding a tubular film including an inner surface and an outer surface, and blowing or otherwise directing micro-filtered air and/or other gas through the tubular film during molding;
(ii) flattening the molded tubular film;
(iii) sealing the flattened tubular film at spaced locations, cutting the sealed film at the spaced locations, and forming one or more empty pouches;
(iv) over-molding a fitment to the outer surface of one or more empty pouches and forming a fluid-tight seal between the fitment and the interior of the pouch; and
(v) preventing the collection of particles on the inner surface of the pouch, and exposure of the inner surface to the ambient atmosphere throughout steps (i) through (iv).

In some embodiments of the present invention, step (i) includes blown film extrusion molding (BFM) the tubular film. In some embodiments, step (i) includes molding a multiple layer tubular film including an inner layer defining a first melting temperature and an outer layer defining a second melting temperature. The first melting temperature of the inner layer is higher than the second melting temperature of the outer layer. In some such embodiments where the tubular film includes multiple layers, step (i) includes co-extrusion blown film molding (CEBFM) the tubular film. In some embodiments, the BFM or CEBFM includes blowing or otherwise introducing a flow of micro-filtered air and/or other gas through the interior of an extrusion or co-extrusion head and the tubular film. Preferably, an inner surface of the tubular film is at bactericidal temperature during step (i).

In some embodiments of the present invention, step (iv) includes molding a flange or base of the fitment in a first molding station, and over-molding a septum to the flange or base in a second molding station. In some such embodiments, the mold is a rotary mold, and step (iv) includes rotating the mold from the first molding station to the second molding station. Some embodiments further comprise rotating the mold containing the base or flange of the fitment, and presenting the base or flange of the fitment to a secondary molding station for over-molding the septum of the fitment thereto. Some embodiments comprise over-molding a base of the fitment onto the empty pouch, and then over-molding the septum to the base to thereby form a sealed, empty pouch. Other embodiments comprise over-molding the base and septum of the fitment to the pouch in the same mold. Some such embodiments comprise over-molding the base and septum of the fitment to the pouch at the same time. In some such embodiments, the base and septum of the fitment are made of the same or substantially the same material, such as a thermoplastic elastomer. Some embodiments further comprise opening the mold, and upon opening the mold, actuating a cam or other actuator to move a septum portion of the fitment into an at least partially closed position. Some embodiments of the present invention further comprise introducing an over-pressure of micro-filtered air and/or other gas through an open area of the mold for over-molding the fitment and/or septum of the fitment, and preventing the collection of particles on at least the interior surfaces of the molded fitment.

Some embodiments of the present invention comprise over-molding the septum onto a hinged portion of the fitment and forming a one-piece or integral fitment and septum. Some embodiments further comprise moving the hinged septum of the fitment into an at least partially closed position and preventing exposure of the inner surfaces of the septum and fitment to the ambient environment. Some such embodiments further comprise over-molding the septum to a hinged portion of the fitment, moving the septum about the hinge to close the fitment, and forming a sealed, empty pouch. In some such embodiments, step (iv) includes over-molding the fitment to the outer surface of the pouch in a rotary mold, rotating the mold and then over-molding the septum to the hinged portion of the fitment, automatically moving the septum about the hinge and closing the fitment, and de-molding the sealed, empty pouch from the mold.

Some embodiments of the present invention further comprise over-molding the fitment in a first mold cavity, molding a septum of the fitment in a second mold cavity, moving at least one of the first or second mold cavities toward the other, assembling the septum and fitment, and forming a sealed, empty pouch. In some such embodiments, the fitment is over-molded in a first mold, such as a cubic or rotary mold, and the septum is molded in a second mold, such as a cubic or rotary mold. Some such embodiments further comprise rotating the first and/or second molds of, for example, a double cubic mold, to align the septum and fitment, moving the aligned septum and/or fitment toward the other to assemble the septum and fitment, and de-molding the sealed, empty pouch. Some embodiments further comprise blowing or otherwise directing an over-pressure of micro-filtered air and/or other gas into or through an open area of the molds.

In some embodiments of the present invention, step (iii) includes sealing the flattened tubular film at spaced locations, and then cutting the sealed film at the spaced locations, to thereby form a plurality of empty pouches. Some embodiments comprise forming an aperture through the tubular film, and over-molding the fitment to the pouch along the periphery of or otherwise about the pouch aperture. Some embodiments comprise forming the pouch aperture by cutting the aperture through the one or more layers of the tubular film. Other embodiments comprise forming the pouch aperture by sealing an edge portion of the pouch at spaced locations relative to each other, and thereby forming the pouch aperture between sealed edge portions. In some embodiments, the pouch aperture is formed just prior to inserting the pouch into the mold. Some embodiments further comprise forming the pouch aperture and over-molding the fitment onto the periphery of or otherwise about the pouch aperture to seal the aperture. Some embodiments further comprise blowing or otherwise directing micro-filtered air and/or other gas into or through an opening of the mold for over-molding the fitment to the pouch.

In some embodiments of the present invention, step (iii) includes thermally sealing and/or cutting the tubular film. In some such embodiments, the cutting occurs substantially simultaneously with, or immediately upon, sealing. In some embodiments, the thermal sealing is performed with one or more of an impulse heat sealer, a continuous heat sealer, a hot bar heat sealer, a hot wire sealer, an induction sealer, and an ultrasonic welder or sealer.

In some embodiments of the present invention, the fitment and the outer surface of the film include the same or substantially the same polymer. In some such embodiments, both the outer surface of the film and at least the portion of the fitment over-molded thereto are polypropylene. In some embodiments, an inner layer of the tubular film is a copolyester elastomer (COPE).

Some embodiments of the present invention further comprise cutting or otherwise forming an aperture through a sealed edge portion of a pouch, and over-molding a fitment onto opposing sides of the pouch and about the periphery of the pouch aperture to seal the aperture. In some such embodiments, the pouch aperture is formed prior to insertion of the pouch into the mold for over-molding the fitment thereto, or is formed within the mold prior to over-molding the fitment thereto. In some embodiments, the pouch aperture is formed in the pouch with the pouch located adjacent to, or otherwise in close proximity to, and/or is formed immediately prior to insertion of the pouch into, the mold for over-molding the fitment thereto. Some embodiments further comprise maintaining the pouch in a flattened condition during forming the pouch aperture therethrough, and/or directing an over-pressure of micro-filtered air or other gas onto the pouch during formation of the pouch aperture therein.

Some embodiments of the present invention further include over-molding a flexible portion of the fitment by forming a reduced cross-sectional thickness as compared to other portions of the fitment and/or by forming the fitment or a portion thereof from a flexible material, such as the same or substantially the same material used to form the septum. Some such embodiments further include molding a fitment including a base that is over-molded to the outer surface of the pouch and extends along or about the periphery of the pouch aperture. A port of the fitment extends from the base and defines a fitment aperture in fluid communication with the pouch aperture. In some embodiments, a junction of the base and port defines a reduced cross-sectional thickness to allow flexing of the base and/or port relative to the other. Some embodiments further include over-molding a septum onto a septum support, and moving the over-molded septum into a port aperture to at least partially close the port aperture and prevent exposure of the interior surfaces of the septum and port aperture to the ambient environment. Some embodiments further comprise molding the fitment with a hinge and septum support connected by the hinge to the fitment, over-molding the septum to the septum support, and moving the over-molded septum about the hinge at least partially into the port aperture.

In some embodiments of the present invention, during step (iv), the over-molding of the fitment at least partially melts an outer layer of a multiple layer tubular film and thermally bonds the fitment thereto, but does not melt an inner layer of the tubular film, and thereby maintains a separateness between the opposing inner surfaces of the inner layer at the over-molded fitment.

In accordance with another aspect, the present invention is directed to a sealed, empty pouch, wherein the interior of the pouch is particle free. The pouch is made in accordance with the following method:
(i) molding a tubular film including an inner surface and an outer surface, and blowing or otherwise directing micro-filtered air and/or other gas through the tubular film during molding;
(ii) flattening the molded tubular film;
(iii) sealing the flattened tubular film at spaced locations, cutting the sealed film at the spaced locations, and thereby forming one or more empty pouches;
(iv) over-molding a fitment to the outer surface of each of one or more empty pouches; and
(v) preventing the collection of particles on the inner surfaces of the pouch, and the exposure of such surface to the ambient atmosphere throughout steps (i) through (iv).

In some embodiments of the present invention, step (i) includes molding a multiple layer tubular film including an inner layer defining a first melting temperature and an outer layer defining a second melting temperature. The first melting temperature of the inner layer is higher than the second melting temperature of the outer layer. In some embodiments, the inner surfaces of the pouch are sterile and sealed with respect to ambient atmosphere.

In accordance with another aspect, the present invention is directed to a pouch comprising a tubular film including an inner surface and an outer surface, a first end edge portion extending from approximately one side of the pouch to another side of the pouch, and a second end edge portion located on an opposite end of the pouch relative to the first end edge portion, and extending from approximately one side of the pouch to another side of the pouch. The opposing surfaces of the tubular film are sealed to each other at the first end and second end edge portions, and define an interior chamber between opposing inner surfaces of the tubular film. In some embodiments, the interior chamber extends from the first end to the second end, and from one side to another side of the pouch. The pouch defines a pouch aperture in fluid communication with the interior chamber, and extending through the tubular film and/or between opposing edge portions of the pouch. A fitment is over-molded to the outer surface of the pouch along a periphery of the pouch aperture. The outer surface of the tubular film is at least partially melted and thermally bonded to the fitment to thereby form a fluid-tight seal between the pouch and fitment about the pouch aperture.

In some embodiments of the present invention, the pouch comprises a multiple layer tubular film including an inner layer and an outer layer. The inner layer defines a first melting temperature and the outer layer defines a second melting temperature. The first melting temperature of the inner layer is higher than the second melting temperature of the outer layer. The outer layer of the tubular film is at least partially melted and thermally bonded to the fitment, but the inner layer of the tubular film is not melted and separateness is maintained between the opposing inner surfaces of the inner layer at the over-molded fitment.

In some embodiments of the present invention, the interior chamber of the pouch is hermetically sealed with respect to the ambient atmosphere. In some such embodiments, the interior chamber of the pouch is aseptic and/or sterile. In some embodiments, the interior chamber of the pouch is particle free. In some embodiments, the interior chamber of the pouch is pyrogen free. In some embodiments, the interior chamber of the pouch is empty.

In some embodiments of the present invention, the over-molded fitment includes a flexible portion defined by (i) a reduced cross-sectional thickness as compared to other portions of the fitment and/or (ii) a flexible material, such as the same or substantially the same material used to form the septum of the fitment. In some such embodiments, the fitment includes a base over-molded to the outer layer of the pouch and extending along or about the periphery of the pouch aperture. A port of the fitment extends from the base and defines a fitment aperture in fluid communication with the pouch aperture. In some such embodiments, a junction of the base and port defines a reduced cross-sectional thickness and/or is formed of a flexible material that allows flexing of the base and/or port relative to the other. In some embodiments, the fitment includes a septum support and an elastic septum over-molded to the septum support. In some such embodiments, the septum support is fixedly secured to the port and the septum seals the port aperture. In some embodiments, the septum is elastic and forms axial and/or radial seals between the septum and port. In some embodiments, the septum support is movable between a first position for over-molding the septum thereto, and a second position for moving the over-molded septum into the port aperture to at least partially close the port aperture and prevent exposure of the interior surfaces of the septum and port aperture to the ambient environment. In some such embodiments, the fitment includes a hinge that movably connects the septum support to the fitment.

In some embodiments, the fitment includes a septum over-molded thereto and hermetically sealing the fitment and pouch aperture with respect to ambient atmosphere. The fitment is penetrable by a needle or other injection member for penetrating the septum, and sterile or aseptic filling a substance thereto into the interior chamber. The resulting penetration aperture in the septum is resealable by applying one or more of heat, radiation, liquid sealant, or mechanical closure thereto.

In some embodiments of the present invention, a pouch aperture extends through outer and inner layers of a multiple layer tubular film on opposing sides of the tubular film relative to each other. The fitment base is over-molded to the outer layer of the tubular film on opposite sides of the tubular film relative to each other. In some embodiments, the pouch aperture extends through an end edge portion of the pouch, and the fitment base extends over the respective end edge portion and over opposite sides of the pouch relative to each other.

In some embodiments of the present invention, the pouch further includes a closure overlying the septum and forming a fluid-tight seal between the septum and the ambient atmosphere. In some such embodiments, the closure is substantially inflexible. In some embodiments, the closure if formed of a hot-melt adhesive sealant overlying the septum and bonded to a septum support extending about a periphery of the septum. In some such embodiments, the hot-melt closure substantially conforms to the shape or morphology of the septum at the interface therebetween, but is not bonded thereto.

In some embodiments of the present invention, the pouch defines a first interior chamber and a second interior chamber, and a sealed portion extending between the first and second chambers. In some such embodiments, the sealed portion defines a frangible seal. In some embodiments, the frangible sealed is defined by opposing surfaces of the tubular film sealed to each other. Some embodiments further comprise a first pouch aperture in fluid communication with the first interior chamber, a second pouch aperture in fluid communication with the second interior chamber, a first fitment over-molded to the outer surface along a periphery of the first pouch aperture, and a second fitment over-molded to the outer surface along a periphery of the second pouch aperture. Some such embodiments further comprise a third pouch aperture in fluid communication with the second interior chamber, and a third fitment over-molded to the outer surface along a periphery of the third pouch aperture. In some embodiments, the second and third fitments are located on substantially opposite sides of the pouch relative to each other.

In accordance with another aspect, the present invention is directed to a pouch comprising a tubular film including an inner surface and an outer surface, a first end edge portion extending from approximately one side of the pouch to another side of the pouch, and a second end edge portion located on an opposite end of the pouch relative to the first end edge portion and extending from approximately one side of the pouch to another side of the pouch. The opposing surfaces of the tubular film are sealed to each other at the first end and second end edge portions, and define an interior chamber between opposing inner surfaces of the tubular film extending from the first end to the second end, and from one side to another side of the pouch. The pouch defines a pouch aperture that is in fluid communication with the interior chamber and extends through the outer and inner surfaces of the tubular film on at least one side of the pouch and/or between opposing edge portions of the pouch. The pouch further includes first means over-molded to the outer surface of the pouch along a periphery of the pouch aperture, for sealing the pouch aperture and introducing a substance therethrough for filling the interior pouch chamber with the substance and/or withdrawing a substance in the pouch chamber therethrough. The outer surface of the tubular film is at least partially melted and thermally bonded to the first means to thereby form a fluid-tight seal between the first means and pouch about the pouch aperture.

Some embodiments of the present invention further comprise second means over-molded to the first means for sealing the first means and for filling the interior pouch chamber therethrough. In some embodiments, the first means is a fitment and the second means is an elastic septum.

In accordance with another aspect, the present invention is directed to a method comprising the following steps: (i) penetrating an elastic septum of a device with a needle or other injection member; (ii) introducing a substance through the needle and into a sealed chamber in fluid communication with the elastic septum; (iii) withdrawing the needle from the septum; (iv) sealing a resulting needle hole in the septum by introducing a liquid hot-melt adhesive sealant onto the septum and covering the septum and the resulting needle hole with the liquid hot-melt sealant; and (v) allowing the liquid hot-melt sealant to cool, transition from a liquid to a solid, and form a substantially inflexible closure overlying the septum. In some embodiments of the invention, the device is a pouch, a vial, a syringe, or a container.

In some embodiments of the invention, the method further comprises heating the liquid hot-melt sealant to a bactericidal temperature, applying the liquid hot-melt sealant onto the septum at the bactericidal temperature, and sterilizing the interface between the hot-melt sealant closure and the septum. Some embodiments further comprise fixedly bonding the liquid hot-melt sealant to a septum support extending about a periphery of the septum, and forming a fluid-tight seal between the septum and ambient atmosphere. Some embodiments further comprise substantially conforming the hot-melt sealant to the shape or morphology of the septum at the interface of the sealant and septum, but not bonding the sealant to the septum.

One advantage of the present invention, and/or of the disclosed embodiments thereof, is that the inner surface of the pouch may be free of particulate matter and pyrogens. Another advantage is that the inner surface of the pouch may be sterile without requiring the pouch to be subjected to additional sterilization processes, such as gamma or other forms of radiation, or terminal sterilization. Yet another advantage is that the methods of the invention may prevent exposure of the inner surface of the pouch to the ambient environment from the time of formation until final assembly of the pouch, thus allowing for the formation of a pouch with a sterile, particle-free and pyrogen-free interior chamber. The interior chamber may be sterile or aseptically filled through the elastic septum with a closed needle or like injection member such that the sterile or aseptic product may be maintained sterile, particle-free and/or pyrogen free within the sealed interior chamber of the pouch.

Another advantage of embodiments of the invention is that the septum and fitment can be closed within the mold, such as by rotation and/or other movement of rotary molds, or by a robot, such as a pick and place robot, that picks the pouch over-molded with the fitment, and places the septum into the fitment to seal the fitment and pouch, right off or adjacent to the mold. As a result, the inner surfaces of the fitment, its septum, and the pouch, are prevented from exposure to the ambient environment.

Yet another advantage is that the pouch may define multiple compartments or interior chambers separated by frangible portions, such as frangible seals, allowing the pouch to be filled with different products and/or products in different chambers, that may be premixed prior to dispensing or delivery by breaking the frangible seal(s), and/or the products may be delivered/dispensed in series from one chamber, and then another, such as to first dispense a saline that may be used, for example, to purge an IV line, and to then dispense the API for delivery through the line to the patient.

Other objects and/or advantages of the present invention, and/or of the embodiments thereof, will become more readily apparent in view of the following detailed description and accompanying drawings.

### BRIEF DESCRIPTION OF THE DRAWINGS

FIG. 1 is a perspective view of a CEBFM multiple layer, tubular film in a flattened, rolled form, prior to cutting into a plurality of pouches;

FIG. 2 is a perspective view of a pouch formed from the flattened, rolled CEBFM multiple layer, tubular film of FIG. 1, wherein the tubular film is collapsed (or flattened), the lengthwise sides of the tubular film are creased, and the opposing end marginal edge portions may be thermally sealed, such as by impulse sealing, and cut to form the respective pouch;

FIG. 3A is a plan view of a pair of rotary cubic molds, wherein the pouch aperture is formed in one of the end marginal edge portions of the pouch that is inserted into the right-hand mold, preferably under an over-pressure of micro-filtered air, the fitment is over-molded to the pouch in the right-hand mold, the septum is over-molded to the septum support/mold ring in the left-hand mold, and as indicated by the arrows, the two molds are rotated to align the over-molded septum with the over-molded fitment;

FIG. 3B is a plan view of the molds of FIG. 3A illustrating the right-hand mold moved toward the left-hand mold to, in turn, insert the over-molded septum of the left-hand mold into the fitment aperture in the right-hand mold, preferably under an over-pressure of micro-filtered air, to assemble the septum to the fitment aperture, and seal the interior of the fitment with respect to the ambient atmosphere;

FIGS. 4A-4C are perspective, front elevational, and side elevational views, respectively, of the fitment over-molded to the pouch, and illustrating the reduced cross-sectional thickness portions of the fitment to facilitate flexing of the fitment port (and septum assembled or over-molded thereto) relative to the fitment base and pouch, and to allow flexing of the opposing sides of the fitment base relative to each other;

FIG. 5 is a perspective view illustrating a pouch inserted into a mold for over-molding the fitment thereto;

FIG. 6 is an exploded, perspective view of the mold and fitment over-molded to the pouch therein;

FIG. 7 is an exploded, perspective view of the pouch with fitment over-molded thereto, and the septum over-molded to the septum support/mold ring, prior to assembly of the septum to the fitment;

FIG. 8 is a perspective view of the pouch with over-molded fitment and septum sealed thereto;

FIGS. 9A-9C are front elevational, side elevational, and partial cross-sectional views, respectively, of the fitment over-molded to the pouch;

FIG. 10 includes perspective views of the CEBFM multiple layer, tubular film in a flattened, rolled form, prior to cutting into a plurality of pouches, and illustrating the manner in which the tubular film is collapsed to prevent exposure of the interior surfaces of the tubular film to the ambient atmosphere;

FIG. 11A is an upper perspective view of a pouch with the ends heat sealed, and cut from the rolled film of FIG. 10, and with a pouch aperture formed in an end marginal edge portion of the pouch; and FIG. 11B is a side elevational view of the pouch of FIG. 11A with a fitment over-molded thereto, wherein the fitment is sealed to the outer layer of the pouch along the periphery of the pouch aperture, and includes a double port, wherein one of the ports includes a hinged, over-molded septum;

FIG. 12 is a series of views showing the processing of the pouch from BFM or CEBFM of the tubular film to impulse heating sealing and cutting the flattened tubular film at a plurality of spaced, end marginal edge portions to form a plurality of pouches therefrom, and further illustrating a fitment with hinged septum that is over-molded to a respective pouch;

FIG. 13 is an upper plan view of a rotary cubic mold including a first station where the pouch with pouch aperture formed therein is inserted into the mold; rotation of the mold and pouch to a second station where the fitment is over-molded to the pouch about a periphery of the pouch aperture; rotation of the mold to a third station where the septum is over-molded to the hinged mold ring of the fitment; and rotation of the mold to a fourth station where the hinged, over-molded septum is automatically moved into the closed position to seal the port aperture of the fitment and, in turn, de-mold the pouch from the mold;

FIGS. 14A-14B are front elevational and side elevational views, respectively, of the fitment with the hinged, over-molded septum, that is over-molded to the pouch, and illustrating the reduced cross-sectional thickness portions of the fitment to facilitate flexing of the fitment port (including the septum assembled or over-molded thereto) relative to the fitment base and pouch, and to allow flexing of the opposing sides of the fitment base relative to each other;

FIG. 15A is a perspective view of another embodiment of a CEBFM multiple layer, tubular film in a flattened, rolled form, prior to cutting into a plurality of pouches, illustrating the manner in which the tubular film is collapsed to prevent exposure of the interior surfaces of the tubular film to the ambient atmosphere, and including an additional seal extending between the creased marginal edge portions of each pair of adjacent pouches in order to form each pouch with a label-receiving marginal edge portion;

FIG. 15B is a perspective view of one of the pouches cut from the film of FIG. 15A, and showing the label-receiving marginal edge portion open and ready to receive a label therein;

FIG. 16 is a perspective view of the pouch of FIG. 15B showing a pouch aperture in one of the creased marginal edge portions of the pouch, wherein the pouch aperture may be die cut prior to or after insertion in the mold for over-molding a fitment thereto;

FIG. 17 is a perspective view of the pouch of FIG. 16 showing a double-port fitment over-molded to a creased, marginal edge portion of the pouch and sealing the pouch aperture;

FIG. 18 is a perspective view of the pouch of FIG. 17 showing a label partially inserted into the label-receiving marginal edge portion of the pouch;

FIG. 19 is a perspective view of the pouch of FIG. 18 showing the opposing sides of the label-receiving marginal edge portion in a flattened condition with the label received therebetween and in position for sealing the open edge;

FIG. 20 is a perspective view of the pouch of FIG. 19 showing the outer edge of the label-receiving marginal edge portion in a sealed condition and enclosing the label therein;

FIG. 21 is a side plan view of the pouch of FIG. 18 showing an RFID tag and radiation dosimeter on the label;

FIG. 22 is a perspective view of another embodiment of a pouch having a marginal edge portion located on a bottom edge of the pouch with a label therein and an RFID tag and radiation dosimeter on the label;

FIG. 23 is a perspective view of another embodiment of a pouch including an over-molded fitment with two septa, where the fitment and septa are formed of an elastic material;

FIG. 24 is a perspective view of the pouch and septum support of FIG. 23 positioned as in a mold, and illustrating the core pins for over-molding the elastic fitment thereto;

FIG. 25 is a perspective view of the pouch, septum support and core pins of FIG. 24 showing the core pins positioned as they would be when inserted in the mold, wherein the base of the right core pin is received through an aperture formed in a tab extending from the marginal edge of the pouch for over-molding the fitment thereto;

FIG. 26 is perspective view of the pouch, septum support and core pins of FIG. 25 positioned as they would be after over-molding the elastic fitment to the tab of the pouch, wherein the right core pin is received within the fitment through a slot in the right edge of the fitment;

FIG. 27 is a perspective view of the pouch of FIG. 26 showing the withdrawal of the core pins upon opening the mold, and the manner in which the elastic fitment expands about the slot in its right edge during withdrawal of the right core pin therethrough;

FIG. 28 is a perspective view of the pouch of FIG. 27 showing the pouch after withdrawal of the core pins, wherein the slot in the right edge of the fitment closes itself due to the elastic material and configuration of the fitment;

FIG. 29 is a perspective view of the pouch of FIG. 28 showing the pouch after the slot in the right edge of the fitment is sealed, such as by thermal sealing, to fixedly secure the fluid-tight seal between the fitment and pouch;

FIG. 30 is a perspective view of another embodiment of a pouch including two fitments laterally spaced relative to each other, wherein each fitment is over-molded to a respective tab in the marginal edge of the pouch, and each septum is over-molded to a respective hinged support;

FIG. 31 is a perspective view of the pouch of FIG. 30 prior to over-molding the fitments thereto, and illustrating the relative positioning of the pouch and core pins in a mold;

FIG. 32 is a perspective view of the pouch of FIG. 31 illustrating the core pins received within the pouch apertures extending through the tabs at the marginal edge of the pouch prior to over-molding the fitments thereto;

FIG. 33 is a perspective view of the pouch of FIG. 32 illustrating the over-molding of the fitments to the pouch tabs, including the formation of fluid-tight seals between each fitment base and tab about the respective pouch aperture, and the hinged septum supports;

FIG. 34 is a perspective view of the pouch of FIG. 33 illustrating removal of the core pins from the over-molded fitments;

FIG. 35 is a perspective view of the pouch of FIG. 34 illustrating the septa over-molded to the septa supports and prior to moving the hinged septa by a cam or like device into the port apertures to seal the ports as shown in FIG. 30;

FIG. 36 is a partial, perspective, cross-sectional view through the pouch of FIG. 30 illustrating a closed filling needle penetrated through a septum of one of the fitments and received within the port aperture for introducing a substance therethrough and into the pouch chamber for sterile or aseptic filling the pouch;

FIG. 37 is a side perspective view of the pouch of FIG. 36 illustrating the filling needle penetrating the septum of the fitment for sterile or aseptic filling the pouch therethrough.

FIG. 38 is a front elevational view of another embodiment of a pouch having a septum located on a hinged portion of the fitment that is movable about the hinge to at least a partially closed position to close the fitment, where the fitment is open and the pouch is being filled with substance through the open fitment;

FIG. 39 is a front elevational view of the pouch of FIG. 38 in which the septum is partially moved about the hinge;

FIG. 40 is a front elevational view of the pouch of FIG. 38 in which the septum is moved about the hinge so as to close the fitment and form a sealed pouch;

FIG. 41 is a front perspective view of another embodiment of a pouch in which the interior contains two chambers separated by a frangible portion;

FIG. 42 is a front perspective view of the pouch of FIG. 41 in which the two chambers are filled with substances;

FIG. 43 is a front perspective view of the pouch of FIG. 42 in which a transfer conduit is connected to a fitment in fluid communication with the right chamber;

FIG. 44 is a front elevational view of the pouch of FIG. 43 in which the substance in the right chamber has been transferred out of the pouch though the transfer conduit;

FIG. 45 is a front perspective view of the pouch of FIG. 44 in which the frangible portion has been broken so that the two chambers are in fluid communication with each other;

FIG. 46 is a front perspective view of the pouch of FIG. 45 in which the remaining substance in the pouch has been transferred out of the pouch through the transfer conduit;

FIG. 47 is a front perspective view of another embodiment of a pouch in which the interior contains two chambers separated by a frangible portion and the chambers are filled by substances;

FIGS. 48A and 48B are a schematic top view diagram and a schematic cross-sectional side view diagram, respectively, illustrating the operation of a pair of impulse sealers sealing the a fitment to a pouch in accordance with an embodiment of the invention;

FIG. 48C is another schematic top view diagram illustrating the operation of a pair of impulse sealers sealing a fitment to a pouch, in accordance with an embodiment of the invention;

FIG. 49A is a further schematic top view diagram illustrating the operation of a pair of impulse sealers sealing a fitment to a pouch, in accordance with an embodiment of the invention;

FIG. 49B is an enlarged schematic top view of area 801 of FIG. 49A;

FIG. 49C is an enlarged schematic side cross-sectional view of area 802 of FIG. 49A; and

FIG. 49D is a schematic side perspective view diagram illustrating impulse sealers of FIG. 49A.

### DETAILED DESCRIPTION OF EMBODIMENTS

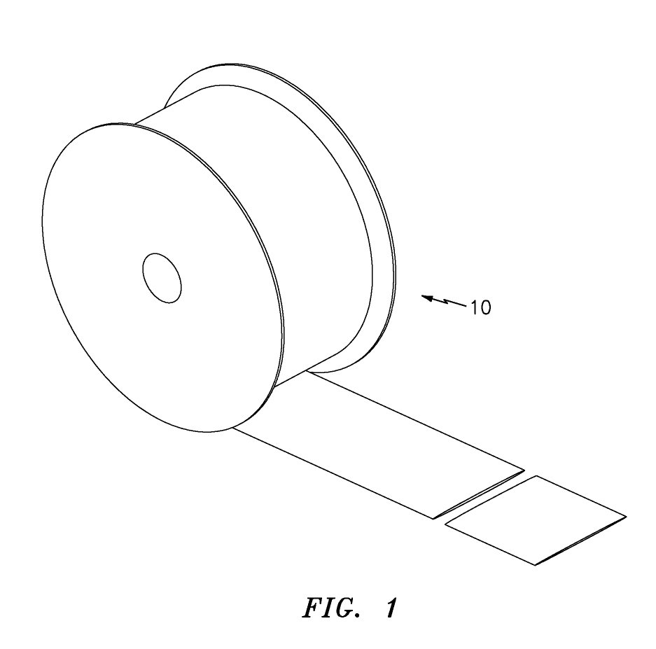

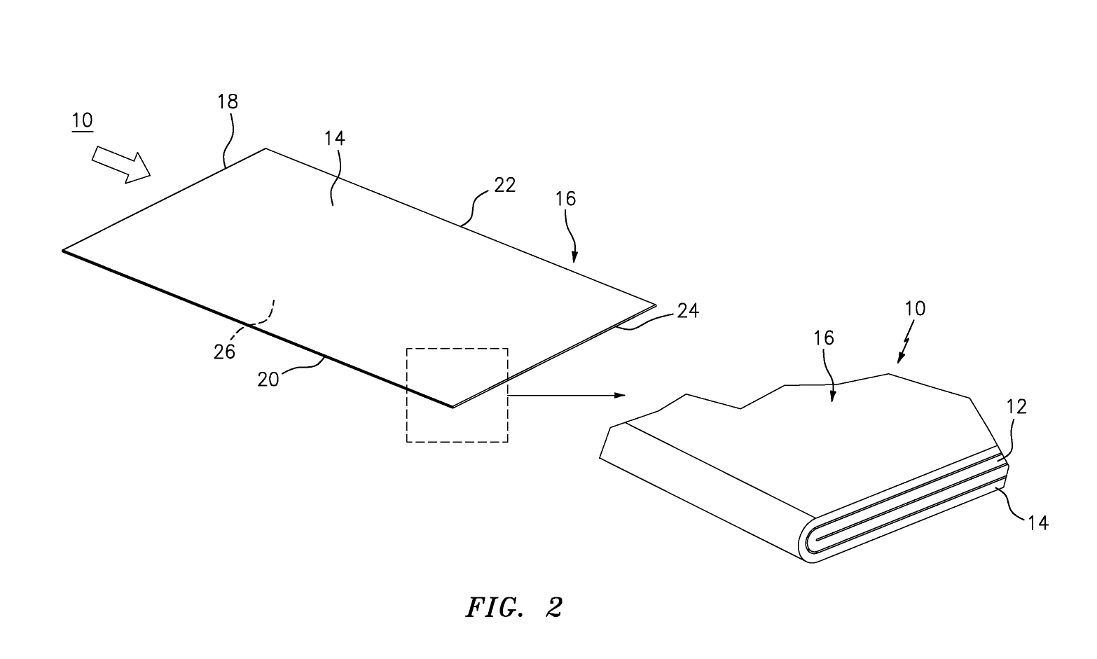

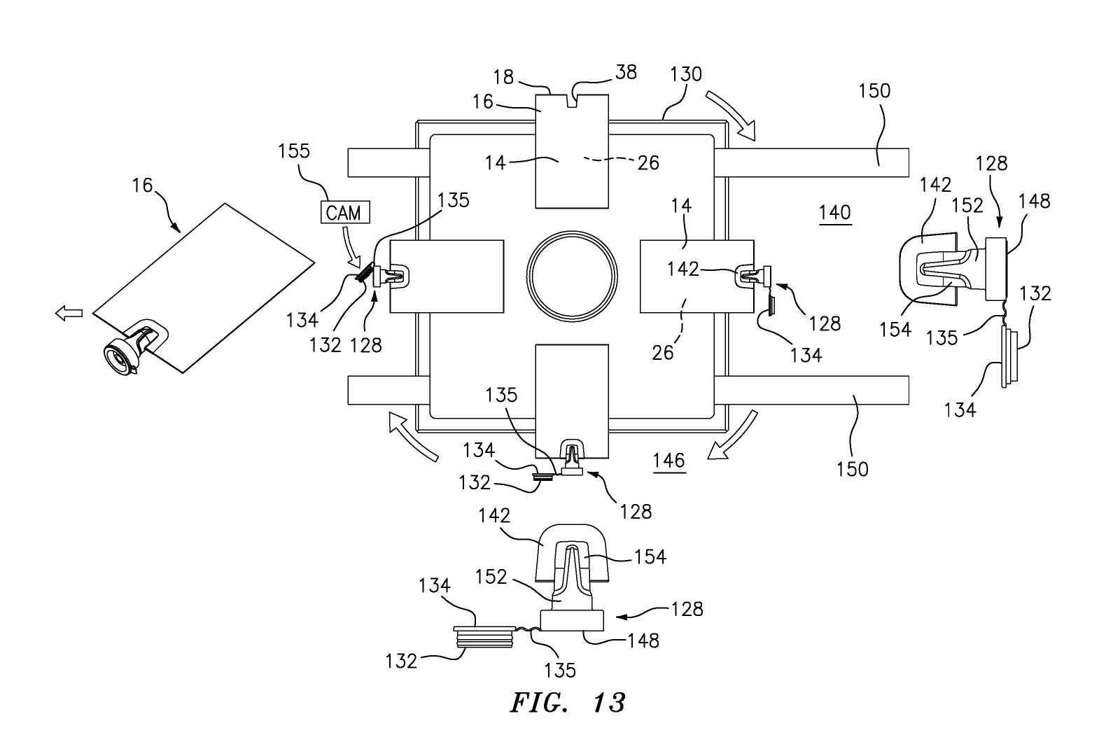

In FIG. 1, a multiple layer, tubular film in a flattened, rolled form, prior to cutting into a plurality of pouches, is indicated generally by the reference numeral 10. As shown typically in FIG. 2, the multiple-layer, tubular film 10 includes an inner layer 12 and an outer layer 14. The inner layer 12 defines a first melting temperature and the outer layer 14 defines a second melting temperature. The first melting temperature of the inner layer 12 is higher than the second melting temperature of the outer layer 14. In the illustrated embodiment, the inner layer 12 of the tubular film is a copolyester elastomer (COPE), and the outer layer 14 is polypropylene. However, as may be recognized by those of ordinary skill in the pertinent art based on the teachings herein, these materials are only exemplary and any of numerous other materials, fewer layers and/or any of numerous additional layers, that are currently known, or that later become known, may be employed. As described below, in some embodiments of the present invention, the tubular film need not include multiple layers; however, if multiple layers are desired, they may be employed. Preferably, the tubular film 10 is formed by BFM, or if it includes multiple layers, by CEBFM. The film 10 is in tubular form, and is formed by blowing or otherwise directing micro-filtered air and/or other gas through an extrusion head or co-extrusion head (if CEBFM is employed) and the interior of the tubular film as it is formed. The filtered air or other gas is micro-filtered to filter out viable and non-viable particulate matter and thereby provide a flow of sterile air or other gas in a manner known to those of ordinary skill in the pertinent art, such as by employing a micro-filter with a pore size of less than about 0.2 microns. When formed, the tubular film is at bactericidal or sterilization temperature, and therefore is sterile. Blowing or otherwise directing micro-filtered air and/or other gas through the tubular film during molding maintains the sterility of the interior surfaces of the film and otherwise prevents the collection of particulate matter within the interior of the tubular film. After the tubular film exits the extrusion head and approaches or reaches ambient temperature, the tubular film is flattened, such as by a pair of rollers, or a series of spaced pairs of rollers defining progressively less distance between the rollers (not shown), and the flattened tubular film is rolled onto a spool or otherwise is placed in rolled form, as indicated typically in FIG. 10. As a result of the foregoing manufacturing process, the interior surfaces of the rolled, flattened tubular film are sterile and particle free (including pyrogen free). Maintaining the film in the flattened rolled form prevents exposure of the interior surfaces of the film to the ambient environment, and thereby maintains the interior surfaces of the tubular film sterile and particle free (including pyrogen free).

As shown in FIG. 2, a plurality of individual pouches, as shown typically by the pouch 16, are formed from the flattened, rolled tubular film 10 by maintaining the tubular film in a flattened condition, sealing the flattened tubular film at spaced locations, cutting the sealed film at the spaced locations, and forming a plurality of empty pouches therefrom, as shown typically by the pouch 16. Each pouch 16 includes a first end marginal edge portion 18 extending from approximately one creased side 20 of the pouch to another creased side 22 of the pouch, and a second end marginal edge portion 24 located on an opposite end of the pouch relative to the first end marginal edge portion 18 and extending from approximately one side 20 of the pouch to the other side 22 of the pouch. The opposing surfaces of the tubular film 10 are sealed to each other at the first end and second end marginal edge portions 18 and 24, respectively, and define an interior chamber 26 (as indicated in broken lines) between opposing surfaces of the inner layer 12 of tubular film extending from the first end 18 to the second end 24, and from one side 20 to the other side 22 of the pouch. In the illustrated embodiment, the ends 18, 24 of each pouch 16 are sealed by thermal sealing, such as by impulse sealing, and are cut at the sealed, end marginal edge portions. In the illustrated embodiment, the end marginal end portions 18, 24 may be cut at substantially the same time as, or upon, sealing. During heat sealing, preferably, the opposing surfaces of the inner layer 12 are heat sealed to each other, and the outer layer 14 is heat sealed to the inner layer, along the respective end marginal edge portions 18, 24 of the pouch. As shown typically in FIG. 2, upon sealing the end marginal edge portions 18, 24, a sealed empty pouch 16 is formed. Each empty pouch 16 defines an interior chamber 26 that is sealed with respect to ambient atmosphere, and is sterile and particle free (including pyrogen free). One advantage of thermal sealing and cutting is that the heat seal sterilizes the surfaces during the sealing and cutting, and thereby facilitates maintaining the sterile, particle free condition of the interior surfaces of the pouch. However, as may be recognized by those of ordinary skill in the pertinent art based on the teachings herein, any of numerous different sealing and/or cutting operations or methods that are currently known, or that later become known, may be employed to seal and cut the end marginal edge portions of each pouch.

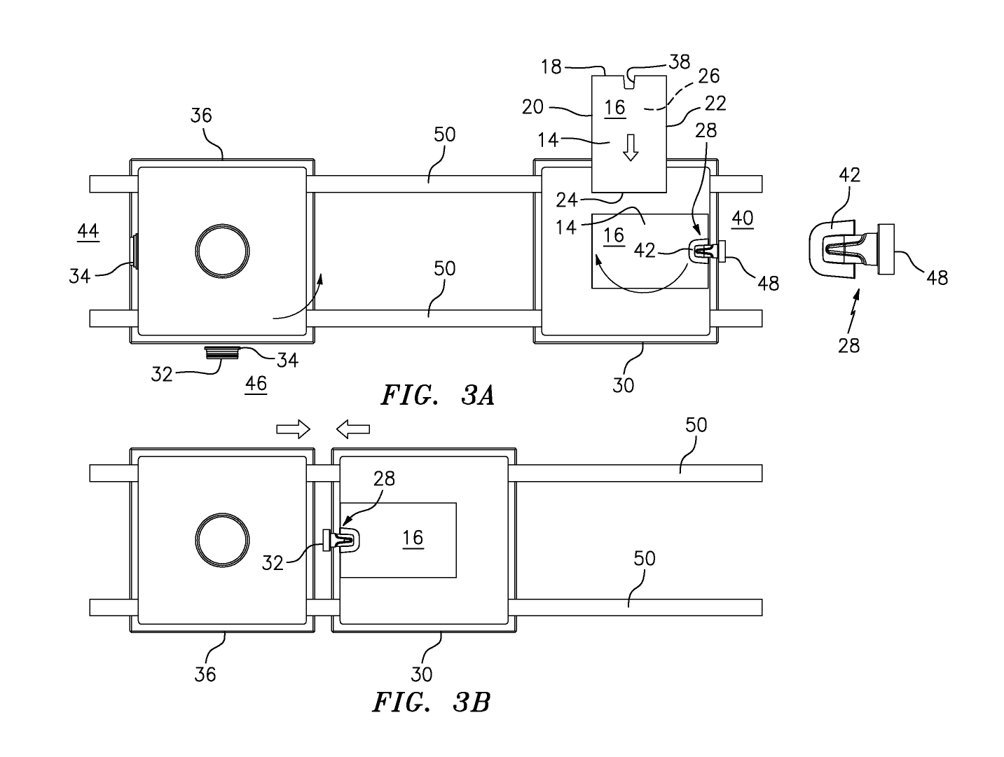

As shown in FIG. 3A, a fitment 28 is over-molded to each pouch 16 in a first rotary cubic mold 30, and a septum 32 is over-molded to a septum support/mold ring 34 in a second rotary cubic mold 36. Prior to insertion of the pouch 16 into the first mold 30, a pouch aperture 38 is formed, such as by die-cutting, through the first end marginal edge portion 18 of the pouch. Preferably, the pouch aperture 38 is cut or otherwise formed adjacent to the mold, and/or immediately prior to insertion of the pouch into the mold, with the pouch in a flattened or collapsed condition, and under an over-pressure of micro-filtered air and/or other gas, in order to maintain the sterile, particle free condition of the interior surfaces of the pouch. If the illustrated pouch aperture is formed outside the mold, it is preferably formed less than about 5 minutes prior to insertion into the mold, more preferably less than about 2 minutes prior to insertion into the mold, even more preferably less than about one minute prior to insertion into the mold, and even more preferably less than about 30 seconds prior to insertion into the mold. However, these times are only exemplary of the illustrated embodiment, and may be changed as required. Preferably, the pouch is maintained in a flat or collapsed condition, and an overpressure of sterile air or other gas is directed onto the pouch during the cutting and inserting steps. In addition, as may be recognized by those of ordinary skill in the pertinent art based on the teachings herein, the pouch aperture may take the form of any of numerous different shapes or configurations, and may be formed in any of numerous different locations, that are currently known, or that later become known, such as a between opposing, unsealed edge portions of a marginal edge of the tubular film, and the pouch may include any desired number of pouch apertures.

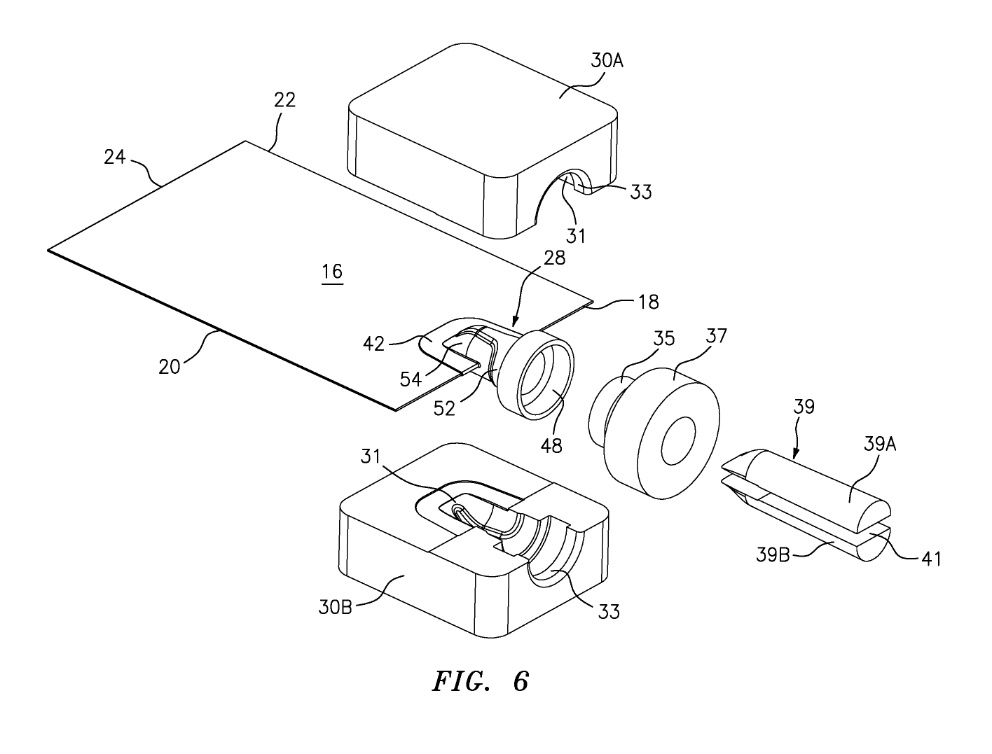

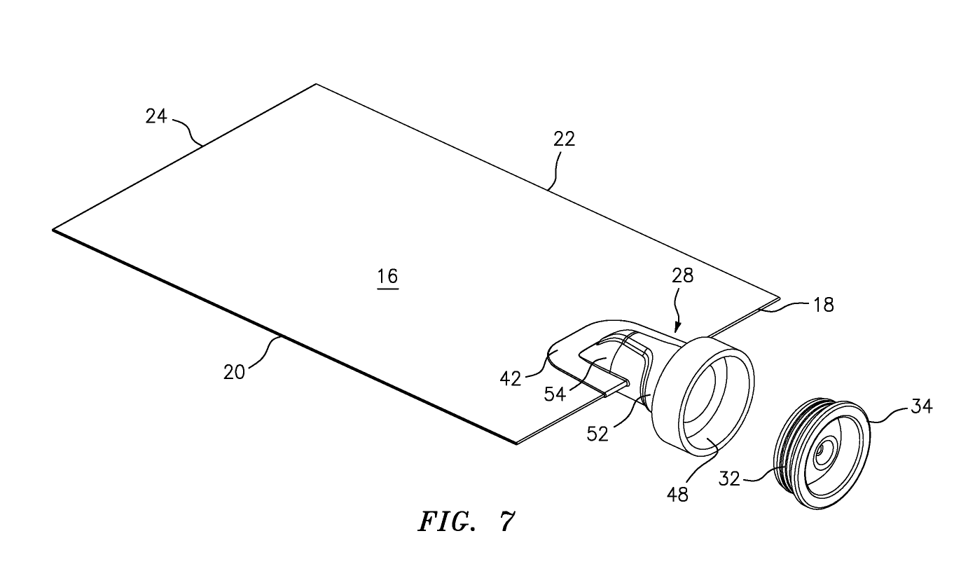

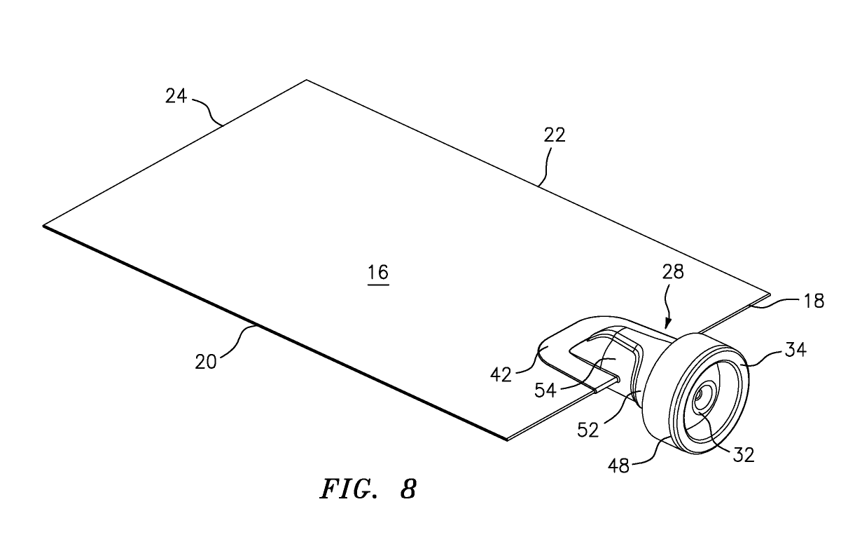

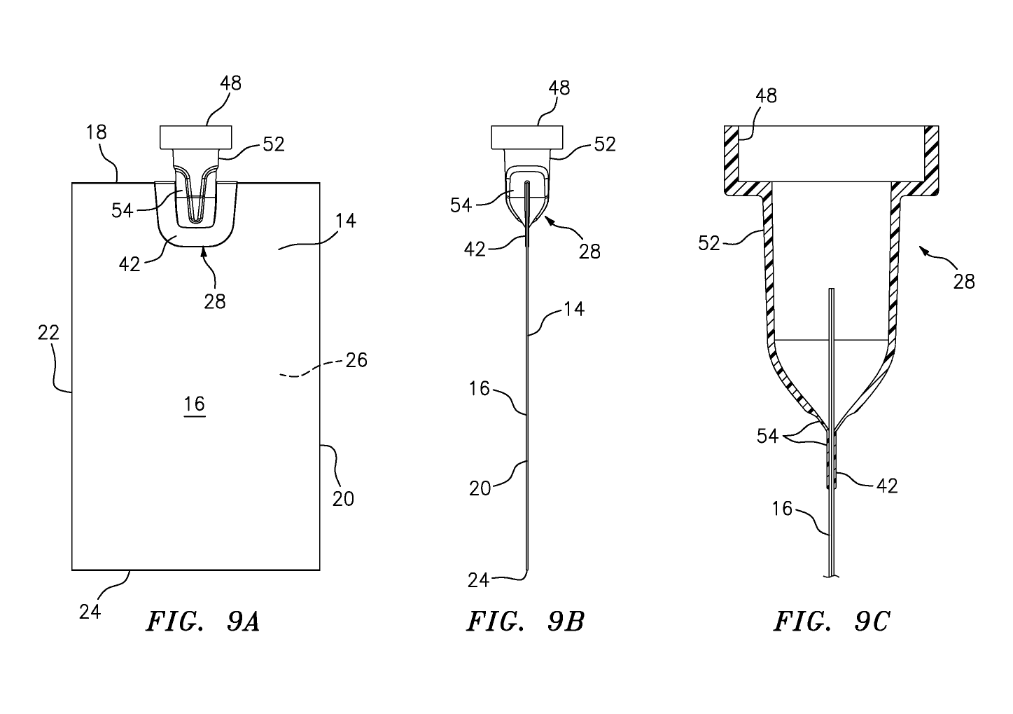

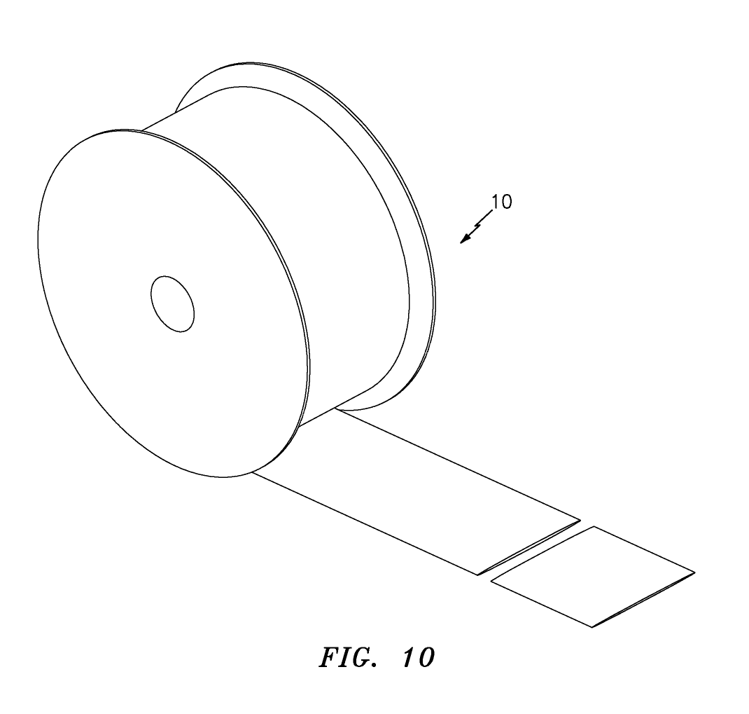

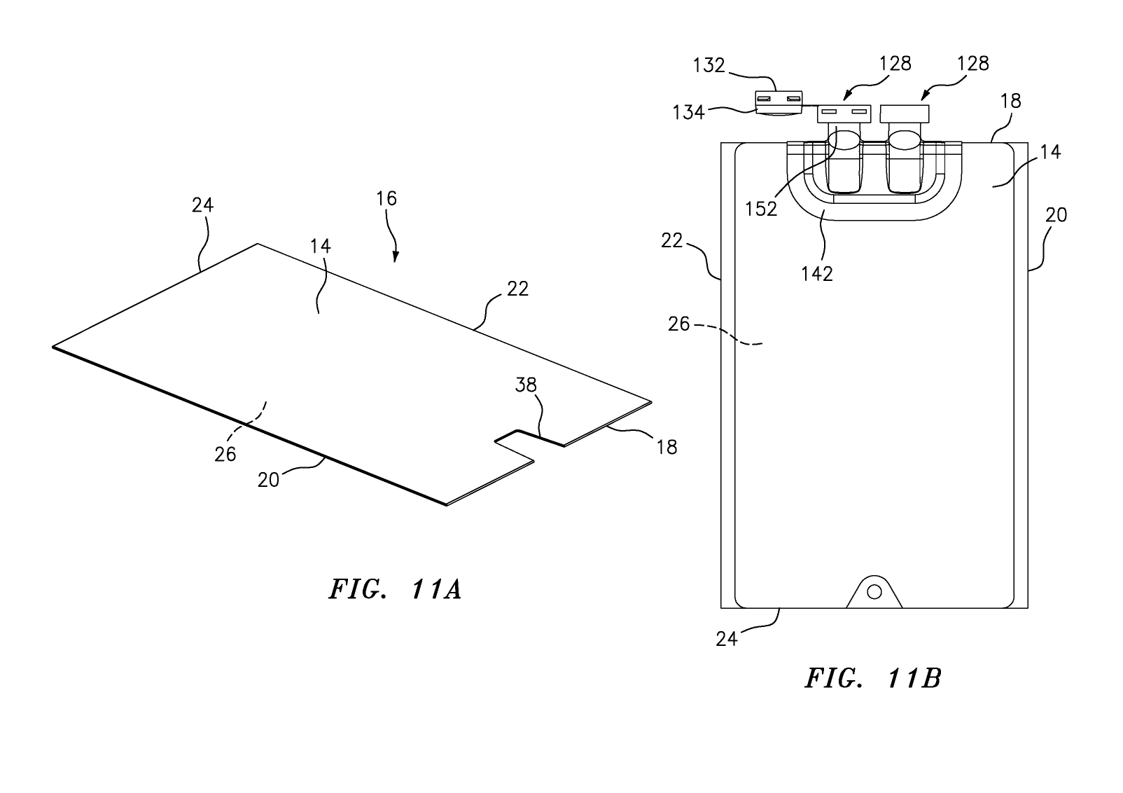

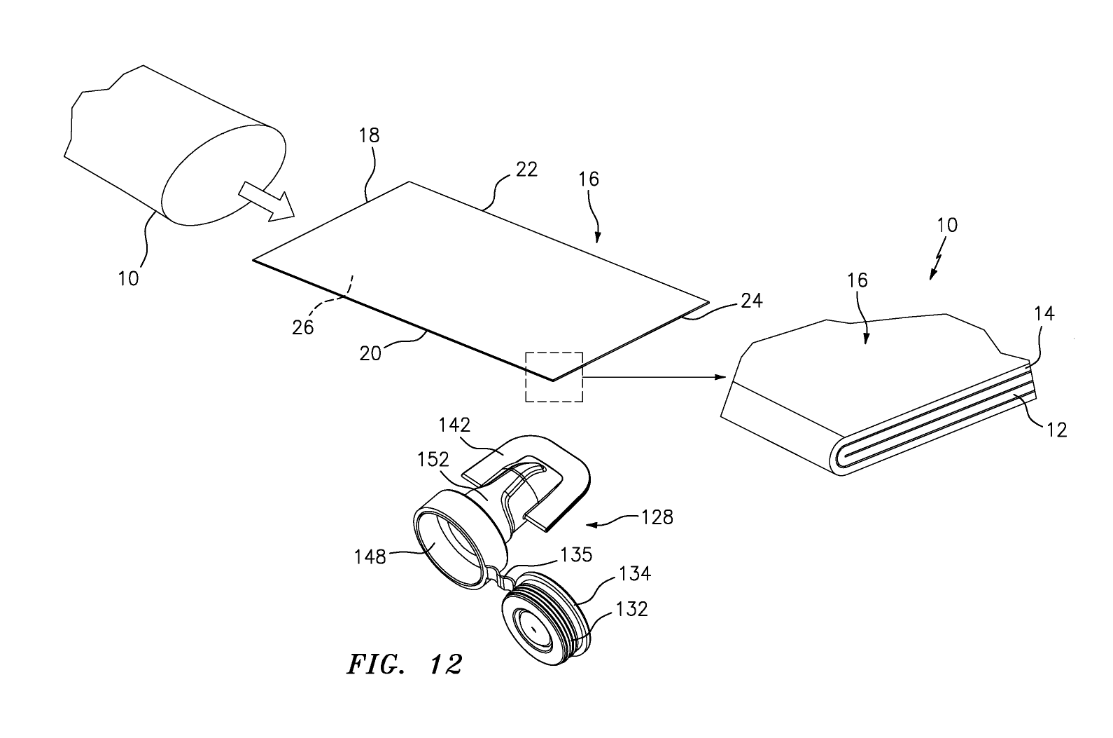

After the pouch 16 is inserted into the first mold 30, the first mold is rotated about 90° to a first molding station 40, and the fitment 28 is over-molded to the pouch in the first molding station. The base 42 of the fitment is over-molded to the outer surface/layer 14 of the pouch along the periphery of the pouch aperture 38 to thereby seal the pouch aperture with respect to the ambient atmosphere along its periphery. The over-molding of the fitment 28 at least partially melts the outer surface/layer 14 of the tubular film, and thermally bonds the fitment base 42 thereto, but does not melt the inner surface/layer 12 of the tubular film. As a result, separation is maintained between the opposing inner surfaces of the inner layer 12 at the over-molded fitment, and thus the integrity of the sealed, empty, sterile, particle-free interior chamber 26 of the pouch is not disturbed. In some such embodiments, the inner surface/layer 12 has a higher melting temperature than the outer surface/layer 14, helping to prevent melting of the inner surface/layer 12. As shown in FIGS. 5 and 6, the first mold 30 includes a first side 30A and a second side 30B, wherein at least one of the sides is movable relative to the other to open and close the mold. Each side 30A, 30B of the mold 30 defines a respective side of a mold cavity 31 that, along with a split core pin 39, delineates the shape of the fitment 28 that is over-molded to the portion of the pouch 16 inserted therein. Each side 30A, 30B of the mold 30 also defines a respective side of a mold inlet 33 to the mold cavity 31. The distal end of a tapered sleeve 35 of a mold inlet ring 37 is received within the mold inlet 33, and the split core pin 39 is received through the tapered sleeve and into the mold cavity 31. The split core pin 39 includes a first half 39A and a second half 39B, and defines a gap 41 formed therebetween. In order to over-mold the fitment onto the pouch, the portion of the pouch 16 defining the pouch aperture 38 is inserted into the open mold cavity 31. As shown typically in FIG. 5, the first and second sides 30A, 30B are moved into engagement with each other to close the mold cavity 31 and engage the pouch 16 between the two sides of the mold. The tapered sleeve 35 is inserted into the mold inlet 33 until the mold inlet ring 37 engages the periphery of the mold inlet 33. The split core pin 39 is inserted into the tapered sleeve 35 with the film defining the periphery of the pouch aperture 38 received within the gap 41 of the split core pin. As the split core pin 39 is moved further into the tapered sleeve 35, the tapered sleeve forces the first and second halves 39A, 39B of the split core pin toward each other and into engagement with the film defining the periphery of the pouch aperture 38 to engage the pouch and fix the relative position of the pouch and core pin within the mold. Molten plastic is then injected into the mold cavity 31 at one or more injection points (not shown) to over-mold the fitment to the pouch. The plastic injection points may be located on one side 30A or 30B of the mold, or for balance, may be located on both sides of the mold. As can be seen, the inner surfaces of the pouch are never exposed to the ambient environment during the over-molding process, and therefore the sterile and particle-free, pyrogen-free condition of the interior surfaces of the pouch is preserved throughout the process.

As shown in FIGS. 7 and 8, the fitment 28 includes a port 52 extending laterally from the base 42, and the port defines a port aperture 48 that receives therein the septum 32. As shown in FIGS. 3A and 3B, while the fitment 28 is over-molded to the pouch 16 in the first mold 30, the mold ring 34 is molded in a first molding station 44 of the second mold 36. Then, the second mold 36 is rotated about 90° to present the mold ring 34 to a second molding station 46 of the second mold where the septum 32 is over-molded to the mold ring. Then, as indicated by the arrows in FIG. 3A, the first mold 30 is rotated about 180° and the second mold 36 is rotated another about 90° to align the over-molded septum 32 with the port aperture 48 of the fitment 28. Then, as indicated by the arrows in FIG. 3B, the first mold 30 is driven laterally along spaced rails 50 toward the second mold 36 until the septum 32 is received within the port aperture 48 of the fitment 28 to assemble the over-molded septum to the fitment and seal the port aperture of the fitment. As shown typically in FIGS. 7 and 8, the mold ring 34 with over-molded septum 32 is received within the port aperture 48 of the fitment 28. The septum 34 forms both annular axial and annular radial dry compression seals with the respective annular surfaces of the port to hermetically seal the port aperture. The mold ring 34 may be fixedly secured to the port within the port aperture 48 in any of numerous different ways that are currently known, or that later become known, such as by a snap-fit connection, by a pressed friction fit within the port aperture, or by bonding the mold ring to the port, such as by the use of an adhesive, or by welding or other thermal bonding, such as by ultrasonic welding. During the molding process, an over-pressure of micro-filtered air and/or other gas is directed onto the first and second molds 30 and 36, respectively, their mold stations 40, 44 and 46, respectively, any openings to the mold at each mold station, and the space between the two molds, in order to maintain the sterile and particle free condition of the interior surfaces of the pouch, fitment and septum, during the molding and assembly process. The molding and assembly steps may take less than about 10 seconds, preferably less than about 5 seconds, and more preferably less than about 2 seconds. The two molds are then moved apart, the pouch 16 with over-molded fitment 28 (including septum 32) is de-molded or otherwise removed from the first mold 30, and the foregoing process is repeated for other pouches.

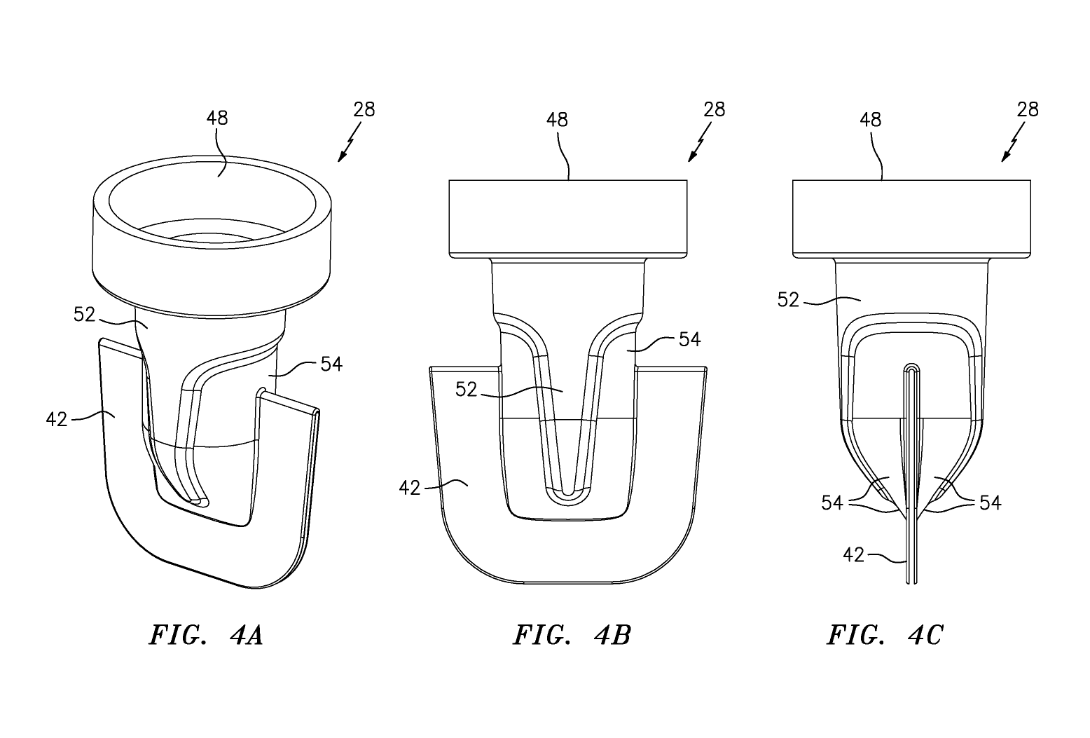

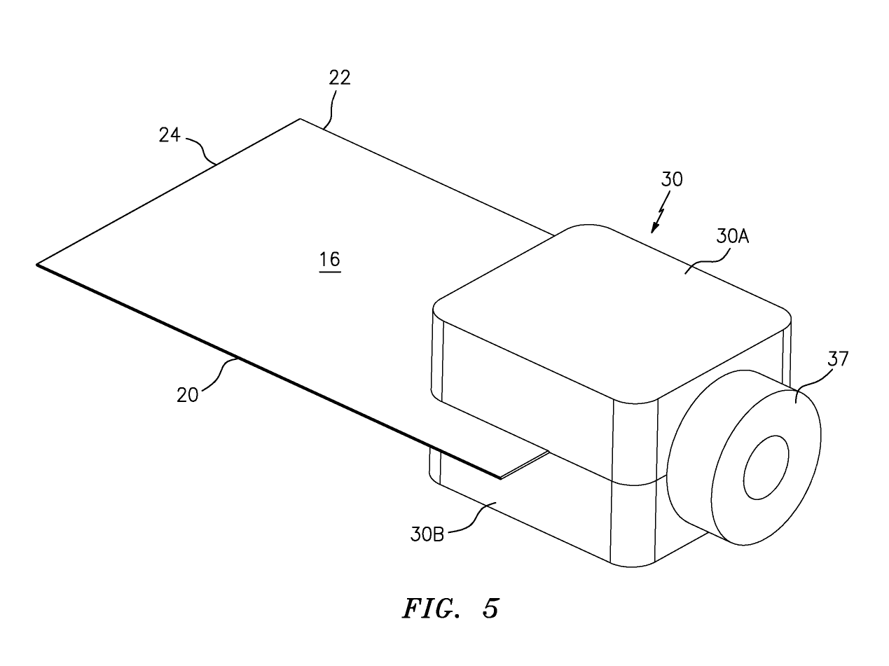

As shown typically in FIGS. 4A-C, each fitment 28 includes a base 42 over-molded to the outer surface/layer 14 of the pouch and extending along or about the periphery of the pouch aperture 38, and a port 52 extending from the base and defining the fitment aperture 48 in fluid communication with the pouch aperture 38. As shown in FIGS. 4A-C, the junction 54 of the base 42 and port 52, and the base 42 define a reduced cross-sectional thickness as compared to the remainder of the port 52. The reduced thickness allows flexing of the base 42 and/or port 52 relative to the other to facilitate de-molding, and allows movement of the opposing sides of the base 42 relative to each other and with movement of the opposing walls of the respective pouch, such as during filling of the pouch. The relatively thick sections of the port 52 facilitate mold flow and impart structural rigidity. It should be understood by those of ordinary skill in the art that the reduced thickness(es) may be located at other locations than, and have different configurations than, those shown in the illustrated embodiment, and nevertheless function to facilitate de-molding and/or allow movement of the opposing sides of the base 42.

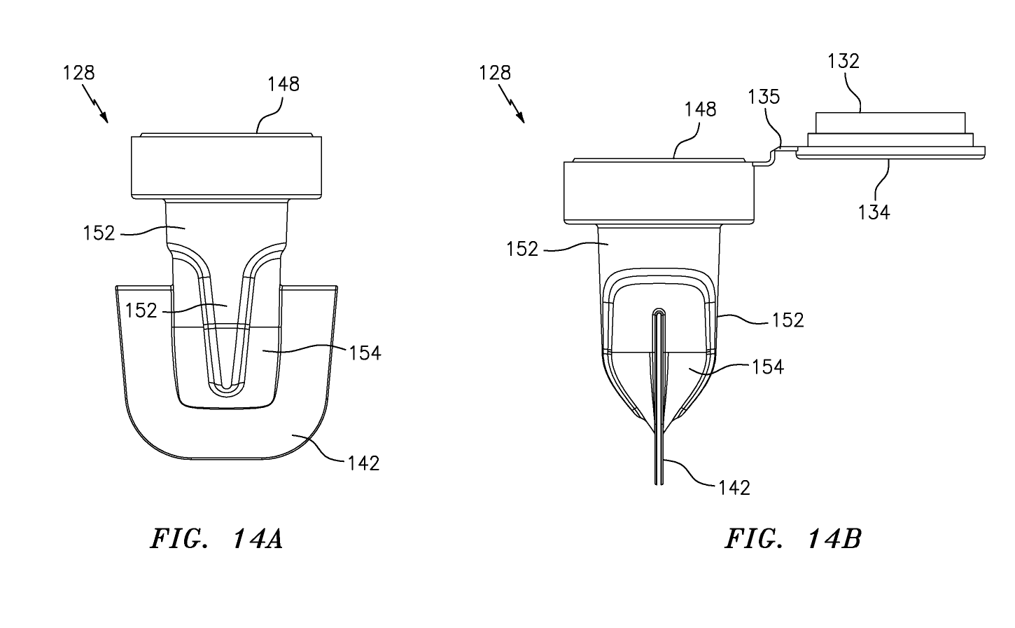

In FIGS. 10 through 14, another embodiment is illustrated. This embodiment is substantially similar to the embodiment described above, and therefore the same reference numerals are used to identify and describe the same elements, or the same reference numerals preceded by the numeral “1” are used to identify and describe like elements. As shown typically in FIG. 12, the primary difference of this embodiment is that the fitment 128 includes a hinge 135, such as the flexible or living hinge illustrated, that connects an integral septum support/mold ring 134 with the port 152 of the fitment 128. The septum 132 is over-molded to the hinged mold ring 134 of the fitment, and the over-molded septum is moved about the hinge to close the fitment and, in turn, form a sealed, empty pouch 16.

As shown typically in FIG. 13, the fitment and septum are both over-molded to the pouch in the same rotary cubic mold 130. Prior to insertion of the pouch 16 into the mold, a pouch aperture 38 is formed, such as by die-cutting, through the first end marginal edge portion 18 of the pouch. If formed by cutting or like means, the pouch aperture 38 is preferably cut or otherwise formed adjacent to the mold, and/or immediately prior thereto, with the pouch in a flattened condition, and under an over-pressure of micro-filtered air and/or other gas, in order to maintain the sterile, particle free condition of the interior surfaces of the pouch. However, as may be recognized by those of ordinary skill in the pertinent art based on the teachings herein, the sealed pouch 16 may be inserted into the mold, and the pouch aperture 38 formed after insertion of the pouch into the mold. In one embodiment, the first and second sides of the mold include dies or jaws (not shown) that cut the pouch when the opposing sides of the mold are closed onto the pouch. Then, the mold is opened to eject the cut portion of the pouch, and the mold is reclosed over the pouch to over-mold the fitment along the periphery of the pouch aperture. As described further below, the pouch aperture may be formed by a gap between opposing edge portions in a marginal edge of the pouch, and/or may be formed in any of numerous different ways, in any of numerous different locations, that are currently known, or that later become known.

After inserting the pouch into the mold 130, the mold is rotated about 90° to present the pouch to the first molding station 140 where the fitment 128 and integral septum support/mold ring 134 are over-molded thereto with the base 142 sealed along the periphery of the pouch aperture 38. The base 142 of the fitment is over-molded to the outer layer 14 of the pouch along the periphery of the pouch aperture 38 to thereby seal the pouch aperture with respect to the ambient atmosphere along its periphery. The over-molding of the fitment 128 at least partially melts the outer layer 14 of the tubular film and thermally bonds the fitment base 142 thereto, but does not melt the inner layer 12 of the tubular film, and thereby maintains separateness between the opposing inner surfaces of the inner layer 12 at the over-molded fitment and does not disturb the integrity of the sealed, empty, sterile, particle-free interior chamber 26 of the pouch.

The mold 130 is then rotated another about 90° to present the fitment 128 and integral molded ring 134 thereof to a second molding station 146 where the septum 132 is over-molded to the integral mold ring 134. Then, as indicated by the arrow in FIG. 13, the mold 130 is rotated another about 90° to a de-molding station, where a cam or other actuating device 155 automatically moves the hinged over-molded septum 132 into the port aperture 148 such that the septum at least partially closes the aperture. During each of the foregoing steps, an over-pressure of micro-filtered air and/or other gas is introduced into or through each of the stations, and particularly any locations where the molds are opened, to facilitate maintaining the sterile, particle-free (and pyrogen free) condition of the interior surfaces of the pouch, fitment and septum.

The sealed, empty pouch may be sterile or aseptically filled through the elastic septum 132 with a closed needle or like closed injection member. The fitment is penetrable by a needle or other injection member (not shown) for penetrating the septum and sterile or aseptically filling a substance into the interior chamber 26 of the pouch. The resulting penetration aperture in the septum is resealable by applying one or more of heat, radiation, liquid sealant, or mechanical closure thereto. The closed needle filling apparatus and process, and the septum, may take the form of any of the apparatus and methods disclosed in the following patents and patent applications, which are hereby incorporated by reference in their entireties as part of the present disclosure: U.S. patent application Ser. No. 14/214,890, filed Mar. 15, 2014, entitled “Controlled Non-Classified Filling Device and Method,” which claims the benefit of similarly titled U.S. Provisional Patent Application Ser. No. 61/798,210, filed Mar. 15, 2013; U.S. patent application Ser. No. 15/267,131, filed Sep. 15, 2016, entitled “Septum That Decontaminates by Interaction With Penetrating Element,” which claims the benefit of similarly titled U.S. Provisional Patent Application Ser. No. 62/219,035, Sep. 15, 2015; U.S. Design patent application Ser. No. 29/539,571, filed Sep. 15, 2015, entitled “Septum;” U.S. patent application Ser. No. 14/636,954, filed Mar. 3, 2015, entitled “Modular Filling Apparatus and Method,” which is a divisional of similarly titled U.S. patent application Ser. No. 13/861,502, filed Apr. 12, 2013, now U.S. Pat. No. 8,966,866, which, in turn, claims the benefit of similarly titled U.S. Provisional Patent Application Ser. No. 61/686,867, filed Apr. 13, 2012; U.S. patent application Ser. No. 13/450,306, filed Apr. 18, 2012, entitled “Needle With Closure and Method,” which claims the benefit of U.S. Provisional Patent Application Ser. No. 61/476,523, filed Apr. 18, 2011, entitled “Filling Needle and Method;” U.S. patent application Ser. No. 13/864,919, filed Apr. 17, 2013, entitled “Self Closing Connector,” which claims the benefit of similarly titled U.S. Provisional Patent Application Ser. No. 61/784,764, filed Mar. 14, 2013, and similarly titled U.S. Provisional Patent Application Ser. No. 61/635,258, filed Apr. 18, 2012, and similarly titled U.S. Provisional Patent Application Ser. No. 61/625,663, filed Apr. 17, 2012; U.S. patent application Ser. No. 13/917,562, filed Jun. 13, 2013, entitled “Device With Penetrable Septum, Filling Needle and Penetrable Closure, and Related Method,” which claims the benefit of similarly titled U.S. Provisional Patent Application Ser. No. 61/799,744, filed Mar. 15, 2013, and similarly titled U.S. Provisional Patent Application Ser. No. 61/659,382, filed Jun. 13, 2012; U.S. patent application Ser. No. 14/708,196, filed May 9, 2015, entitled “Self Closing and Opening Filling Needle, Needle Holder, Filler and Method,” which claims the benefit of similarly titled U.S. Provisional Patent Application Ser. No. 61/991,561, filed May 11, 2014, and similarly titled U.S. Provisional Patent Application Ser. No. 61/991,467, filed May 10, 2014; U.S. Provisional Patent Application Ser. No. 61/991,557, filed May 11, 2014, entitled “Self Closing and Opening Filling Needle, Needle Holder, Filler and Method;” U.S. Provisional Patent Application Ser. No. 61/991,474, filed May 10, 2014, entitled “Self Closing and Opening Filling Needle, Needle Holder, Filler and Method;” and U.S. patent application Ser. No. 15/238,011, filed Aug. 16, 2016, entitled “Device With Sliding Stopper and Related Method,” which is a divisional of similarly titled U.S. patent application Ser. No. 14/208,030, filed Mar. 13, 2014, now U.S. Pat. No. 9,415,885, which, in turn, claims the benefit of similarly titled U.S. Provisional Patent Application Ser. No. 61/799,423, filed Mar. 15, 2013.

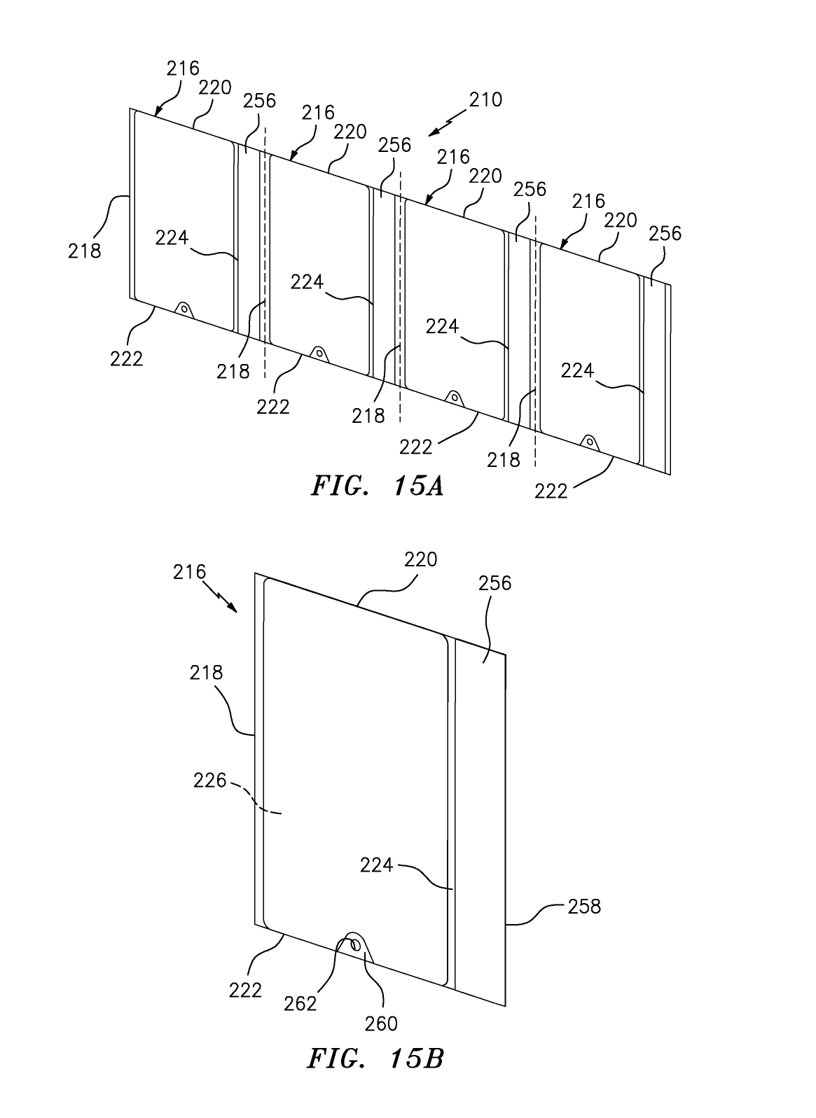

In FIGS. 15A through 21, another embodiment is illustrated. This embodiment is substantially similar to the embodiments described above, and therefore the same reference numerals preceded by the numeral “2”, or preceded by the numeral “2” instead of the numeral “1”, are used to identify and describe like elements. As shown typically in FIGS. 15A and 15B, the primary difference of this embodiment is that the tubular film 210 includes a plurality of additional seals 224 extending between the creased, marginal edge portions 220 and 222 of the film. As shown in FIG. 15A, each extra seal 224 is spaced adjacent to a respective seal 218 also extending between the creased, marginal edge portions 220 and 222 of the film, and the adjacent seals 218 and 224 define a label-receiving marginal edge portion 256 therebetween. As described above, the seals 218, 224 may be formed in any of numerous different ways that are currently known, or that later become known, such as by thermal sealing or ultrasonic sealing. The individual pouches 216 are cut from the film 210 by cutting the film, such as by die cutting, along each seal 218. As indicated by broken lines in FIG. 15A, each such cut is made along or adjacent to the edge of the seal facing the adjacent seal 224 to thereby define an open outer edge 258 (FIG. 15B) on the respective label-receiving portion 256 and a sealed edge 218 on the adjacently-formed pouch 216.

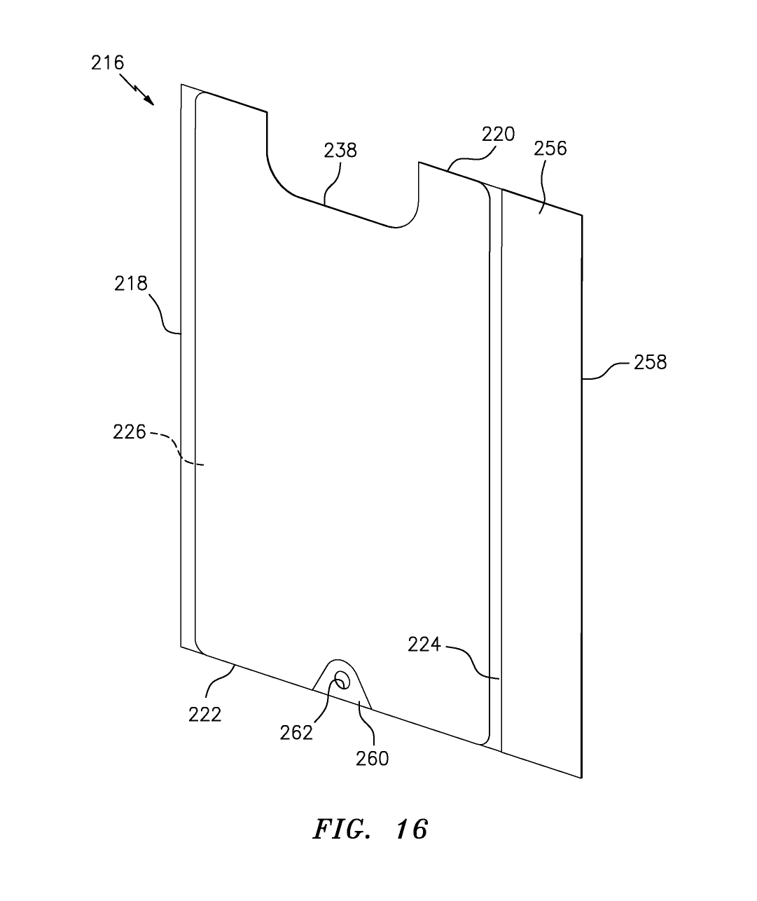

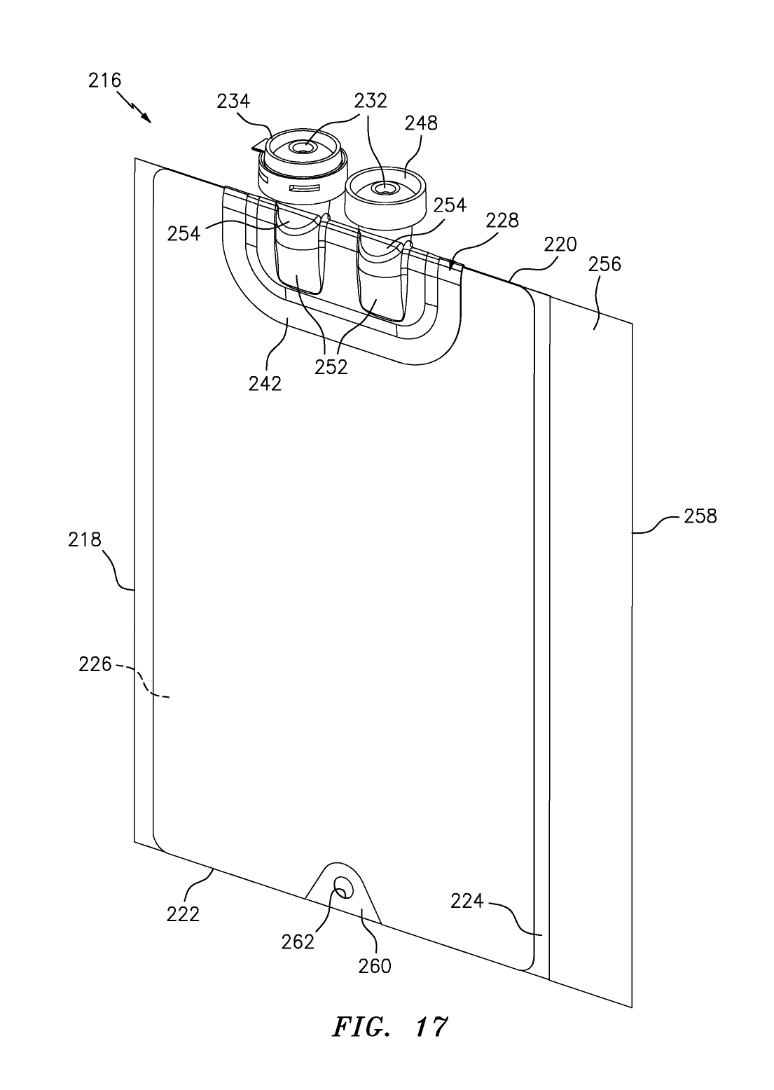

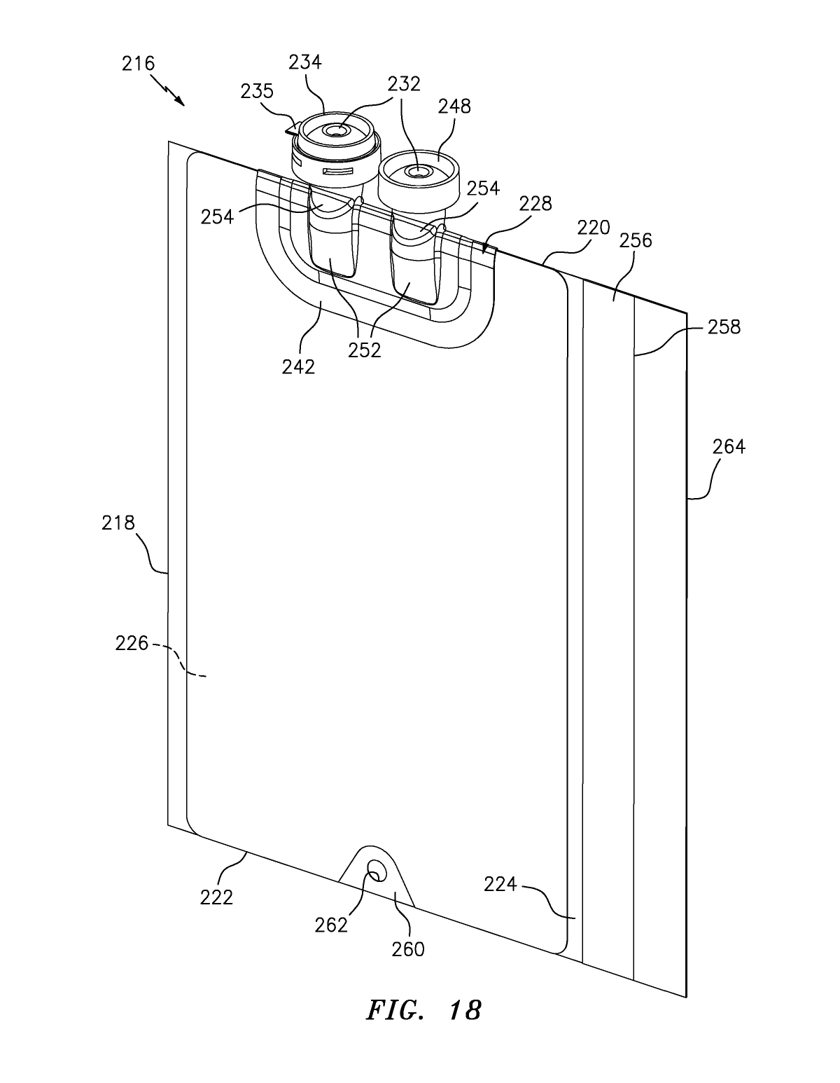

As also shown in FIGS. 15A and 15B, a grommet 260 is formed at the creased marginal edge portion 222 of each pouch 216 by sealing the opposing walls of the tubular film to each other in the desired shape of the grommet, and by cutting a grommet aperture 262 therein. As indicated in FIG. 15A, if desired, the seals defining the grommet 260 may be formed at the same time that the seals 218, 224 are formed in the tubular film 210. The grommet apertures 262 may be formed, such as by die-cutting, either before or after heat sealing the grommet. As shown in FIG. 16, the pouch aperture 238 is formed in the creased, marginal edge portion 220 opposite the grommeted edge. In one embodiment, the pouch aperture 238 is cut in the mold, such as by die-cutting, immediately prior to over-molding the fitment 242 thereto, as described above.

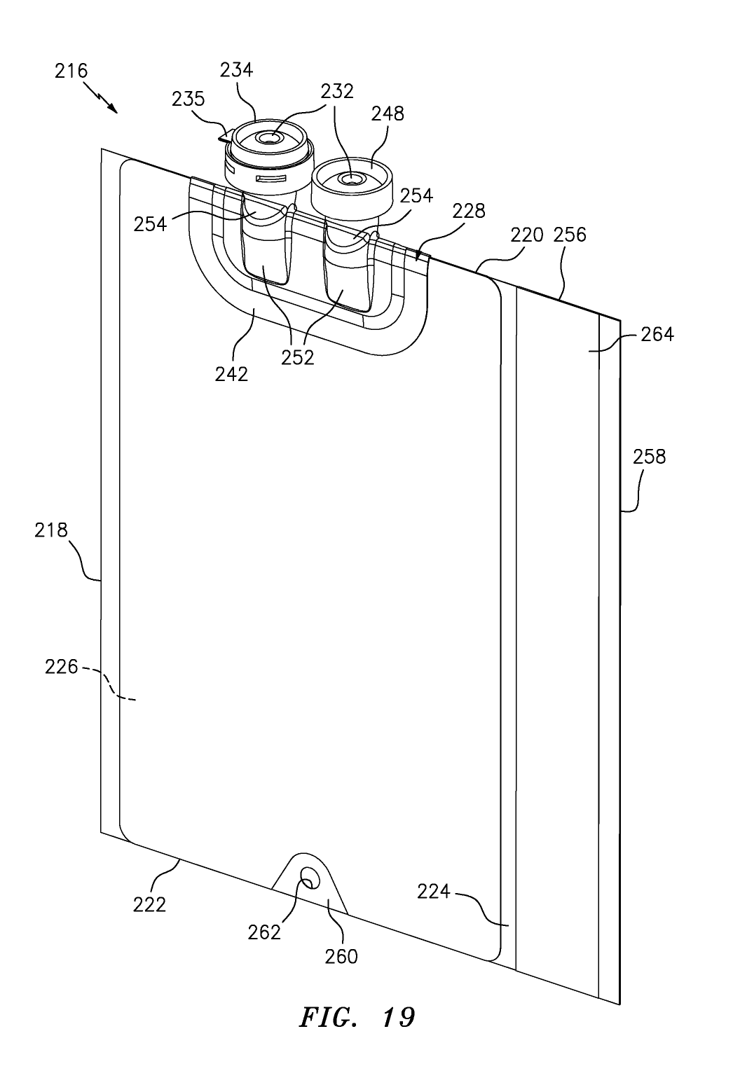

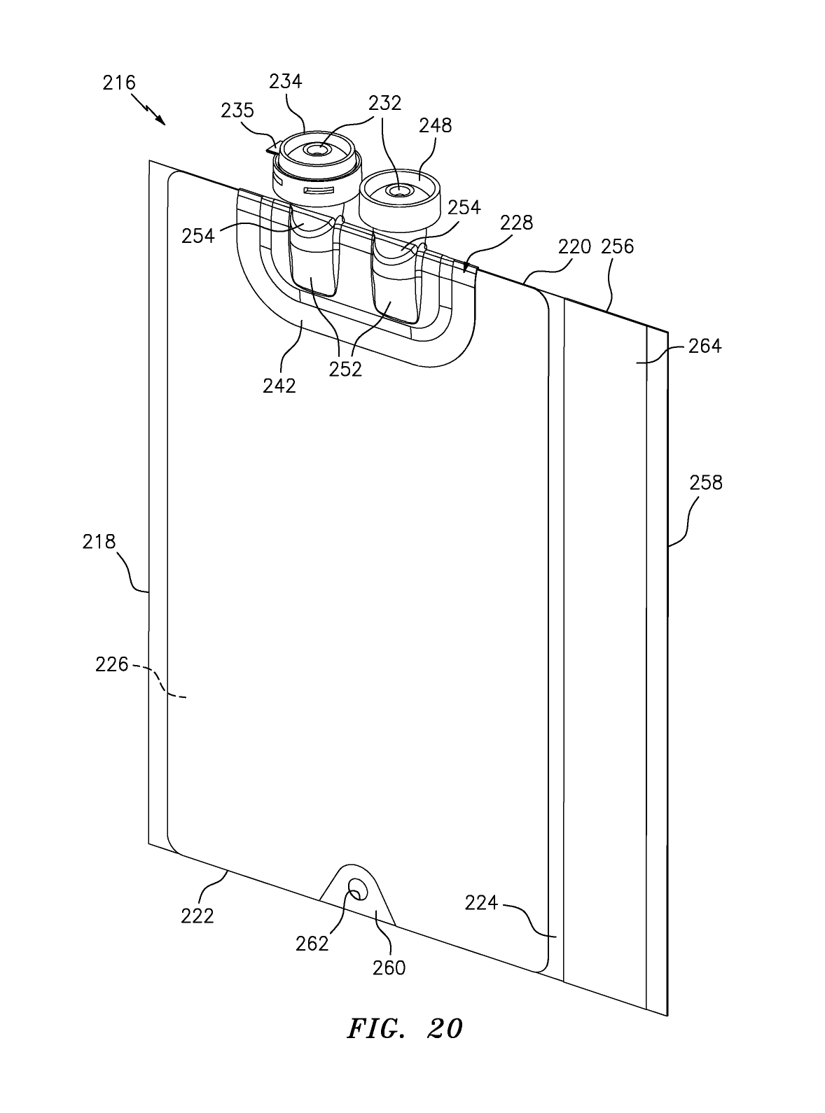

As shown in FIG. 17, the fitment 228, which in the illustrated embodiment has two ports 252, is over-molded to the pouch 216 about the pouch aperture 238, and the septa 232 are over-molded and/or assembled to the fitment, as described above. Other embodiments do not include a pouch aperture, and the fitment 242 is over-molded onto the fully-closed pouch. After over-molding, and as shown typically in FIG. 17, the sealed empty pouch 216 includes a label-receiving marginal edge portion 256 extending laterally from the sealed edge 224 of the pouch chamber and located on an opposite side of the pouch relative to the sealed marginal edge portion 218. As also indicated in FIG. 17, the label-receiving marginal edge portion 256 is closed on three sides by the seal 224 and the creased, marginal edge portions 220 and 222, but defines an open outer edge 258 for receiving a label or other device therein. As shown in FIG. 18, a label 264 is inserted through the outer edge 258 and into the label-receiving marginal edge portion 256. Then, as shown in FIGS. 19 and 20, the label-receiving marginal edge portion 256 is flattened, if necessary, in order to bring the opposing sides of the open outer edge 258 into contact with each other, and the opposing sides are sealed to each other, such as by heat or ultrasonic sealing, to thereby enclose and retain the label 264 within the label-receiving marginal edge portion 256. However, as should be appreciated by those of ordinary skill in the art, the outer edge 258 may be sealed by other suitable means, e.g., by adhesive. In some embodiments, fully or hermetically sealing the outer edge 258 may not be required, because maintaining a sterile condition of the label 264 is not necessary. In such embodiments, the outer edge 258 need only be sealed or otherwise secured/closed to sufficient extent to retain the label 264 within the label-receiving marginal edge portion 256.

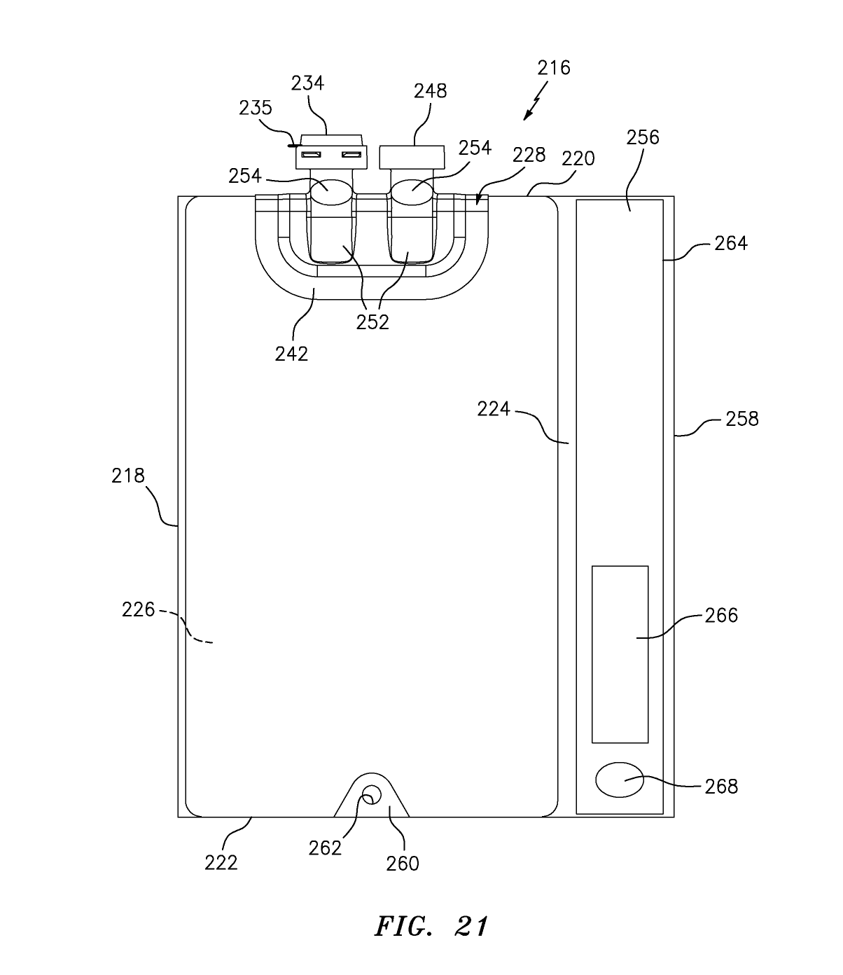

As shown in FIG. 21, the label 264 includes printed or otherwise mounted thereon an RFID tag 266 and a radiation dosimeter 268. The RFID tag 266 provides a unique identifier for the respective pouch 216 that is readable by a radio frequency or RFID transceiver (not shown). As a result, the respective pouch can be monitored or tracked at every stage, or at select stages of processing/manufacturing, in order to ensure compliance with quality controls and other manufacturing and/or regulatory procedures and/or guidelines, and if desired, the data of such monitoring/tracking can be recorded via the RFID or database system for future reference. Embodiments of monitoring/tracking systems and methods are described in the U.S. patent application entitled “Devices and Methods for Formulation Processing,” filed Jan. 19, 2017, which claims the benefit of U.S. Patent Application No. 62/280,696, filed Jan. 19, 2015, entitled “Formulation Processing,” which is incorporated by reference in its entirety as part of the present disclosure. The radiation dosimeter 268 measures the exposure of the dosimeter and thus of the pouch to radiation and undergoes a color change, such as from yellow to red, when the dosimeter is exposed to a sufficient level of radiation, such as gamma or ebeam radiation. Thus, if desired to subject the empty pouch to radiation sterilization as an added measure to ensure sterility, such as gamma or ebeam radiation, the dosimeter 268 will undergo a color change, and the color change will indicate that the pouch has been subjected to such a sufficient amount or dose of radiation to ensure that the pouch is sterile and will visibly indicate such exposure and confirmed sterility on the pouch. Thus, the dosimeter provides a visible back-up to the RFID tag, which can be used to track and confirm that the pouch has been sterilized, e.g., processed by or in sterilization equipment, if desired to so process the pouch.

In addition, or alternatively, the fitment 228 contains a color indicator that signifies the sterility of the septum 232 and/or the pouch 216 (or its interior chamber 226). The color indicator changes color upon heat or radiation exposure, e.g., gamma radiation exposure. Upon exposure to sufficient heat or radiation, the color indicator changes to a color signifying that the septum 232 and/or the pouch 216 is sterile. In some embodiments, the color indicator is blended into the material forming the septum 232. In yet other embodiments, the colored sterility indicator is located elsewhere on pouch 216 or its fitment 228.

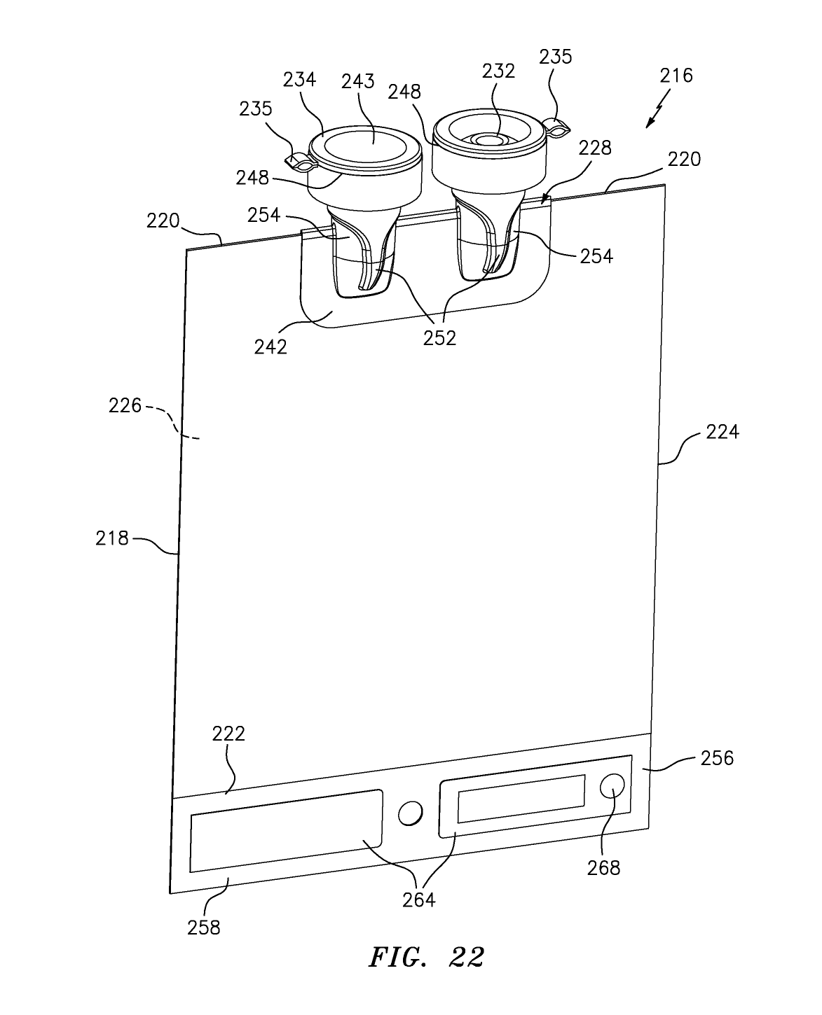

As may be recognized by those of ordinary skill in the pertinent art based on the teachings herein, the labels may include any of numerous different features that are currently known, or that later become known, including different features for identifying the pouch, such as a bar code, computer chip, or other optical or electronic means for identifying, monitoring and/or tracking the pouch. Alternatively, the label may include only an identifier, such as an RFID tag, or a dosimeter, but not both. In addition, the label-receiving marginal edge portion 264 need not include a label at all, but rather may receive an RFID tag, dosimeter and/or other device therein without a label, or may receive one or more such devices separate from a label. Accordingly, the label-receiving marginal edge portion may serve any of numerous different purposes, and/or may receive any of numerous different devices, that are currently known, or that later become known. Still further, the label-receiving marginal edge portion may be located on any marginal edge portion of the pouch, and need not extend along the entire respective edge portion. Such an embodiment is shown in FIG. 22 where the same reference numerals are used to identify the same or like elements as in the embodiment described in connection with FIGS. 15A through 21. As shown in FIG. 22, the label-receiving marginal edge portion 256 is located on a bottom edge of the pouch. As also shown, the sealed edge portion 218 defines the left edge of the pouch, the sealed edge portion 224 defines the right edge of the pouch, the sealed portion 222 defines the base of the interior chamber 226 and a fluid-tight barrier between the interior chamber and the label-receiving portion 256, and the sealed edge portion 258 defines the bottom edge of the pouch and the closure to the label-receiving portion 256. As shown in FIG. 22, the interior chamber 226 of the pouch is sterile or aseptic filled with a liquid substance.

The illustrated pouch 216 was needle filled through the left-hand port 252, and the penetrated septum 232 was re-sealed with a liquid sealant 243. In the illustrated embodiment, the liquid sealant 235 is a hot-melt adhesive sealant. As shown in FIG. 22, the hot-melt adhesive sealant 243 overlies the septum 232 and is adhesively bonded to the respective septum support 234 to thereby form a fluid-tight seal between the penetrated septum and the ambient atmosphere. The hot-melt sealant 243 adhesively bonds to the annular wall of the septum support 234 to form an annular, fluid-tight seal between the sealant and the support. Prior to dispensing the hot-melt sealant 243 onto the septum 232, the sealant is heated to a sufficiently high temperature to melt the sealant and have a bactericidal effect on surfaces contacted by the melted sealant. The liquid sealant is then dispensed with an applicator (not shown) of a type known to those of ordinary skill in the pertinent art onto the penetrated septum 232. As the liquid sealant 243 flows onto the penetrated septum 232, the temperature of the liquid sealant is sufficiently high to sterilize the contacted surfaces, and thus sterilize the interfaces between the sealant 243 and both the septum 232 and septum support 234. Accordingly, the interior of the seal 243 is sterile at the time of formation, and because the sterile interior is sealed with respect to ambient atmosphere, its sterility is maintained throughout the shelf-life and usage of the pouch. As a result, organism growth between the septum 232 and seal 243 may be prevented. The liquid sealant 243 cures at room temperature, and when cured, it forms a solid, rigid, substantially inflexible closure overlying the penetrated septum. One advantage of the rigid closure 243 is that it provides tamper resistance by preventing access to the underlying septum. Because the hot-melt sealant 243 is hard or rigid and thus substantially inflexible at room temperature, it is substantially impenetrable by a needle or like injection member. As a result, the closure 243 prevents re-penetration of the underlying septum 232, or prevents re-penetration of the underlying septum without destroying or otherwise damaging the hot-melt closure, and thus without providing visible evidence of tampering. Another advantage is that the substantially inflexible hot-melt closure 243 provides a sealed, moisture-vapor-transmission (MVT) barrier overlying the septum. Yet another advantage of the hot-melt sealant 243 is that it is self-curing. In other words, the liquid sealant cures when allowed to cool to a sufficiently low temperature, such as room temperature. The hot-melt sealant does not require exposure to radiation or another type of catalyst to transition from its liquid form, to its substantially inflexible, solid form. The hot-melt sealant 243 and septum support 234 are formed of materials that are bondable to each other, and the septum support 234 and septum 232 also are formed of materials that are bondable to each other. In the illustrated embodiment, the hot-melt sealant 243 is a polyolefin (or polyolefin blend), and the septum support 234 is a polypropylene (or polypropylene blend) in order to allow the sealant to firmly bond to the septum support and form a fluid-tight seal therebetween. Thus, in the illustrated embodiment, the hot-melt sealant 243 and septum support 234 are formed of materials with sufficiently common monomers to allow bonding therebetween, and the septum 232 and septum support 234 also are formed of materials with sufficiently common monomers to allow bonding therebetween. Also in the illustrated embodiment, the septum 232 is formed of a thermoplastic elastomer or a silicone that is bondable to the polypropylene septum support 234. One advantage of this embodiment is that the hot-melt sealant 243 need only be bondable to the septum support 234, and need not be bondable to the septum 232, in order to provide a sealed, tamper-resistant closure overlying the septum. Rather, the hot-melt closure 243 substantially conforms to the morphology of the septum 232 at the interface therebetween, but is not bonded thereto. As a result, the septum 232 may be made of any of numerous different materials without regard to whether such materials are bondable to the overlying closure 243. However, if desired, the hot-melt sealant, septum, and septum support may be made of materials that are all bondable to each other. One hot-melt adhesive sealant that may be used is sold by the Minnesota, Mining and Manufacturing Company (“3M”) as 3M Scotch-Weld Hot Melt Adhesive, product no. 3792. As may be recognized by those of ordinary skill in the pertinent art based on the teachings herein, the disclosed materials are only exemplary, and any of numerous other materials that are currently known, or that later become known, equally may be employed.

Another advantage of the hot-melt adhesive sealant 243 is that it allows for improved quality control. Upon or within a set time following application of the hot-melt sealant to the septum 232, a temperature sensor (not shown) senses the temperature of the hot-melt sealant and transmits same to a controller (not shown). The controller compares the sensed temperature to an acceptable range, or otherwise determines whether the applied sealant temperature is sufficiently high to have a bactericidal effect on the surfaces of the septum. In addition, the temperature sensor may measure the temperature profile across the surface of the septum, to assess whether the hot melt sealant fully covers the septum. For example, if a portion of the scanned temperature profile is below a lower temperature threshold, this may indicate a bare or thin spot in the overlying sealant, and thus the controller can flag the respective product for rejection or further inspection. Alternatively, a computer vision camera may be used to visually monitor the application of the hot-melt sealant, and flag any seals that do not meet or substantially conform to a required visual seal profile.

As shown in FIG. 22, the septum 232 of the right-hand port 252 is exposed in the illustrated condition of the pouch to allow connection thereto of a sterile connector, such as one of the sterile connectors incorporated by reference below, in order to withdraw substance from the pouch therethrough. The right-hand septum 232 may be covered with a tamper-resistant closure (not shown), such as an adhesive-backed foil or other covering, that requires removal of the closure in order to access the septum. In other embodiments, one or more of the ports 252 may be a valve for filling substance into and/or withdrawing substance from the pouch 216. Examples of valves that may be utilized are disclosed in U.S. patent application Ser. No. 14/990,778, filed Jan. 7, 2016, entitled “Pouch with Sealed Fitment and Method,” which claims the benefit of similarly titled U.S. Provisional Patent Application Ser. No. 62/100,725, filed Jan. 7, 2015, which are hereby incorporated by reference in their entireties as part of the present disclosure.

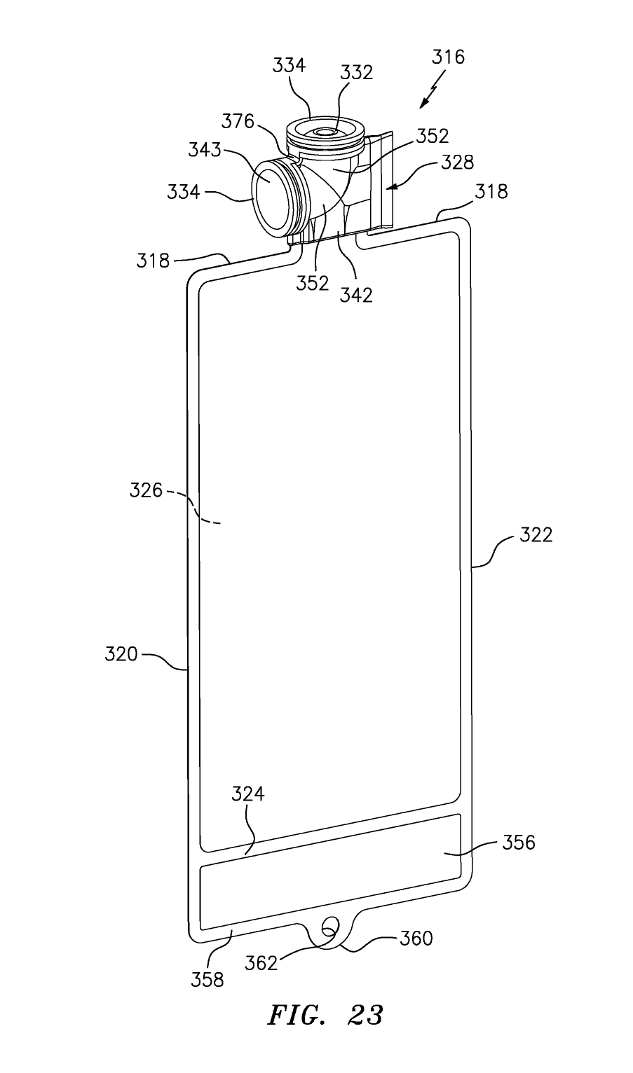

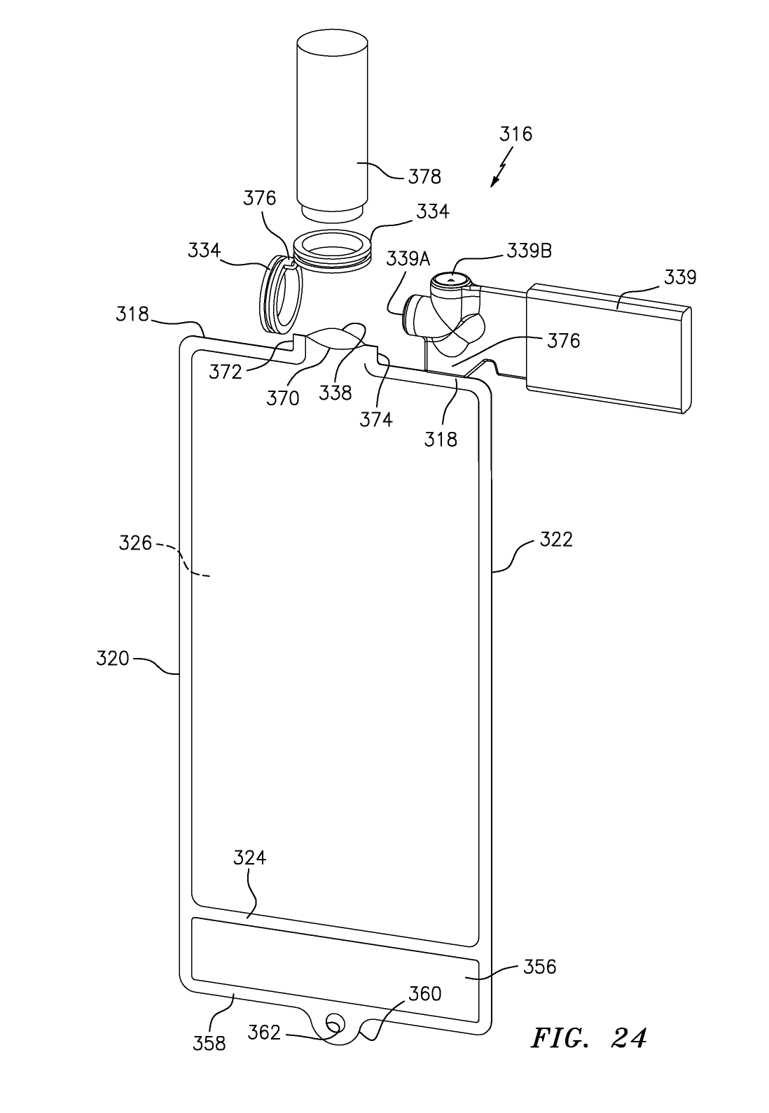

In FIGS. 23 through 29, another embodiment of a pouch is indicated generally by the reference numeral 316. The pouch 316 is substantially similar to the pouches described above, and therefore like reference numerals preceded by the numeral “3,” or preceded by the numeral “3” instead of the numerals “1” or “2,” are used to identify and describe the same or like elements. A primary difference of the pouch 316 is that the fitment 328 and its septa 332 are formed of a flexible or elastic material, and are over-molded at the same or substantially the same time to the pouch 316. In the illustrated embodiment, the septa 332 and fitment 328 are made of the same material, such as a thermoplastic elastomer. However, as may be recognized by those of ordinary skill in the pertinent art based on the teachings herein, the septa 332 may be made of different materials or combinations of materials than each other and/or of the remainder of the fitment 328. As shown in FIG. 24, the pouch 316 defines a tab 370 extending laterally therefrom, and the tab defines a gap in the sealed edge portion forming the pouch aperture 338. Thus, the pouch aperture 338 is defined between the unsealed, opposing edge portions of the tubular film at the gap in the seal. With reference to FIG. 24, the left side 372 of the tab is sealed; however, the right side 374 of the tab is not sealed, but rather defines a continuation of the pouch aperture 338 along the right side of the tab. Otherwise, the sealed edge portion 318 extends from the left side 320 of the pouch and, in turn, along the left side 372 of the tab 370, and extends from the base of the right side 374 of tab to the right side 322 of the pouch. The pouch aperture 338, on the other hand, extends between the distal end of the left side 372 of the tab 370 to the base of the right side 374 of the tab. As shown typically in FIG. 23, the fitment 328 includes two septa 332 (one shown) oriented at approximately 90° relative to each other. The respective septum supports/mold rings 334 are interconnected by a bridge 376. As can be seen, the left-hand (or horizontal) septum is sealed by a rigid, substantially inflexible hot-melt sealant closure 343.

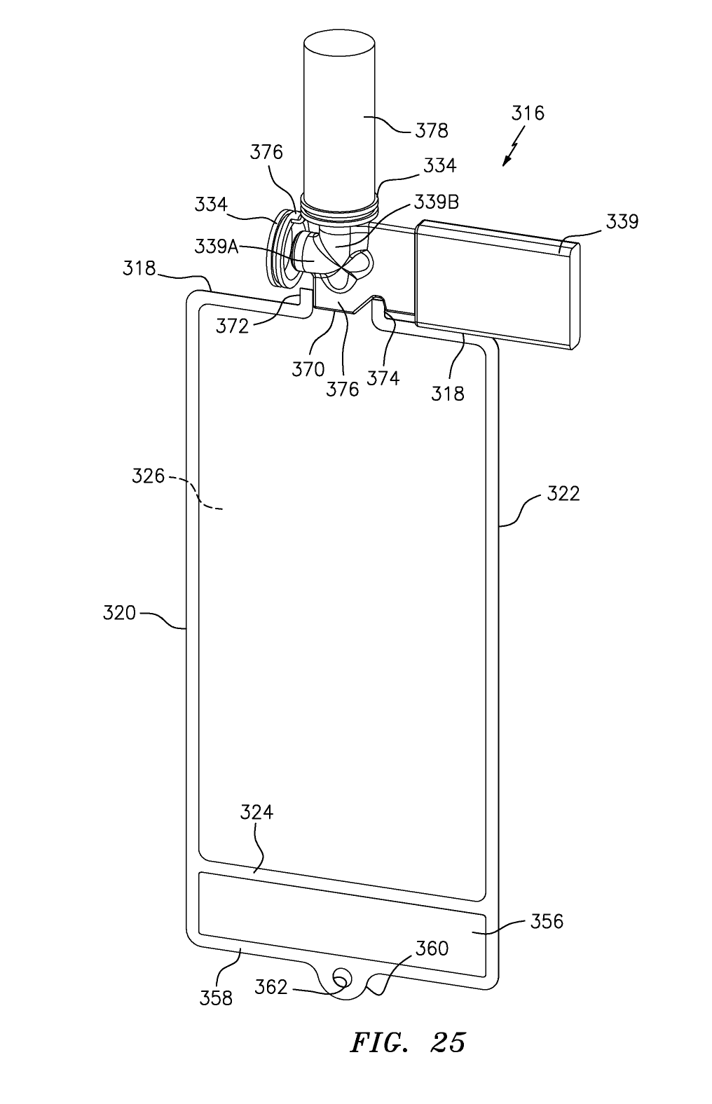

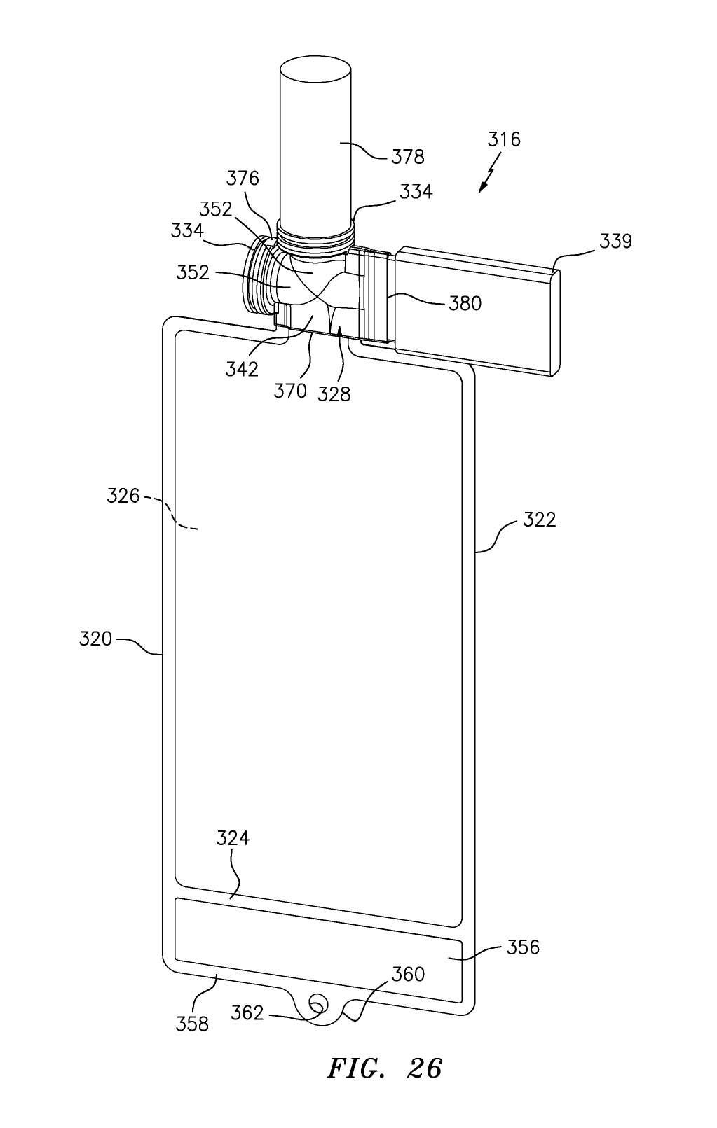

As shown in FIG. 24, in order to over-molded the fitment 328 to the pouch, the tab 370 of the pouch is inserted into a mold cavity (not shown) and the integral septum supports 334, 334 are located in the same mold cavity and spaced relative to the tab as shown. A first core pin 339 defines a first septum core pin 339A, a second septum core pin 339B, and a tab-penetrating base 376. As shown in FIG. 25, as the first core pin 339 is moved into the mold cavity, the tab-penetrating base 376 is moved initially through the pouch aperture 338 in the right side 374 of the tab, and is then moved into the remainder of the pouch aperture such that the tab-penetrating base is located between, and separates the opposing, unsealed edge portions of the pouch located within the mold cavity and defining the pouch aperture. The tab-penetrating base 376 defines a thin, elongated construction with radiused edges to facilitate insertion between the opposing, unsealed edge portions, as shown in FIG. 25. In order to facilitate separation of the opposing, unsealed edges of the pouch to allow insertion of the tab-penetrating base 376 therebetween, the tab-penetrating base may include fluid-flow apertures (not shown) to allow micro-filtered air or another sterile gas to be directed therethrough and against the opposing edge portions of the pouch to push the edge portions away from each other, and/or the mold (not shown) may define vacuum surface(s) adjacent to the respective edge portions of the tab to pull the opposing edge portions away from each other. Alternatively, or in addition to the use of vacuum or fluid pressure, a mechanism may be employed to bend the opposing upper corners of the tab away from each other to facilitate the insertion of the tab-penetrating base of the core pin therebetween. Another core pin 378 is moved into the external side of one septum support 334, and another core pin (not shown) is moved into the external side of the other septum support 334 in the same manner as shown. Then, as shown in FIG. 26, the flexible or elastic fitment material is injected into the mold cavity (not shown) to form the fitment 328 and its septa 332.

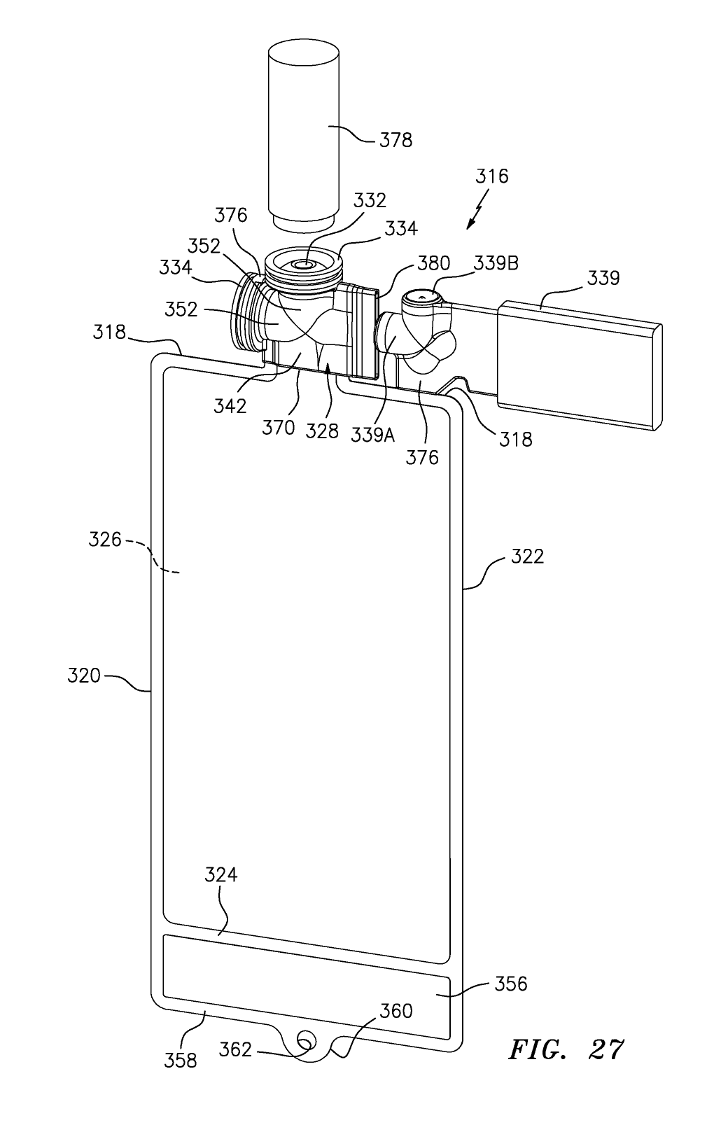

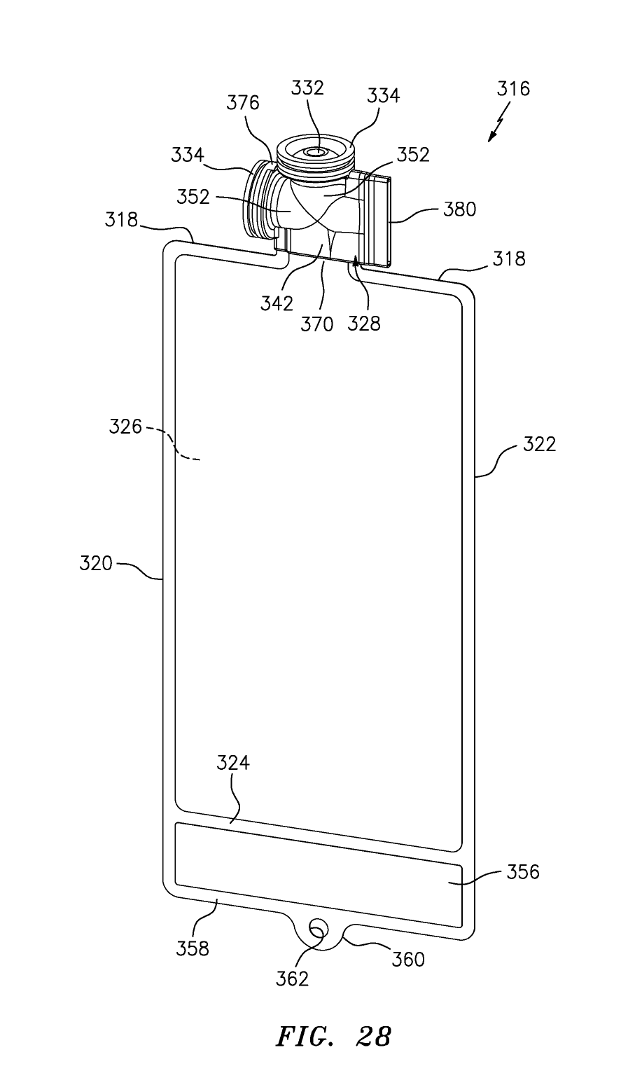

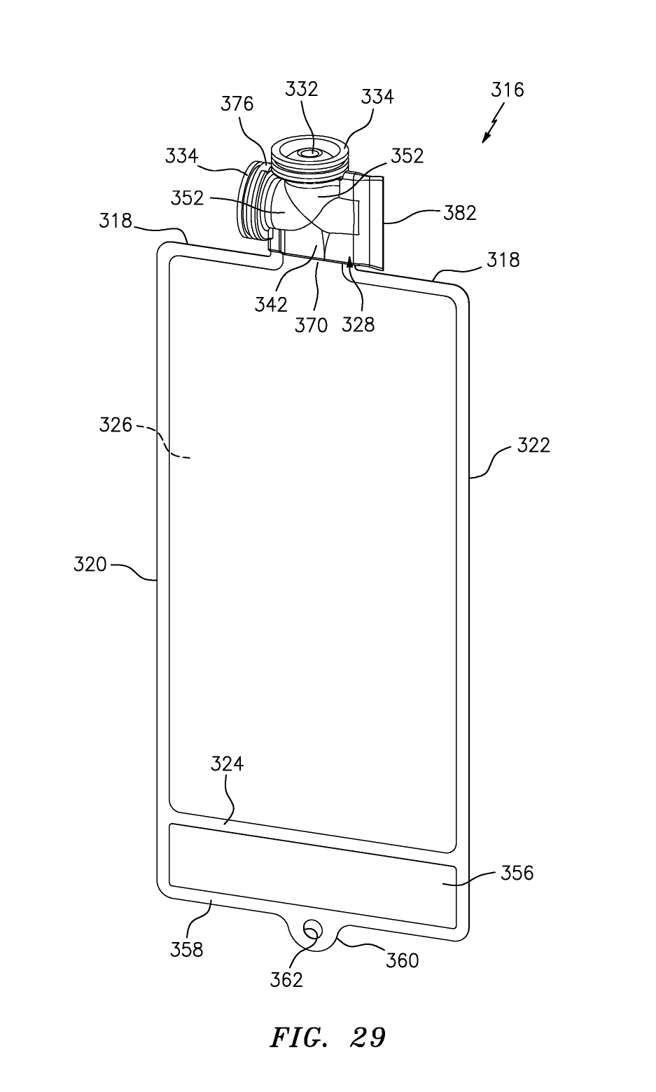

As can be seen, the base 342 of the fitment is thermally bonded to the tab 370 of the pouch and forms a fluid-tight seal therebetween, and the septa 332 are formed within the respective septum supports 334 and thermally bonded thereto. Because of its formation about the core pin 339, the elastic fitment 328 defines an elongated aperture 380 in the right side thereof in FIG. 26 through which the core pin 339 extends during molding of the fitment. As shown in FIG. 27, because the fitment 328 is formed of a flexible or elastic material, the material expands about the aperture 380 to allow removal of the core pin 339 therethrough. As shown in FIG. 28, upon removal of the core pin 339, the flexible or elastic material of the fitment 328 returns to its original shape and, in turn, closes or substantially closes the aperture 380 due to the flexibility or elasticity of the fitment material and its shape. Then, as shown in FIG. 29, the aperture 380 is sealed along its full extent to form a sealed edge 382 and thereby fixedly close the aperture and secure a fluid-tight seal between the fitment and pouch. The aperture 380 may be sealed in any of numerous different ways that are currently known, or that later become known, such as by heat sealing, including impulse heat sealing, induction heat sealing or ultrasonic welding, adhesive or chemical bonding, and/or mechanical closure. When the pouch 316 is filled through one of the septa 332, the opposing sides of the fitment flex outwardly relative to each other to expand the pouch as the fluid flows through the penetrated septum, through the pouch aperture, and into the interior, sealed chamber 326 of the pouch.

One advantage of the pouch 316 is that the core pin (or the tab-penetrating portion thereof) is inserted into the pouch aperture during molding, and thus is interposed between the opposing sides of the tubular film, during over-molding the fitment thereto. As a result, the core pin provides a thermal barrier between the opposing sides of the film that thermally insulates one side from the other and otherwise prevents the opposing sides of the film from bonding to each other during over-molding. Accordingly, this configuration obviates the need to use a multiple layer tubular film where the inner layer of the film defines a higher melting temperature than the outer layer of the film, as described above. In addition, during over-molding the cure pin is heated to a bactericidal temperature, thus killing any bugs, germs or other contaminants that might come into contact with it during over-molding and providing an over-molded fitment with a sterile interior. Another advantage of the pouch 316 is that the fitment 328, and in particular the base 342 thereof, is formed of a flexible or elastic material, which allows the fitment to flex outwardly and provide an unobstructed passageway for filling the pouch therethrough. In some embodiments of the invention, a closed needle is used to penetrate a septum of the fitment, and the closed needle is not opened until it passes through the septum and is in fluid communication with the interior of the pouch. Then, the flow of fluid from the closed needle into the pouch can operate to delaminate the opposing sides of the pouch film as the fluid is introduced therein. Another advantage of the pouch 316 is that the fitment 328 can be made of a thermoplastic elastomer having a relatively low melting temperature which, in turn, allows the resulting slot in the fitment after withdrawal of the core pin therefrom to be easily sealed, such as by applying a thermal pinch seal right off the mold upon de-molding the pouch. Another advantage is that, if desired, the pouch can be made of essentially two materials, a thermoplastic elastomer for the fitment, including the septa, and polypropylene(s) for the septum supports and pouch. Such materials are recyclable, and thus facilitate recycling the pouches after disposal.

The rigid rings or septum supports 334, 334 effectively rigidify the otherwise flexible fitment and provide rigid surfaces adjacent to each septum to allow gripping by a user, such as a nurse or other practitioner, for purposes of, for example, inserting a syringe needle through the septum, and/or for mounting or otherwise engaging the fitment in a sterile or aseptic filling machine. The septum supports 334, 334 can be molded and then inserted into the fitment mold for over-molding the fitment to the septum supports and to the pouch, or the septum supports can be molded in a first molding station of mold, and the fitment can be over-molded to the septum supports and pouch in a second molding station, such as in the first and second stations of a rotary mold, such as a rotary cubic mold, as described above. In another embodiment, the septum supports are molded in a first molding station, the septa are over-molded to the septum supports in a second molding station, and the fitment is over-molded to the septum supports and pouch in a third molding station, such as in the molding stations of a rotary mold, such as a rotary cubic mold, as described above. If desired, the over-molded fitment can be formed of a different material than the septa, and can be over-molded to the septa and/or to the septum supports. One advantage of molding the septum supports in the same mold as used for over-molding the fitment is that it eliminates the need to move the septum supports from one mold to another and otherwise eliminates the need to handle the septum supports prior to over-molding the fitment. However, if desired, the septum supports can be molded in a first mold, and moved, such as automatically by a pick and place robot or like device, from a first mold to a second mold where the fitment is over-molded to the septum supports and pouch. In some such embodiments, the mold may define multiple cavities in a single or respective injection press, where each fitment is over-molded to a pouch and septum support in a respective cavity, and the cavities are interconnected by runners. In each case, the over-molding of the fitment ensures that the interior surfaces of the fitment and the interfaces of the fitment and pouch are heated to a sufficiently high temperature by virtue of the heated core pin(s), mold and molten plastic injected into the mold, to maintain the sterility of the sealed, empty pouch, including its fitment.

Another advantage of the pouch 316 is that the septa are oriented at approximately 90° relative to each other. As can be seen, one septum 332 is approximately aligned with the elongated axis of the pouch and thus is substantially vertically oriented when the pouch is hung from its grommet 360. The other septum 332 is aligned with an axis approximately perpendicular to the elongated axis of the pouch and thus is substantially horizontally oriented when the pouch is hung from its grommet 360. If desired, one septum may be used for filling and the other septum for dispensing or otherwise withdrawing a fluid or other substance from the sealed chamber 326. In one embodiment, the horizontally oriented septum is used for filling and the vertically oriented septum is used for dispensing/withdrawing (although such roles/functions may be reversed). One advantage of such configuration is that a syringe needle or sterile connector, such as for sampling, may be inserted through the vertically oriented septum. This, in turn, allows the needle/connector tip to be located within the port aperture within the respective port 352 to thereby minimize any ullage or residue within the pouch upon emptying the pouch.

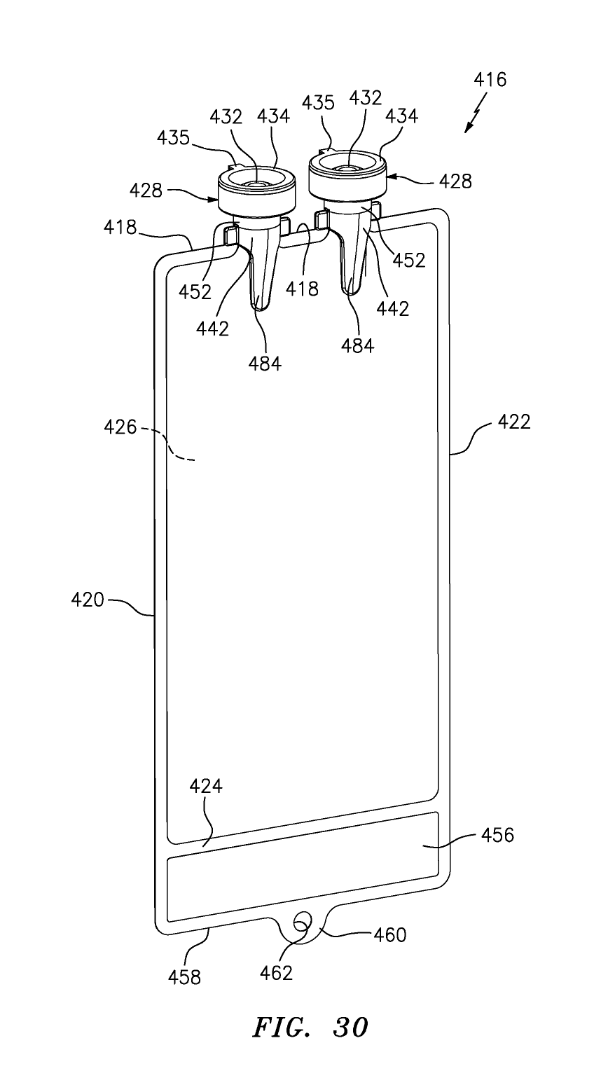

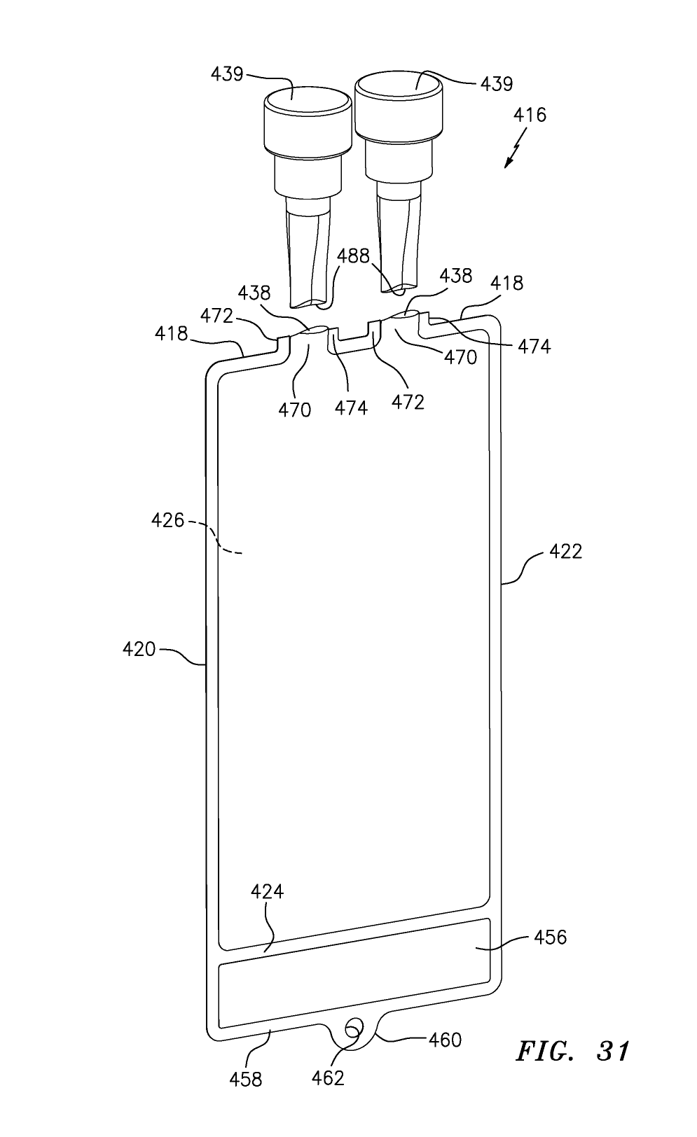

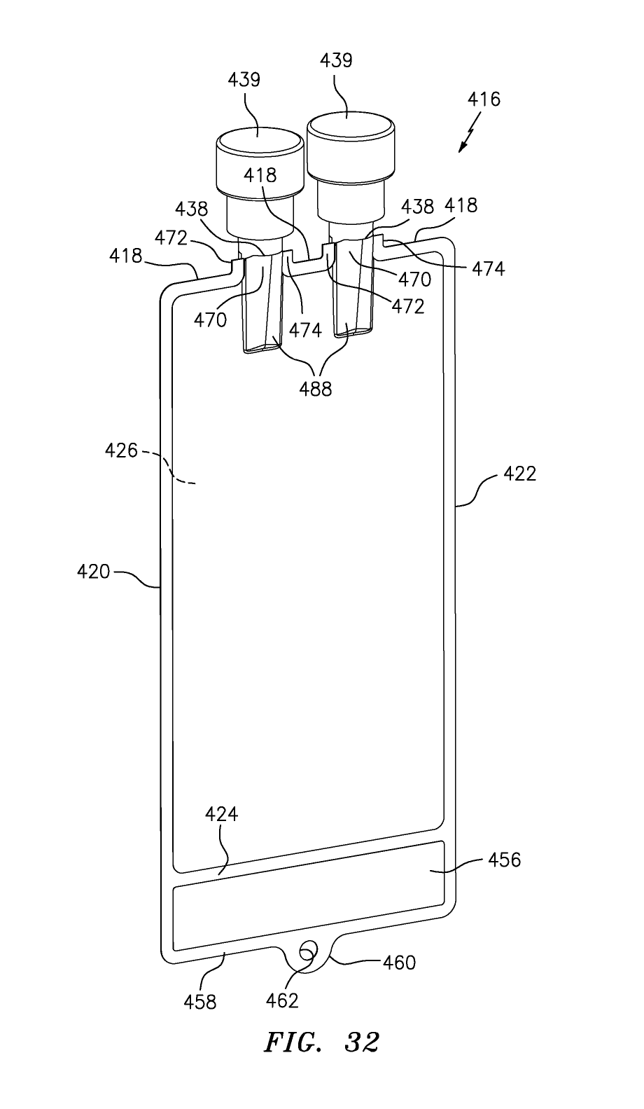

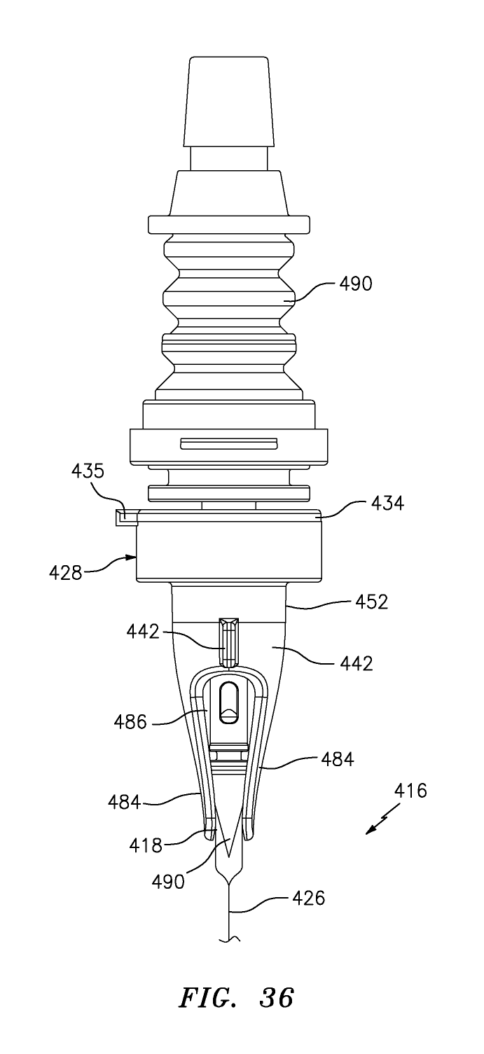

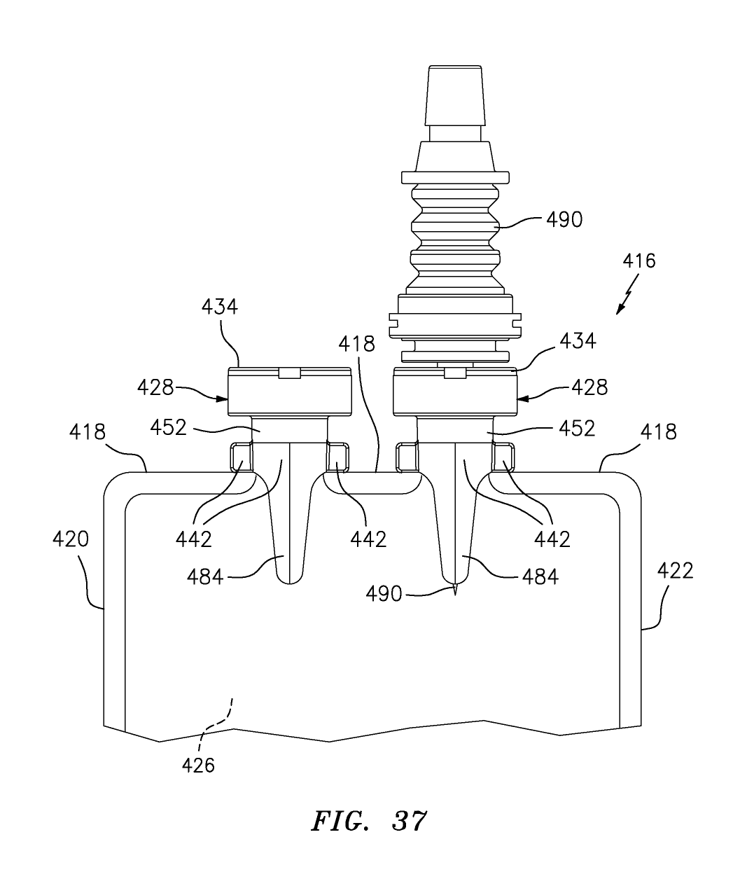

In FIGS. 30 through 37, another embodiment of a pouch is indicated generally by the reference numeral 416. The pouch 416 is substantially similar to the pouches described above, and therefore like reference numerals preceded by the numeral “4,” or preceded by the numeral “4” instead of the numerals “1,” “2” or “3,” are used to identify and describe the same or like elements. A primary difference of the pouch 416 is that it includes two laterally spaced fitments 428 over-molded to the marginal edge portion 418 of the pouch about respective pouch apertures 438 and forming fluid-tight seals therebetween. As shown in FIG. 31, the pouch 416 defines a pair of laterally projecting tabs 470 spaced relative to each other. Each tab 470 defines a respective pouch aperture 438 in its distal edge between opposing, unsealed portions of the film at the marginal edge portion 418. Each tab defines a sealed left edge 472 and a sealed right edge 474, and the respective pouch aperture 438 extends therebetween. The remainder of the edge 418 is sealed and extends from one side 420 to the other side 422 of the pouch, including between the spaced tabs 470. As shown typically in FIG. 37, the base 442 of each fitment 428 extends over and about the left and right sides 472 and 474, respectively, of the tab 470 to thereby form a fluid-tight seal between the fitment and tab and about the pouch aperture 438. The base 442 further defines a pair of axially-elongated ribs or tongues 484, 484 that are spaced relative to each other on opposite sides of the pouch and thermally bonded thereto. Each tongue 484 depends inwardly along the respective side of the marginal edge portion 418, and in the illustrated embodiment, defines a progressively decreasing width toward the distal end of the tongue. As shown in FIG. 36, the tongues 484 define therebetween a port aperture 486 for receiving a filling needle 490 to facilitate insertion of the filling needle through the respective septum 432 and into fluid communication with the interior chamber 426 of the pouch. As can be seen, the width of the space between the tongues 484, 484, and thus of the port aperture 486, progressively decreases toward the distal ends of the tongues, i.e., toward the interior of the pouch. The tongues 484 are movable laterally relative to each other and are permitted to flex outwardly with the respective sides of the pouch 416, such as during needle filling. As shown typically in FIG. 36, in the illustrated embodiment, the tongues 484 extend along the marginal edge portion 418 of the pouch a distance approximately equal to the depth of penetration of the filling needle or other filling member.

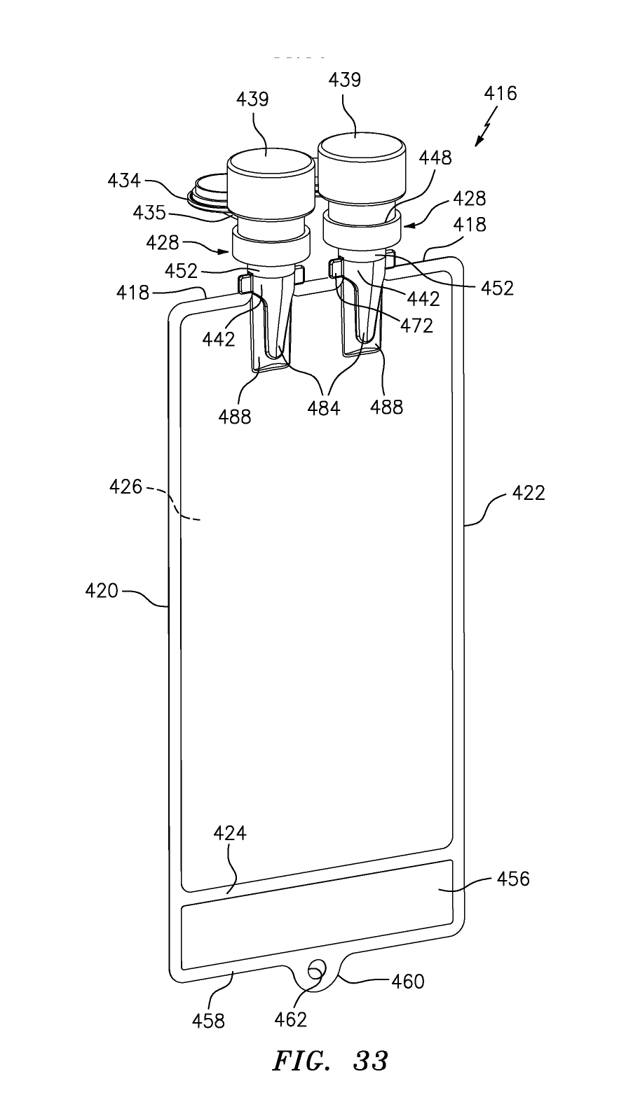

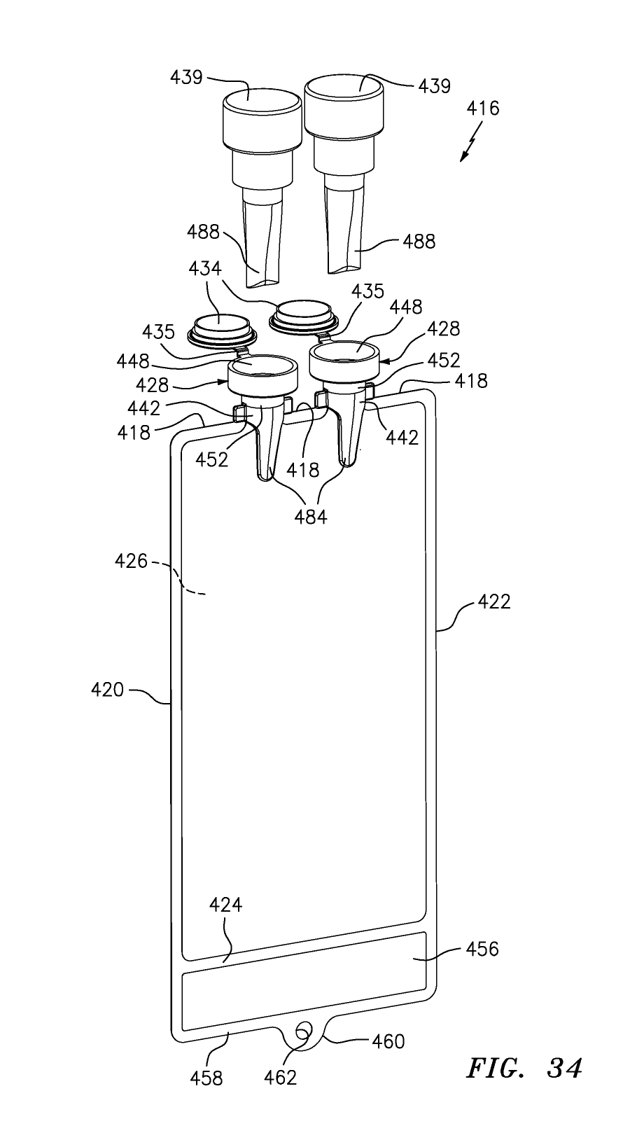

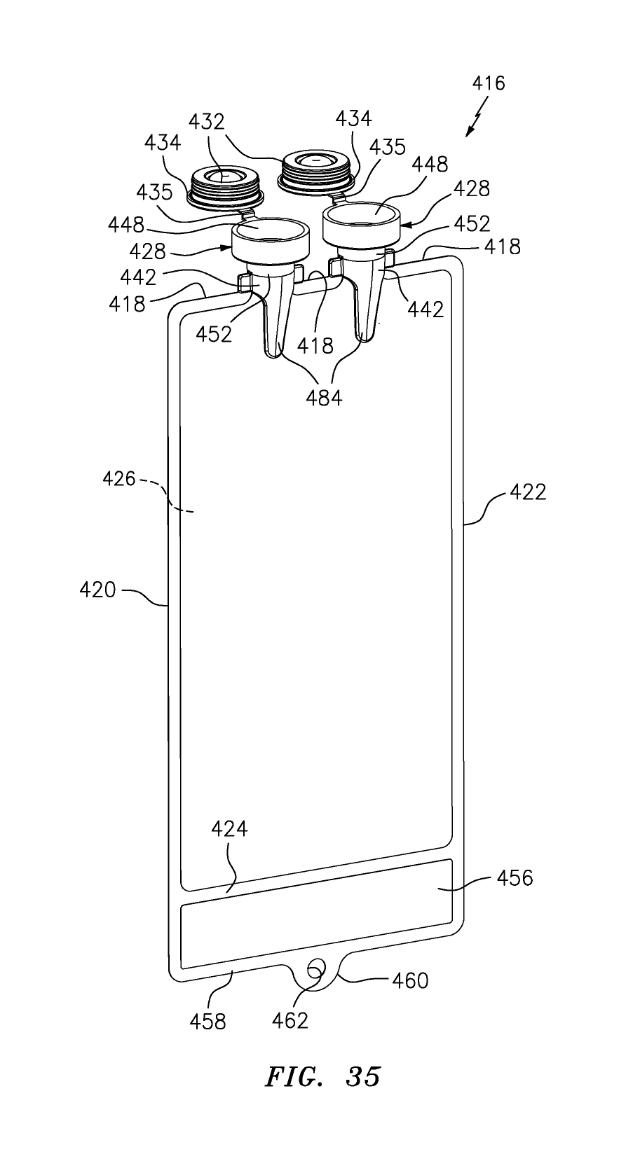

As shown in FIGS. 31 through 34, the fitments 428 are over-molded to the pouch by inserting the tabs 470 into a mold cavity (not shown) and inserting the distal end 488 of a respective core pin 439 through each mold aperture 438. As can be seen, each core pin 439 defines a tapered form that progressively decreases in width toward the distal end 488 of the core pin. Each core pin 439 defines a shape corresponding to, and forming the port 452, port aperture 448, base 442, and depending tongues 484 of a respective fitment 428. In order to facilitate separation of the opposing, unsealed edges of the pouch tabs to allow insertion of the core pins 439 therebetween, the distal end 488 of each core pin may include fluid-flow apertures (not shown) to allow micro-filtered air or another sterile gas to be directed therethrough and against the opposing edge portions of the respective tab to push the edge portions away from each other, and/or the mold (not shown) may define vacuum surface(s) adjacent to the edge portions of the respective tab to pull the opposing edge portions away from each other. Another pair of core pins (not shown) is also inserted into the mold cavity to form the septum supports 434 and bridges 435 extending between the septum supports and port in a manner known to those of ordinary skill in the pertinent art based on the teachings herein. As shown in FIG. 33, the fitment material is injected into the mold about the core pins to form each port 452, port aperture 448, base 442, and depending tongues 484, and to simultaneously form the integral bridges 435 and septum supports 434. The base 442 and tongues 484 of each fitment 428 are thermally bonded to the respective tab 470 and marginal edge portion 418 to fixedly secure the fitments to the pouch and form fluid-tight seals therebetween. Then, as shown in FIG. 34, the core pins 439 are removed from the mold, and as shown in FIG. 35, the septa 432 are over-molded to the septum supports 434. The septa 432 may be over-molded in the same molding station, or in a different molding station, such as in a rotary cubic mold, as described above. The septa 432 are molded to the hinged septum supports 434 in order to allow the core pins (not shown) for molding the septum to be introduced into the mold to the side of, and without interfering with the other portions of the fitment. Then, as indicated in FIG. 30, the pouch 416 is presented to a de-molding station (not shown), such as in a rotary cubic mold, where a cam or other actuating device (not shown) may automatically move each hinged over-molded septum 432 into the respective port aperture 448 such that the septum at least partially closes to seal the aperture. During each of the foregoing steps, an over-pressure of micro-filtered air and/or other gas is introduced into or through each of the stations, and particularly any locations where the molds are opened, to facilitate maintaining the sterile, particle-free (and pyrogen free) condition of the interior surfaces of the pouch, fitments and septa. Each septum support 434 may be fixedly secured to the respective port 452 within the port aperture 448 in any of numerous different ways that are currently known, or that later become known, such as by a snap-fit connection, by a pressed friction fit within the port aperture, or by bonding the septum support to the port, such as by the use of an adhesive, or by welding or other thermal bonding, such as by ultrasonic welding.

As shown typically in FIG. 36, the sealed, empty pouch 416 may be sterile or aseptically filled through an elastic septum 432 with a closed needle 490 or like closed injection member. The closed needle filling apparatus 490, process, and septa, may take the form of any of the apparatus and methods that are currently known, or that later become known, including any of the apparatus, methods and septa disclosed in the patents and patent applications incorporated by reference herein. The septum 432 of each fitment 428 is penetrable by the needle or other injection member 490 to sterile or aseptically fill a substance into the interior chamber 426 of the pouch. The resulting penetration aperture in the septum (not shown) is resealable by applying one or more of heat, radiation, liquid sealant, or mechanical closure thereto.

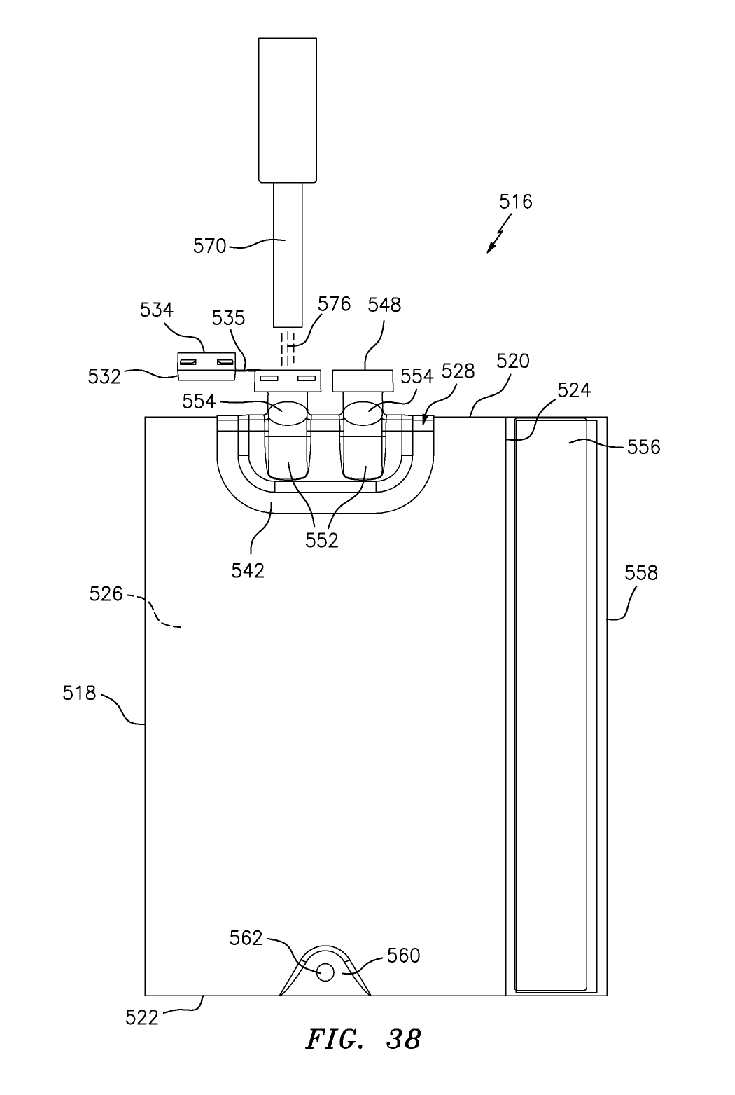

In FIGS. 38 through 40, another embodiment of a pouch is indicated generally by the reference numeral 516. The pouch 516 is substantially similar to the pouches described above, and therefore like reference numerals preceded by the numeral “5,” or preceded by the numeral “5” instead of the numerals “1,” “2,” “3” or “4,” are used to identify and describe the same or like elements. As shown in FIGS. 38 through 40, the fitment 528 includes a hinge 535, such as the flexible or living hinge illustrated, that connects the support/mold ring 534 with the port 552 of the fitment 528. The septum 532 is attached to the hinged mold ring 534 of the fitment 528, and, as illustrated in FIGS. 38 through 40, the mold ring 534 with the septum 532 can be moved about the hinge 535 to close the port 552 and the fitment 528, and, in turn, form a sealed pouch 516.

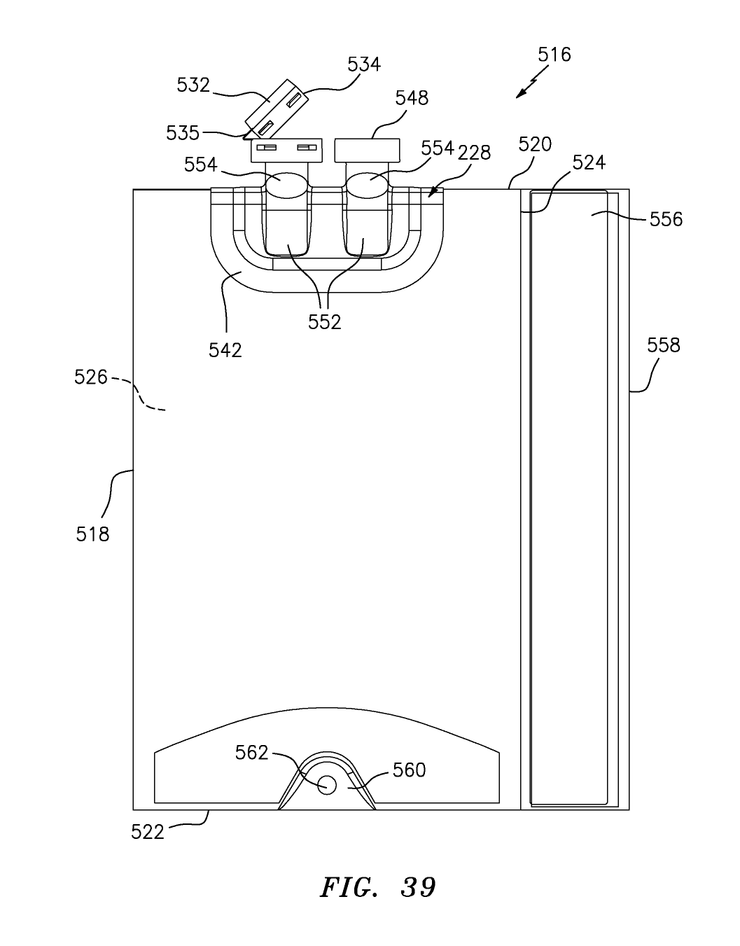

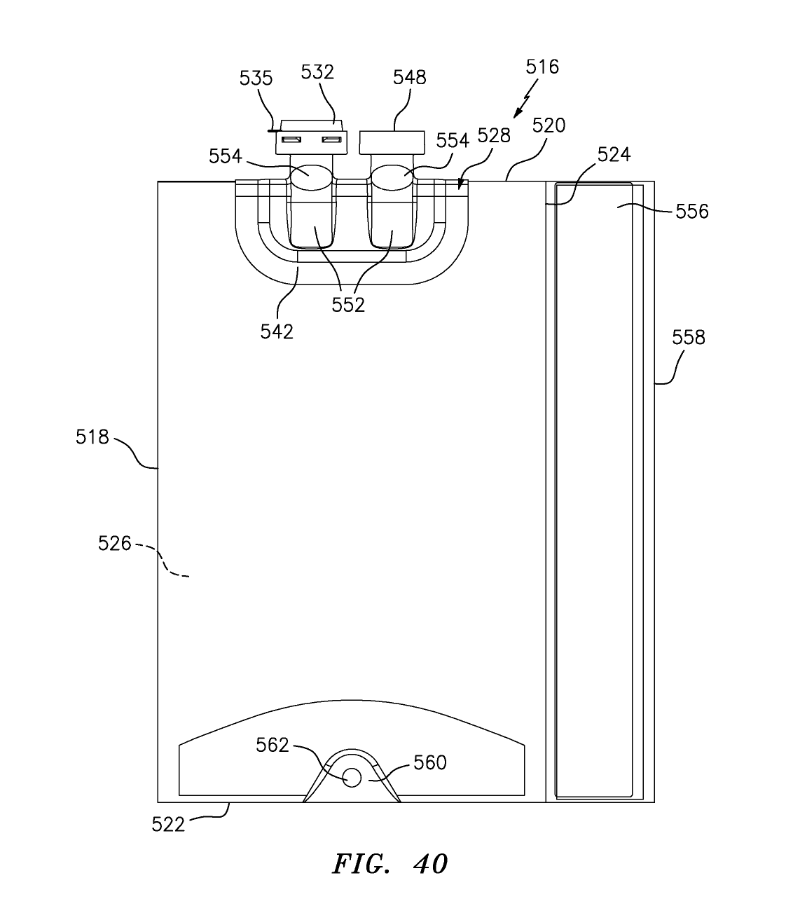

As shown in FIG. 38, rather than move the hinged mold ring 534 to close the port 552 prior to filling, the pouch is filled, at least in part, though the open left port 552. Dispenser 570, which is in communication with a source of substance (not shown) is aligned over the open left port 552 and dispenses a substance 576 into the interior chamber 526 of the pouch 516 through the open port 552. After the pouch 516 is filled, as seen in FIGS. 39 and 40, the hinged mold ring 534 and septum 532 is moved about the hinge to an at least partially closed position, as seen in FIG. 40, to close the port 552 and form a sealed pouch 516 closed to ambient atmosphere. In this manner, for example, substances that do not readily pass through a needle or other injection member, such as a powder or high viscosity fluid, may be filled into the pouch 516.

When the pouch 516 is filled in this manner, the filling may be performed a non-sterile fashion, if desired. The entire sealed pouch, including the filled substance, may then be sterilized, such as by gamma radiation or heat (autoclaved) where the substance 576 will tolerate the selected sterilization procedure. In some embodiments, the pouch 516 may include one or more sterility indicators, as described herein, that change color during the sterilization procedure to indicate that the sealed pouch 516 and substance 576 are sterilized. Once the pouch 516 is sterilized, the substance 576 is maintained sterile within in the sealed pouch 516 with no exposure to the environment. In some embodiments, the filling may take place under a flow of micro-filtered and/or sterile air and/or other gas as described herein to prevent the collection of undesired particles within the pouch 516.

Once the pouch 516 and substance 576 are sealed within the pouch and sterilized, the ports 552 may be utilized as elsewhere described herein to remove substance from the pouch 516 and/or add substance to the pouch 516 in a sterile manner. For example, one or more of the septa 332 may be pierced by a needle or injection member, substance added or withdrawn as desired, and the pierced septum resealed as elsewhere described herein.

In some embodiments where the substance 576 is a powder, the pouch 516 may be sterile filled with sterile fluid, solvent or diluent through a septum 532. The powder 576 may then be dissolved into or otherwise combined with fluid by added fluid. To assist in this process, and to promote even distribution of formulation within the pouch 516, the pouch 516 may be squeezed, manipulated, vibrated, or shaken. The resultant fluid may then be withdrawn through one of the septa 532 as described herein. Similarly, in embodiments where a high viscosity fluid is filled into the pouch, a diluent may be sterile filled into the pouch 516 through a septum 532 to sufficiently reduce the viscosity of the fluid so that it can be removed from the pouch through a septum 532.

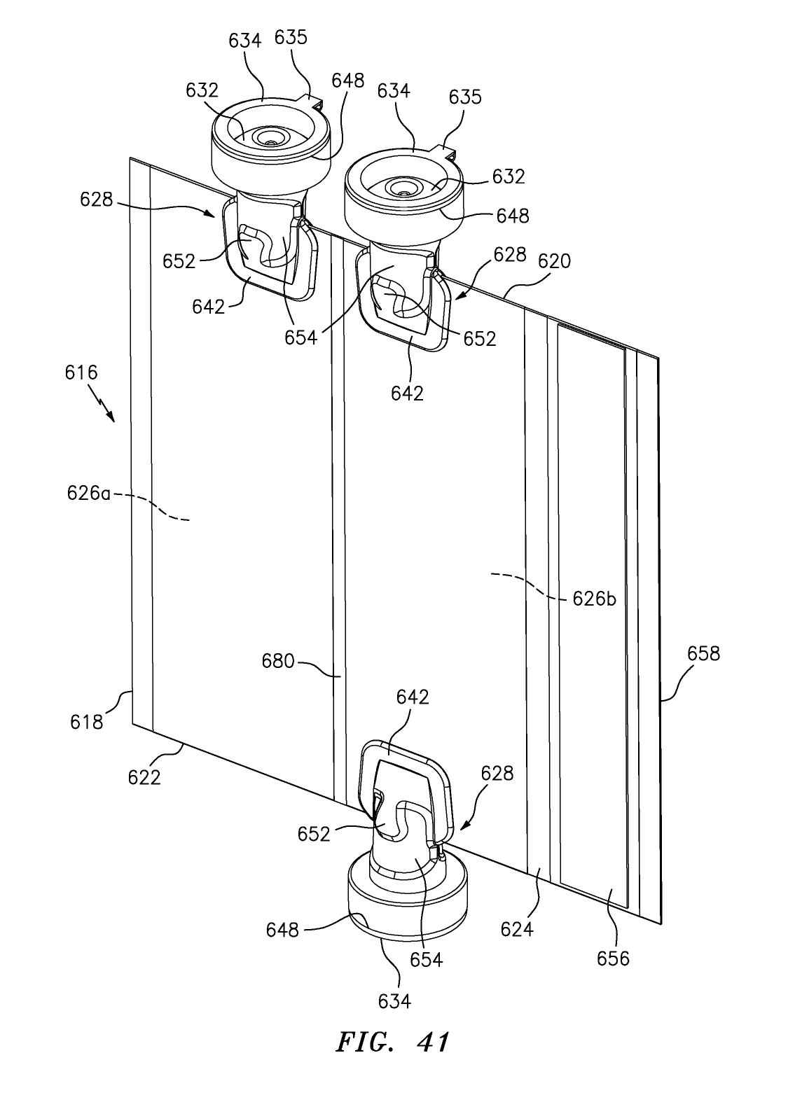

In FIGS. 41 through 46, another embodiment of a pouch is indicated generally by the reference numeral 616. The pouch 616 is substantially similar to the pouches described above, and therefore like reference numerals preceded by the numeral “6,” or preceded by the numeral “6” instead of the numerals “1,” “2,” “3,” “4” or “5,” are used to identify and describe the same or like elements. One way in which pouch 616 differs from other embodiments disclosed herein is that, as depicted in FIGS. 41-44, the interior 626 of the pouch 616 contains two chambers 626a and 626b that are separated from each other by a frangible portion or seal 680 so that the chambers 626a, 626b are not in fluid communication with each other.

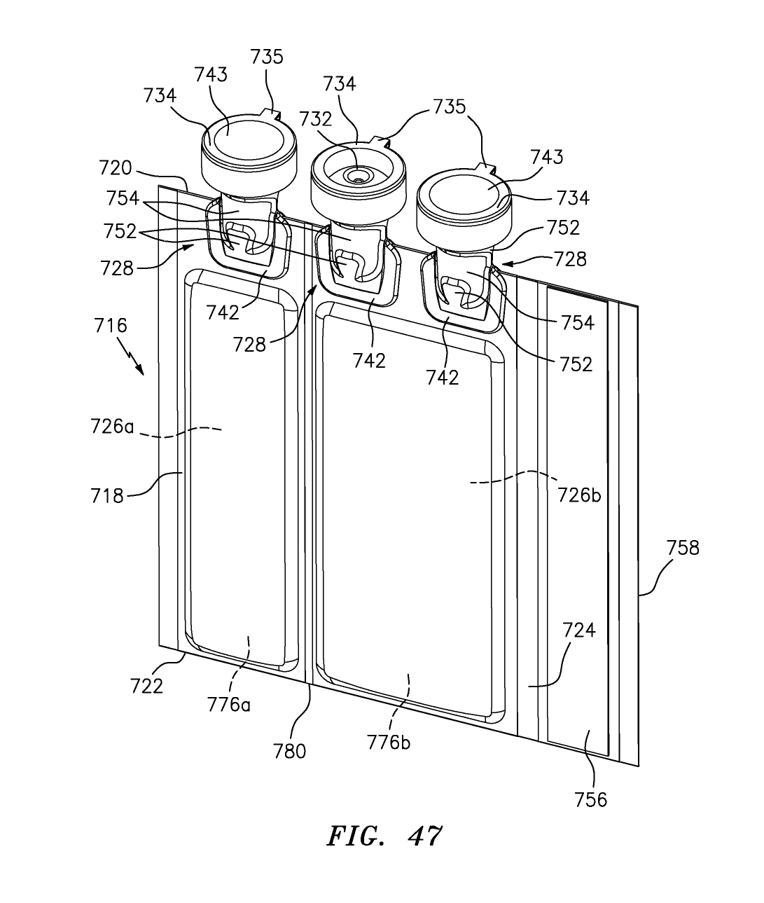

In the illustrated embodiment, the frangible seal 680 extends from side 620 to side 622. It should be understood by those of ordinary skill in the art that though in the illustrated embodiment the frangible seal 680 extends from side 620 to side 622, the frangible seal may extend between any of the first end marginal edge portion 618, the second end marginal edge portion 620, and the sides 620, 622 as desired. Further, while the illustrated frangible seal 680 is linear, the frangible seal may have any desired configuration that separates the interior 626 into multiple chambers, e.g., curvilinear, curved, or having multiple contiguous linear, curved and/or curvilinear segments. In addition, though the illustrated frangible seal 680 extends perpendicularly to the sides 620, 622, the frangible seal 680 may extend at any desired angle. Moreover, though the illustrated frangible seal 680 is located on the pouch 616 where the chambers 626a, 626b are of approximately the same size, the frangible seal 680 may be located so as to create chambers of different sizes, as illustrated in FIG. 47 discussed further below. Yet further, while pouch 616 contains one frangible seal 680 to provide the pouch 616 with two chambers, the pouch may contain multiple frangible seals to provide more than two chambers as desired.

In the illustrated embodiment, the pouch 616 has three fitments 628. One fitment is located in fluid communication with chamber 626a, and two fitments are located in fluid communication with chamber 626b. Other embodiments may contain more or fewer fitments. In addition, though the two fitments in fluid communication with chamber 626b are located at side 620 and side 622 respectively, the fitments may be located on the same side as each other (see, as an example, FIG. 47 discussed below), and on the same side or a different side than the fitment in fluid communication with chamber 626a.

The frangible portion 680 is breakable in response to pressure in one or both of the chambers 626a, 626b exceeding a substantially predetermined threshold pressure that will break the frangible portion 680. In one such embodiment, the frangible portion 680 is breakable by engaging and squeezing the pouch 616 at a location of one of the chambers so as to increase the pressure of substance in that chamber to or beyond the threshold pressure. A threshold pressure should be provided so as to be lower than the pressure that would separate the layers of the pouch 616 at the first and second end marginal edge portions 618, 620 or cause the material of pouch 616 to tear, rupture or burst. In embodiments where the frangible portion 680 may be broken by manually engaging and squeezing the pouch, the threshold pressure preferably is achievable without undue effort by the user. On the other hand, the threshold pressure may be provided so as to be sufficiently high to prevent unintended breaking of the frangible portion.

The frangible portion 680 may be formed in any of numerous different ways, that are currently known, or that later become known. In one embodiment, the frangible portion 680 may be formed by sealing the opposing inner surfaces or layers of the pouch 616 together in a similar manner or process as to how the inner surfaces or layers may be sealed to form the end marginal edge portions 618, 624 of the pouch, e.g., by heat sealing the inner surfaces or layers of the pouch together at the location of the frangible portion 680. Providing a desired threshold breaking pressure of the frangible portion, e.g., less than the threshold breaking pressure of the end marginal edge portions 618, 620 and the pouch material, may be accomplished in any suitable manner. One such way is to perform the heat sealing of the frangible portion 680 at a lower temperature, lower pressure and/or shorter time than the sealing of the end marginal edge portions 618, 620, so as to provide a seal that is not as strong as at the end marginal edge portions 618, 620, but strong enough to maintain the seal between the chambers 626a, 626b until it is desired to be broken. Another way, which may be used alternatively to or in addition to the process described in the preceding sentence, is to form the frangible seal 680 with a width (e.g., the transverse distance the seal extends between the chamber 626a, 626b) that is less than the width of the seals at the end marginal edge portions 618, 620. Accordingly, the area of the frangible seal would be less than the area of the seal(s) at the end marginal edge portions 618, 624, and thus at a reduced strength (threshold pressure) compared thereto. As illustrated in FIGS. 41 through 44, the width of the frangible seal 680 is less than the width of the seals of the end marginal edge portions 618, 624.

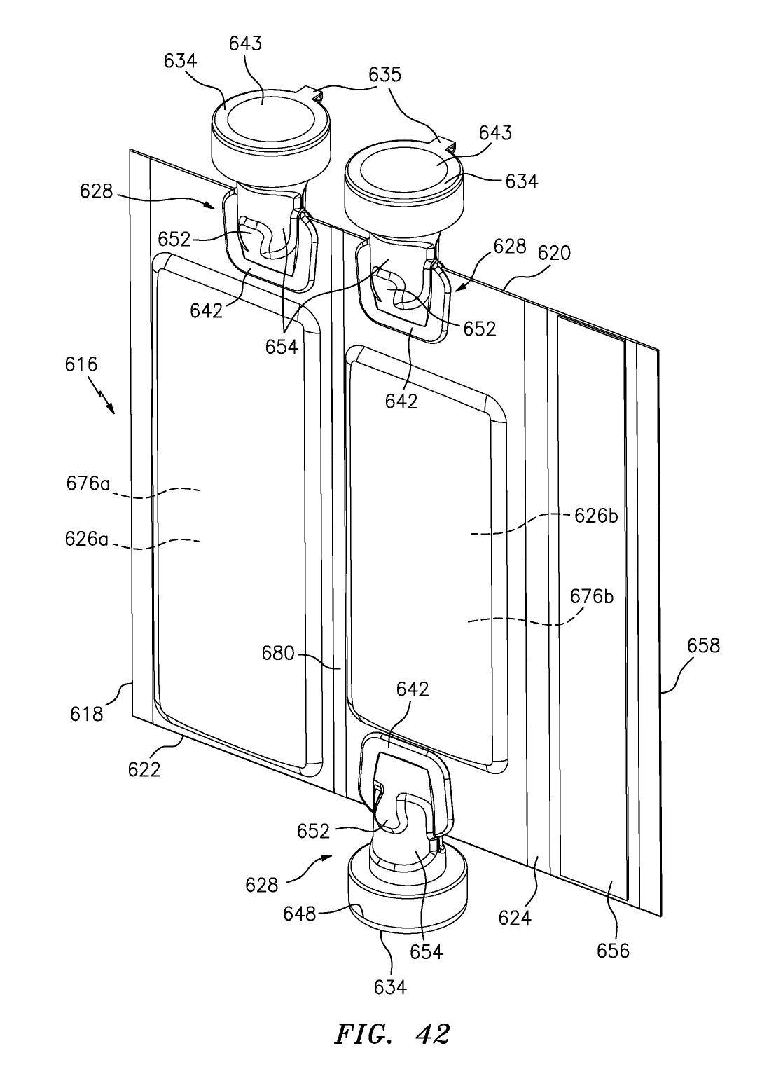

The pouch 626 may be used, for example, to fill each chamber 626a, 626b with a different substance. FIGS. 41-46 illustrate such a use. As illustrated, each of the sealed empty chambers 626a, 626b shown in FIG. 41 may be filled with respective different substances 676a, 676b though a respective fitment 628 in fluid communication with a respective chamber 626a, 626b. In the illustrated embodiment, an injection member may be inserted through the septum 632 of each fitment to sterile fill the substances 676a, 676b into the chambers 626a, 626b. After filling, the septums 632 may be resealed so as to provide a sealed, filled pouch as seen in FIG. 42. It should be understood by those of ordinary skill in the art that, though the illustrated embodiment utilizes fitments having septums, fitments of other configurations and filling methods (e.g., a valve) may be alternatively used.

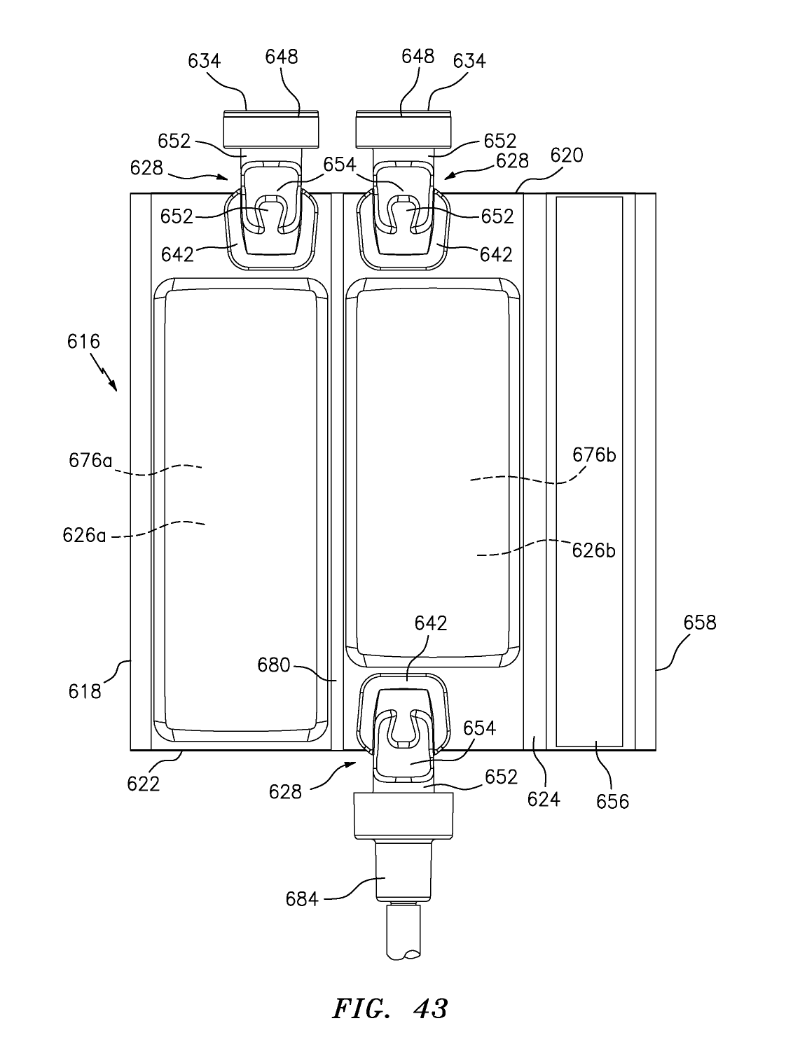

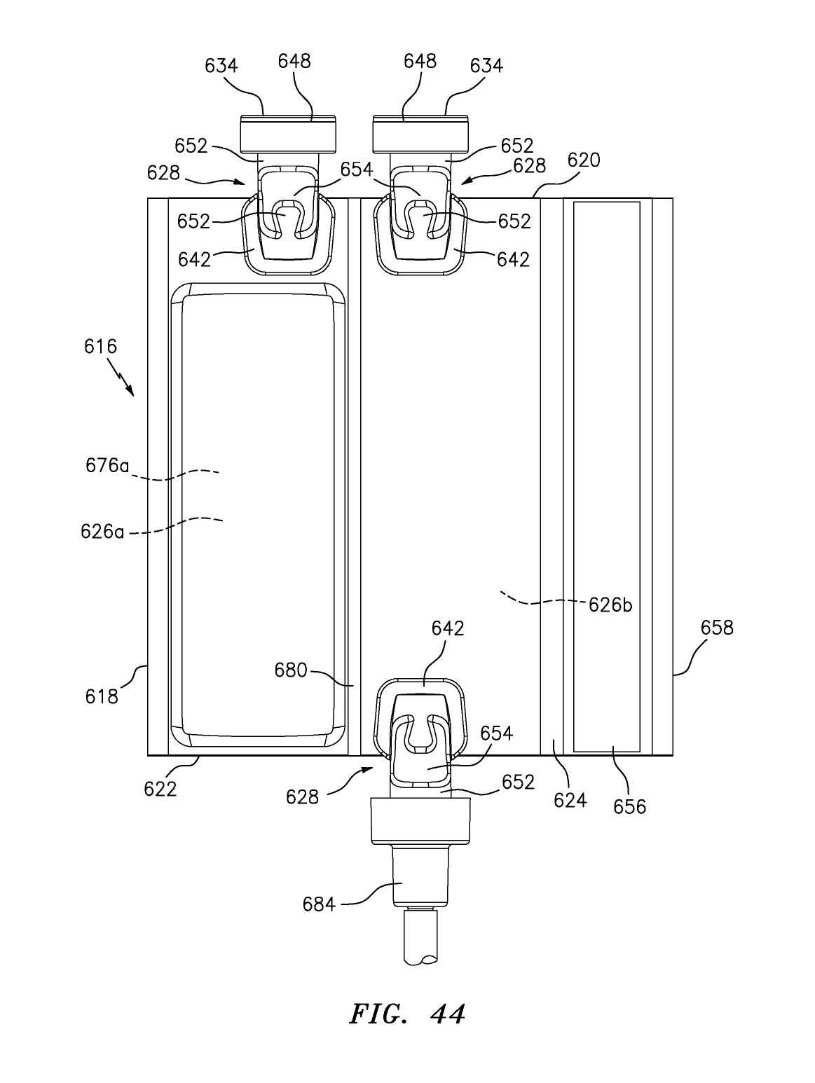

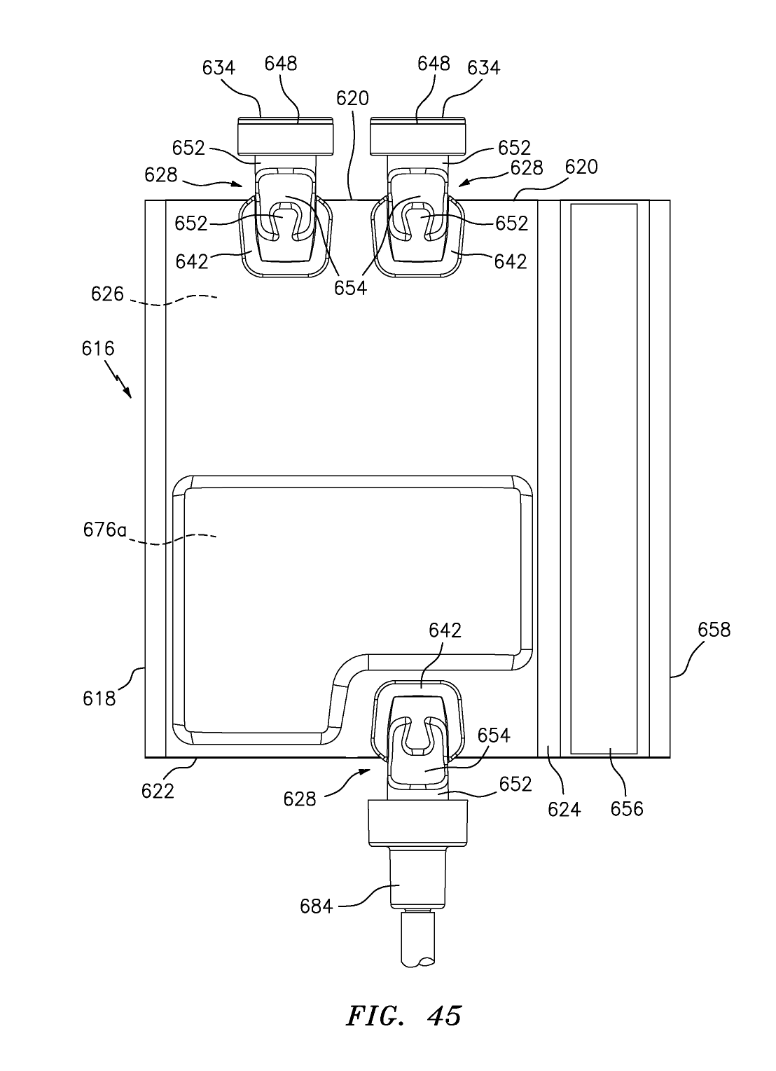

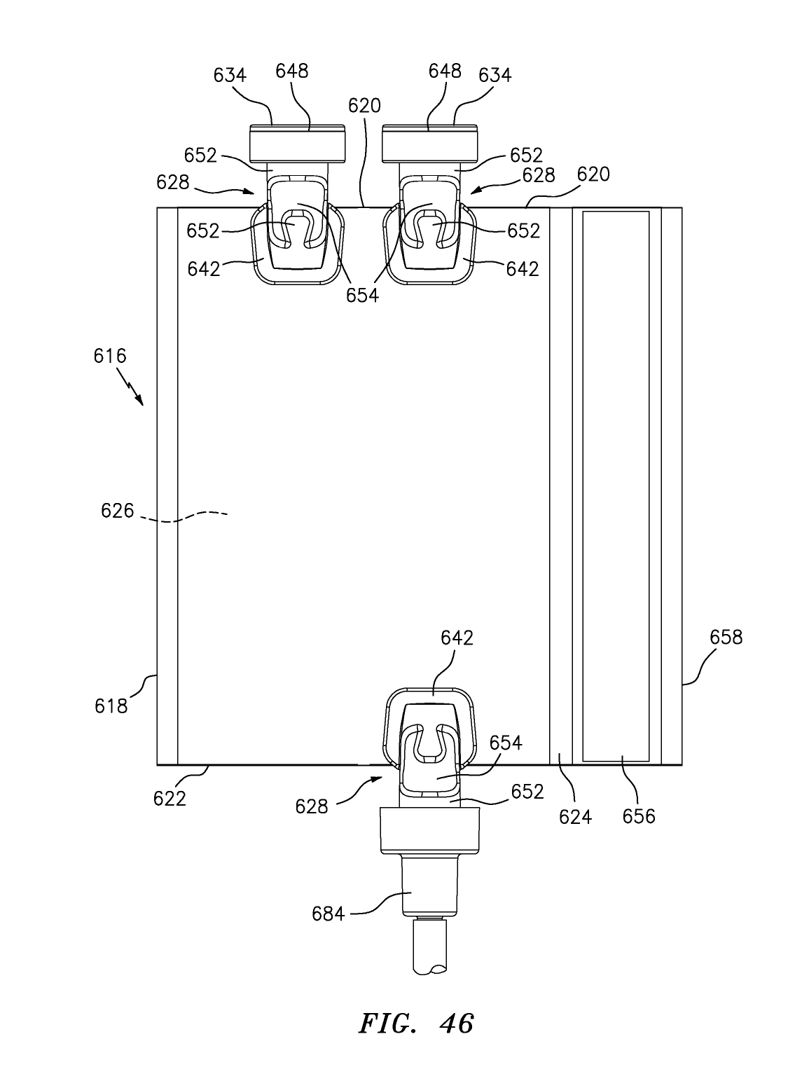

Next, as seen in FIG. 43, a fluid line 684 may be placed into fluid communication with the second fitment 628 of chamber 626b, e.g., sterile connected via a sterile connector, to place the fluid line 684 in fluid communication with the chamber 626b. Substance 676b may then be removed from chamber 626b through fluid line 684 as seen in FIG. 44. The frangible seal may then by broken, e.g., by squeezing the pouch at chamber 626a and pressurizing substance 676a above the threshold pressure of the frangible seal 680, so as to place chamber 626a into fluid communication with chamber 626b (effectively creating a single chamber in the pouch 616) seen in FIG. 45. Substance 676a may then be removed from the pouch through fluid line 684 as shown in FIG. 46.

Those of ordinary skill in the art should understand that, while in the illustrated embodiment the fitment 628 located at the side 620 of the pouch 616 is used to fill the chamber 626b, and the fitment 628 located at the side 622 of the pouch 616 is used to empty the chamber 626b, the fitment 628 located at the side 622 may be used for filling and the fitment 628 located at the side 620 may be used for removal. It should also be understood that in other embodiments chamber 626a has multiple fitments, such that substance may be first removed from chamber 626a and the frangible seal 680 may be broken by pressurizing the substance in the chamber 626b.

The above-described process may be used, for example, to sequentially dispense substances 676b and 676a from the pouch 616. Though any desired substances may be filled into the pouch 616 and sequentially dispensed, in one embodiment, substance 676b may be saline and substance 676a may be a drug, e.g., Carboplatin. The saline 676b may be dispensed from the pouch 616 to purge or clean the flow line 684. The drug 676a may then be dispensed without contacting or interacting with other substances (other than saline) in the fluid line 684.

In other embodiments, the pouch 616 may be used to mix different substances. It may be desirable to mix or otherwise combine substances only shortly before dispensing, e.g., where the mixture is not sufficiently stable or degrades if mixed too far in advance of dispensing, as available with conventional formulation manufacturing. Mixing at or close to the time of dispensing may provide enhanced tolerance, absorption, transport and/or bioavailability of the mixture.

To mix the substances 676a, 676b prior to dispensing, the sequence illustrated by FIGS. 41-46 is modified. First, the chambers 626a, 626b are filled similarly to as described above with respect to FIGS. 41 and 42. Then, instead of attaching fluid line 684 to the pouch as shown in FIG. 43, the frangible seal is broken to place the chambers 626a, 626b in fluid communication with each other. This may be accomplished by pressurizing either or both of the substances 676a, 676b so as to exceed the threshold breaking pressure of the seal. Once the chambers 626a, 626b are in fluid communication with each other, the substances 676a, 676b will mix. At the desired time, the fluid line 684 is connected to the pouch 616, and the mixture dispensed from the pouch 616.

In yet further embodiments, the pouch 616 may be used to dispense multiple portions of the same substance at different times. In such embodiments, the chambers 626a, 626b are filled with the same substance in the manner describe above with respect to FIGS. 41 and 42. The portions in each chamber may then be dispensed, at different desired times, using a process as described with respect to FIGS. 42 through 46. That is, the portion of the substance in chamber 626b may be dispensed at a first time by connecting fluid line 684 to the pouch as shown in FIGS. 43 and 44. At a second, later time, the portion of the substance in chamber 626a may be dispensed by breaking the frangible seal 680 and dispensing the portion as shown in FIGS. 45 and 46. Utilizing a single pouch 616 to dispense discrete portions or doses over time provides increased convenience and economy as compared to using multiple pouches, i.e., each pouch containing a single dose. In addition, as fluid line 684 need only be connected once to a single pouch, the risk of contamination from disconnecting and reconnecting fluid line 684 multiple times is eliminated.

In FIG. 47, another embodiment of a pouch is indicated generally by the reference numeral 716. The pouch 716 is substantially similar to the pouches described above, and therefore like reference numerals preceded by the numeral “7,” or preceded by the numeral “7” instead of the numerals “1,” “2,” “3,” “4,” “5” or “6,” are used to identify and describe the same or like elements. Pouch 716 is substantially similar to pouch 616. One difference between pouch 716 and pouch 616 is that chamber 726b has the two fitments 728 located at the first marginal edge portion 720 instead of, as in pouch 616, one fitment located at the first end marginal edge portion 720 and one fitment located at the second end marginal edge portion 722. Another difference is that the frangible portion 780 is located/configured so that chamber 726a is smaller in volume than chamber 726b. However, as discussed above, the frangible portion 780 may be located or configured to provide any desired relative volumes of the chambers 726a, 726b.

In some embodiments, the fitments(s) are not over-molded to a pouch. Rather, the fitment is formed separately from the pouch, such as by molding in the above described molds or separate molds, and then thermally sealed to the pouch in a manner that forms a single, continuous sealed interface between the fitment and the pouch. The sealed interface keeps the inner surfaces of the pouch sealed from ambient atmosphere. The heat sealing may be performed with one or more of an impulse heat sealer, a continuous heat sealer, a hot bar heat sealer, a hot wire sealer, an induction sealer, an ultrasonic welder or sealer, or any suitable sealing apparatus and method.

In some embodiments, the fitment is sealed to the pouch immediately after the fitment is removed from the mold in which it is formed. In some such embodiments, the fitment is put onto and sealed to the pouch under a flow of sterile air and/or other gas, as discussed herein. Therefore, no contaminants can get onto the underside of the fitment that is sealed to the pouch. Thus, upon sealing to pouch, there are no contaminant and germs between the fitment and pouch.

In some embodiments, the fitment is sealed to the pouch while the fitment and/or the pouch is still hot, e.g., at a bactericidal temperature. Should there be any germs between the fitment and pouch, because the fitment and/or pouch are still hot, the heat will kill any germs at the interface of, or between, the fitment and pouch. In addition, or alternatively, the heating of the fitment and pouch material during thermal sealing of the fitment to the pouch will kill germs at the interface of, or between, the fitment and pouch.

In some embodiments, the single, continuous sealing interface is formed through application of heat or energy to an external surface of the fitment, without direct application of heat or energy to a surface of the pouch. In some such embodiments, the apparatus that applies the thermal or other energy to seal the fitment to the pouch contacts only external surfaces of the fitment, and does not touch the pouch surface. Sealing the fitment to the pouch in such manner helps avoid contamination of interior surfaces during the sealing process and/or potential damages to the pouch material due to the direct application of heat.

In some embodiments where the pouch is formed from a multi-layer material, the outer layer contains a material that bonds with the material of the fitment, and the inner layer does not contain a material that bonds with the material of the fitment. Accordingly, during thermal sealing of the fitment to the pouch, the fitment will not bond with the inner layer of the pouch. In some embodiments where the pouch is formed of a multi-layer material where an inner layer thereof defines a melting temperature higher than a melting temperature of the outer layer, the inner layer thus does not melt or soften when the outer layer is heated, and thus the inner layer does not seal together or bond with the fitment when heat is applied to seal the fitment to the pouch.

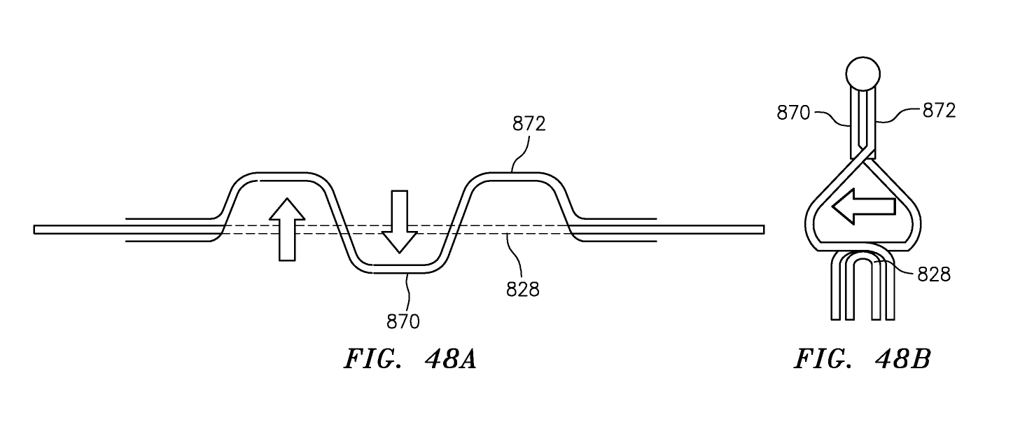

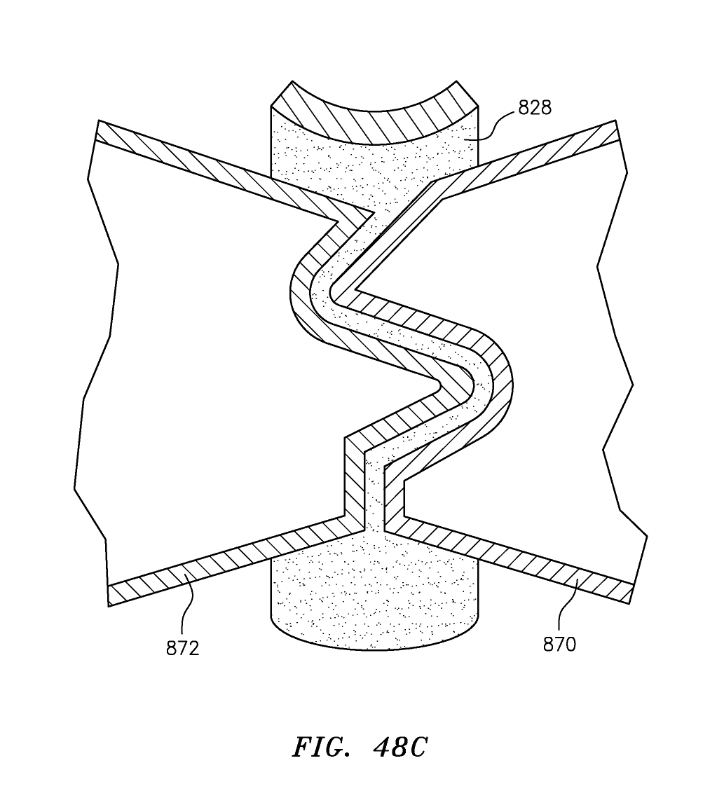

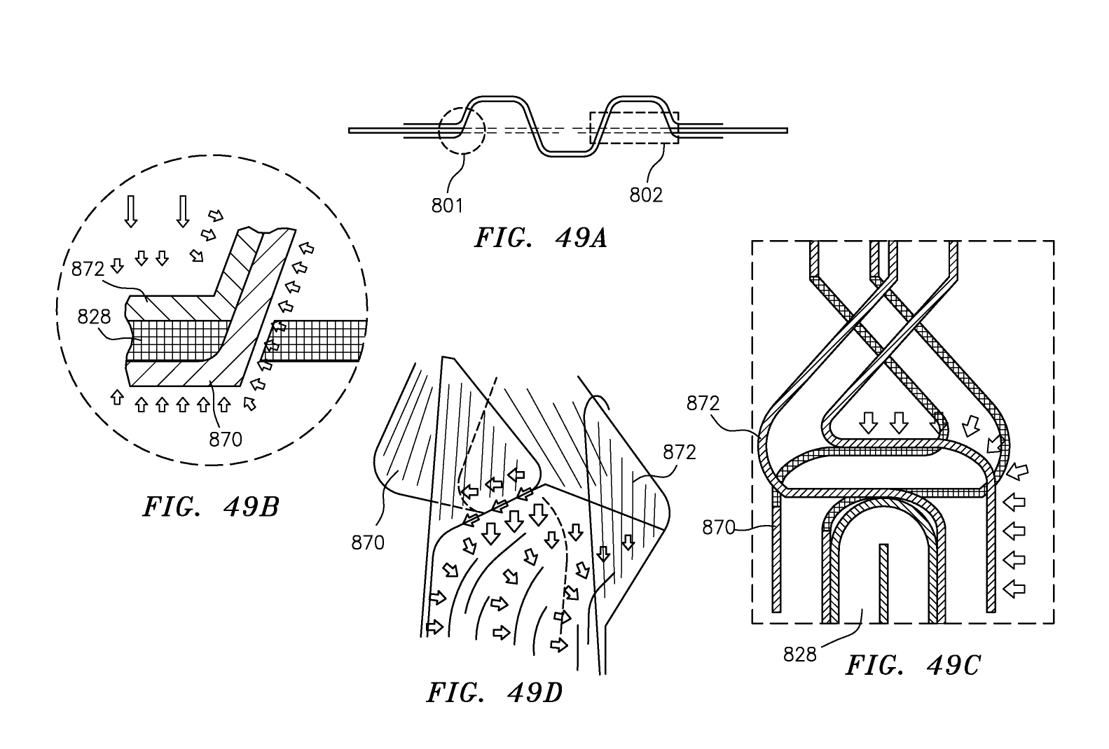

FIGS. 48-49D illustrate apparatuses and methods of sealing a fitment 828 onto the pouch to form a continuous, single interface seal between the fitment 828 and the pouch. As discussed above, the fitment 828 may be sealed to the pouch under a flow (e.g., laminar flow) of sterile air and/or other gas shortly after molding of the pouch and/or fitment. Performing the sealing in this environment prevents exposure of the interior of the pouch and fitment to environmental contaminants. Accordingly, there would be no contaminants or germs trapped between the fitment and pouch. Should there be any germs between the fitment and pouch, because the pouch and/or fitment are still hot, the heat will kill any germs at the interface of, or between, the fitment and pouch.

The fitment may be impulse sealed to the pouch using a suitable pressure, temperature, and duration. In some embodiments, the pressure, temperature, and duration of the impulse sealing may be the same pressure, temperature, and duration of the impulse sealing used to seal the edges of the film when forming the pouch as discussed above. As discussed above, the sealable portion of the fitment may, in some embodiments, be comprised of the same material as the pouch, and thus the same parameters and process for impulse sealing edges of the film can be used for impulse sealing the fitment to the pouch. The fitment is preferably sealed to the edge of the pouch, e.g., over the pouch aperture, that is formed when the blow molded film is flattened and folded, not on an edge of the pouch that is formed by heat sealing the open ends of the cylinder. This is because there is a risk that an intact seal cannot form on a heat-sealed seam, and a leak or hole could form.

As seen schematically in FIGS. 48A-49D, an impulse sealing machine that seals the fitment 828 to the pouch has a pair of heated jaws 870, 872 that clamp together with the fitment/pouch interface between them. Each jaw has a “wave” shape that corresponds with the shape of the other jaw so as to interlock with the other when they come together. As can be seen in FIGS. 48A-49D, jaw 870 and jaw 872 come together on opposite faces of fitment 828 to capture between them the pouch and fitment 828, and thereby seal the fitment 828 to the pouch 50. In addition, as can be seen in FIG. 48B, which represents a schematic cross-sectional view of where the upper (apical) edge of the fitment 828 is being sealed to a pouch, jaw 870 and jaw 872 also effect a seal between the fitment 828 and the pouch along the top edge of the fitment 828.

The jaws 870, 872 effect a fluid-tight seal both laterally and apically. The interaction of the jaws 870, 872 and fitment 828 is shown, for example, in FIG. 49A, with area 801 representing a location of lateral sealing to faces of the pouch, and area 802 indicating a location of apical sealing adjacent to an edge or margin of the pouch. As shown particularly in FIG. 49B, the two jaws 870, 872 apply forces against fitment 828 (represented by arrows), thereby effecting a continuous interface between the fitment 828 and the pouch. As seen particularly in FIGS. 49C and 49D, the interlocking configuration of the two jaws 870, 872 enables the jaws 870, 872 to effect sufficient heat and force through the interdigit area to seal the fitment 828 to the pouch along the upper edge. Jaws 870, 872 may be configured to contact only the fitment 828, not the pouch surface directly. Furthermore, the jaws 870, 872 may be configured to contact the fitment 828 only on the external side thereof. This configuration helps avoid contamination of interior surfaces during the sealing process and/or potential damage to the pouch material due to the direct application of heat.

When sealing the fitment to the pouch, in order to ensure sterility and no leaks, the portion of the fitment is sealed to the outer layer of the pouch everywhere around the periphery of the fitment/pouch interface. This is relatively easily achieved on flat parts of a pouch (e.g., the front and rear faces of the pouch) because there is ample mating surface on those parts between the fitment and the pouch. However, sealing is more difficult at the apical edge of the pouch where the material folds over the pouch from one side to the other (and where the fitment extends from one side of the pouch over the edge to the other side of the pouch), because there is less surface area contact between the fitment and the pouch. However, it is still necessary for a continuous single interface seal to extend from one side of the pouch to the other (over the apex of fold) to prevent leaks and contamination. This is accomplished in part by the interlocking configuration of the jaws 870, 872, which, as particularly shown in FIGS. 48B and 49D, extend over the apex so as to apply heat to the apical portion of the fitment. In addition, as seen, for example, in FIGS. 4C, 14B, 48B and 49D, the bottom surface of the fitment 19 at the apex that engages the pouch has a curved shape as opposed to forming a point or vertex, so as to increase the sealing surface contact area in comparison to a more sharply-shaped vertex.

In additional embodiments, a pouch aperture is formed on a first side of the pouch spaced from a marginal edge of the pouch. The fitment has first and second portions connected by a hinge, for example, a flexible or living hinge. The first portion of the fitment contains one or more ports extending therefrom. The one or more ports may have the configuration of one or more of the ports disclosed elsewhere herein. In some embodiments, the one or more ports have a first part extending transversely to the first portion and a second part extending from an outer end of the first part at so as to extend generally parallel to the first portion. A septum or valve is attached to an outer end of the second part to seal said outer end.

The fitment is sealed to the pouch such that the first portion is attached to the first side of the pouch and overlies the pouch aperture with the first part of the one or more parts in fluid communication with the pouch aperture, and the second portion overlies a second side of the pouch that is opposite the first side, the fitment being folded at its hinge so that the hinge is located substantially adjacent to the marginal portion located between the first and second sides. Substance may be filled and/or withdrawn from the pouch, e.g., in a sterile manner, through the one or more ports in a similar manner as in other embodiments described herein. In at least some such embodiments, the fitment is heat sealed to the pouch as described elsewhere herein to form a single, continuous interface between the fitment and the pouch.

One advantage of disclosed apparatuses and methods is that they can allow preventing the interior surfaces of the pouch or like container from being exposed to the ambient atmosphere from their formation during molding, through sterile or aseptic filling and storage, and preferably, through dispensing or withdrawal of the product from the interior chamber of the pouch or like container. Another advantage is that such surfaces can be sterile, particle free and pyrogen free from their formation during molding through sterile or aseptic filling and storage. As a result, the pouch or like container need not be sterilized prior to filling, such as by applying gamma radiation thereto, and need not be sterilized after filling, such as by applying terminal sterilization, in order to ensure the sterility of the product filled therein. However, such sterilization(s) nevertheless may be employed in connection with the disclosed apparatus and/or method, if so desired. Yet another advantage is that the illustrated septum (as further described in the above-mentioned co-pending patent applications incorporated herein) de-contaminates the closed needle or like injection member during penetration of the septum, and therefore the septum need not be surface sterilized or otherwise de-contaminated prior to closed needle or other closed injection member sterile or aseptic filling. A further advantage is that such sterile or aseptic filling may be performed in a non-classified environment while nevertheless providing for higher safety levels than products filled in sterile isolators.

Another advantage of the illustrated pouches is that a single interface seal is formed along the periphery of the pouch aperture between the base of the fitment and the pouch, thus providing for a high integrity and/or reliable seal, and obviating problems encountered in prior art pouches without single interface seals between the pouches and their fitments. Another advantage is that the fitment may include any desired number of ports, including one or two ports as illustrated herein, or another desired number of ports. In such embodiments, one port may be used to sterile or aseptically fill the interior of the pouch therethrough, and one or more other ports may be used to withdraw or dispense the sterile or aseptically filled product from the interior chamber(s) of the pouch. Another advantage is that any contamination of the sterile or aseptically filled product may be prevented from formulation of the product, through filling of the product into the pouch and withdrawal or dispensing of the product from the pouch, such as for administration of the product to a patient. A further advantage is that the pouch may be used to contain a hazardous or otherwise dangerous product or material, and the sealed pouch can prevent such a product from being exposed to the ambient environment, or the product or material may be withdrawn from the interior chamber of the pouch, as needed, through a sterile connector, such as one of the sterile connectors incorporated by reference below, connected to the port, or one of the ports, without exposing the product to the ambient environment.

The product filled within the pouch may be withdrawn from the interior chamber of the pouch through a sterile connector connected to the port or one of the ports of the fitment, and/or a product may be sterile or aseptically filled into the interior chamber of the pouch through a sterile connector connected to the port or one of the ports of the fitment. The sterile connectors usable with the disclosed pouches may take the form of any of the sterile connectors disclosed in any of the following patents or pending patent applications, which are hereby incorporated by reference in their entireties as part of the present disclosure: U.S. patent application Ser. No. 14/217,864, filed Mar. 18, 2014, entitled “Aseptic Connector with Deflectable Ring of Concern and Method,” which claims the benefit of similarly titled U.S. patent application Ser. No. 13/080,537, now U.S. Pat. No. 8,671,964, issued Mar. 18, 2014; entitled; U.S. patent application Ser. No. 14/536,566, filed Nov. 7, 2014, entitled “Device for Filling and Method,” which is a continuation in part of similarly titled U.S. patent application Ser. No. 13/874,839, filed May 1, 2013; U.S. patent application Ser. No. 13/864,919, filed Apr. 17, 2013, entitled “Self Closing Connector”; the U.S. patent application entitled “Single Use Connector,” filed Jan. 19, 2017, which claims the benefit of U.S. Provisional Patent Application No. 62/280,693, filed Jan. 19, 2016, entitled “Single Use Connectors.”

One advantage of the pouch and sterile connector is that they allow for closed transfer of product into or from the pouch without any exposure of the product to the ambient atmosphere throughout the transfer process. One advantage of such closed transfer processing is that it can obviate the need for cleaning in place (CIP) or sterilization in place (SIP) systems and processes. Yet another advantage of such closed transfer processing is that it can allow for a safer and improved quality product, such as products for intravenous (IV) administration. Products processed by such closed transfer processing can exhibit the lowest extractable levels, can be free of undesirable by-products, such as those degraded by heat during sterilization, and can be prevented from being subjected to heat degradation, such as may be encountered when products contact the relatively hot interior walls of recipient containers in connection with prior art blow form, fill and seal processing. As a result, the disclosed apparatus and methods can provide for higher safety levels for patients, for the products filled into and withdrawn from the pouches, for the medical professionals using the products filled into and withdrawn from the pouches, such as physicians, nurses, pharmacists, and other medical professionals, and for the ambient environment.

As may be recognized by those or ordinary skill in the pertinent art based on the teachings herein, numerous changes and modifications may be made to the above-described and other embodiments of the present invention without departing from its scope as defined, for example, in the appended claims. For example, the film used to make the pouch may include any number of layers made of any of numerous different materials that are currently known or that later become known. Similarly, the fitments may take any of numerous different configurations, may include any of numerous different parts or features, such as septa, sterile connectors, valves, and other devices for filling substances into the pouches, or withdrawing substances therefrom, may be made of any of numerous different materials or combinations of materials, and may include any of numerous different insert-molded, over-molded, co-molded, or other molded features, that are currently known, or that later become known. The invention may be used to make, or may be embodied in containers or devices other than pouches, such as vials, syringes, multiple dose delivery devices, or pouches that differ in shape and/or construction than those shown and described. In addition, steps of the disclosed methods may be eliminated, additional steps may be added, and/or steps may be performed in an order different from that described. The molding of the tubular film may be performed in line with, immediately prior to, and/or adjacent to, the molding of the fitments to the pouches, or the tubular film may be transported in a flattened, collapsed and/or rolled form, or the empty pouches may be transported, from a first location to a different or second location where the fitments are molded or attached to the pouches. The pouch apertures may take any of numerous different shapes and/or configurations, may be formed at any of numerous different locations, and/or may be formed any at time during the manufacturing process. The fitments and any components thereof may be made in accordance with any of numerous different molding processes or techniques that are currently known, or that later become known, such as insert molding and co-molding. Further, the molds used to form the fitments or any components thereof may take the form of any of numerous different types of molds that are currently known, or that later become known. Accordingly, this detailed description is to be taken in an illustrative as opposed to a limiting sense.

1. A method comprising the following steps:
(i) molding a tubular film including an inner surface and an outer surface, and blowing or otherwise directing micro-filtered air and/or other gas through the tubular film during molding;
(ii) flattening the molded tubular film;
(iii) sealing the flattened tubular film at spaced locations, cutting the film, and forming at least one empty pouch;
(iv) over-molding a fitment to the empty pouch and forming a fluid-tight seal between the fitment and pouch; and
(v) preventing the collection of one or more of particles or pyrogens on the inner surface of the pouch, and the exposure of the inner surface to an ambient atmosphere throughout steps (i) through (iv).

2. A method as defined in claim 1, wherein the molding includes blown film extrusion molding or blown film co-extrusion molding the tubular film, and blowing or otherwise introducing a flow of micro-filtered air and/or other gas through the interior of an extrusion head and the tubular film.

3. A method as defined in claim 1, wherein at least an inner surface of the tubular film is at bactericidal or sterilization temperature during step (i).

4. A method as defined in claim 1, further comprising blowing or otherwise directing micro-filtered air and/or other gas toward and/or through an opening to a mold for over-molding the fitment to the pouch.

5. A method as defined in claim 1, further comprising forming the pouch with a pouch aperture in an edge portion thereof and in fluid communication with an interior chamber of the pouch, and over-molding the fitment to the pouch and forming a fluid-tight seal between the fitment and pouch about the pouch aperture.

6. A method as defined in claim 5, further comprising over-molding a septum onto the fitment and in fluid communication with the pouch aperture.

7. A method as defined in claim 6, further comprising moving a mold containing the fitment over-molded onto the pouch from a first molding station to a second molding station, and over-molding the septum onto the fitment in the second molding station.

8. A method as defined in claim 6, further comprising over-molding a septum onto a hinged portion of the fitment and forming a one-piece or integral fitment and septum.

9. A method as defined in claim 8, further comprising moving the hinged septum of the fitment into an at least partially closed position and preventing exposure of the inner surfaces of the septum and fitment to the ambient atmosphere.

10. A method as defined in claim 9, further comprising opening the mold, and upon opening the mold, (i) actuating a cam or other actuator to move the hinged portion of the fitment or (ii) otherwise automatically moving the hinged portion of the fitment, into the at least partially closed position.

11. A method as defined in claim 1, further comprising over-molding the fitment in a first mold cavity, molding a septum in a second mold cavity, moving at least one of the first or second mold cavities toward the other, assembling the septum and fitment, and forming a sealed, empty pouch.

12. A method as defined in claim 11, further comprising rotating or otherwise moving at least one of the first or second molds to align the septum and fitment, moving at least one of the aligned septum or fitment toward the other to assemble the septum and fitment, and de-molding the sealed, empty pouch.

13. A method as defined in claim 12, further comprising directing an over-pressure of micro-filtered air and/or other gas into or through an open area of the molds during assembly of the septum and fitment.

14. A method as defined in claim 1, wherein step (i) further includes molding a multiple layer tubular film including an inner layer defining a first melting temperature and an outer layer defining a second melting temperature, and the first melting temperature of the inner layer is higher than the second melting temperature of the outer layer.

15. A method as defined in claim 14, further including during step (iv) at least partially melting the outer layer of the tubular film and thermally bonding the fitment thereto, but not melting the inner layer of the tubular film and thereby maintaining a separateness between the opposing inner surfaces of the inner layer at the over-molded fitment.

16. A method as defined in claim 1, wherein step (iii) includes thermally sealing and cutting the tubular film.

17. A method as defined in claim 16, wherein the cutting occurs substantially simultaneously with, or immediately upon, sealing.

18. A method as defined in claim 16, wherein the thermal sealing is performed with one or more of an impulse heat sealer, a continuous heat sealer, a hot bar heat sealer, a hot wire sealer, an induction sealer, and an ultrasonic welder or sealer.

19. A method as defined in claim 5, wherein the pouch aperture is formed prior to insertion of the pouch into the mold for over-molding the fitment thereto, or is formed with the pouch in the mold prior to over-molding the fitment thereto.

20. A method as defined in claim 19, further comprising maintaining the pouch in a flattened condition during forming the pouch aperture, and/or directing an over-pressure of micro-filtered air or other gas onto the pouch during formation of the pouch aperture.

21. A method as defined in claim 1, further including molding a fitment including a base that is over-molded to the outer surface of the pouch and extends along or about a periphery of a pouch aperture, and a port extending from the base and defining a fitment aperture in fluid communication with the pouch aperture.

22. A method as defined in claim 21, wherein a junction of the base and port defines a reduced cross-sectional thickness to allow flexing of the base and/or port relative to the other.

23. A method as defined in claim 1, further including forming the pouch with a pouch aperture in an edge portion thereof and in fluid communication with an interior chamber of the pouch, inserting a core pin into the pouch aperture, and over-molding the fitment to the pouch and forming a fluid-tight seal between the fitment and pouch about the pouch aperture.

24. A method as defined in claim 23, further including (i) directing filtered or sterile gas into the pouch aperture to facilitate opening the pouch aperture and introducing the core pin therein, and/or (ii) engaging the outer surface of the pouch at or adjacent to the pouch aperture to facilitate opening the pouch aperture and introducing the core pin therein.

25. A method as defined in claim 23, further including over-molding an elastomeric fitment about the pouch aperture.

26. A method as defined in claim 25, wherein the elastomeric fitment includes a base over-molded to the outer surface of the pouch, and a penetrable septum in fluid communication with the pouch aperture.

27. A method as defined in claim 26, wherein the fitment includes a septum support, and the method further includes over-molding the septum to the septum support.

28. A method as defined in claim 27, further including substantially simultaneously over-molding the septum and base of the fitment.

29. A method as defined in claim 26, further including withdrawing the core pin through an aperture in the fitment, and then sealing the fitment aperture.

30. A method as defined in claim 23, further comprising sealing an edge portion of the pouch at spaced locations relative to each other and defining the pouch aperture therebetween.

31. A method as defined in claim 30, further comprising sealing the edge portion of the pouch with a plurality of gaps in the sealed edge portion laterally spaced relative to each other, wherein each gap defines a respective pouch aperture.

32. A sealed, empty pouch, wherein the interior of the pouch is one or more of particle free and pyrogen free, made in accordance with the following method:
(i) molding a tubular film including an inner surface and an outer surface, and blowing or otherwise directing micro-filtered air and/or other gas through the tubular film during molding;
(ii) flattening the molded tubular film;
(iii) sealing the flattened tubular film at spaced locations, cutting the sealed film, and thereby forming an empty pouch;
(iv) over-molding a fitment to the empty pouch; and
(v) preventing the collection of one or more of particles or pyrogens on the inner surface of the pouch, and the exposure of the inner surface to ambient atmosphere throughout steps (i) through (iv).

33. A pouch comprising:
a tubular film including an inner surface and an outer surface, a first end marginal edge portion extending from approximately one side of the pouch to another side of the pouch, and a second end marginal edge portion located on an opposite end of the pouch relative to the first end marginal edge portion and extending from approximately one side of the pouch to another side of the pouch, wherein opposing surfaces of the tubular film are sealed to each other at the first end and second end marginal edge portions, and define an interior chamber between opposing inner surfaces of the tubular film; and the first or second marginal edge portion defines a pouch aperture in fluid communication with the interior chamber; and
a fitment over-molded to the outer surface along a periphery of the pouch aperture, wherein the outer surface is at least partially melted and bonded to the fitment and thereby forms a fluid-tight seal between the fitment and outer surface about the pouch aperture.

34-57. (canceled)

58. A method comprising the following steps:
(i) penetrating an elastic septum of a device with a needle or other injection member;
(ii) introducing a substance through the needle or other injection member and into a sealed chamber in fluid communication with the elastic septum;
(iii) withdrawing the needle or other injection member from the septum;
(iv) sealing a resulting hole in the septum by introducing a liquid hot-melt adhesive sealant onto the septum and covering the septum and the resulting hole with the liquid hot-melt sealant; and
(iv) allowing the liquid hot-melt sealant to cool, transition from a liquid to a solid, and form a substantially inflexible closure overlying the septum.

59-60. (canceled)
